(19) United States
(12) Patent Application Publication
(10) Pub. No.: US 2018/0054405 A1
(43) Pub. Date: Feb. 22, 2018

(54) PERSONALIZED IMAGE-BASED COMMUNICATION ON MOBILE PLATFORMS

(71) Applicant: INK CORP., West Hollywood, CA (US)

(72) Inventors: David Andrew Ritch, West Hollywood, CA (US); Antony Stewart Ritch, West Hollywood, CA (US)

(21) Appl. No.: 15/799,897

(22) Filed: Oct. 31, 2017

Related U.S. Application Data
(63) Continuation-in-part of application No. PCT/US2016/030402, filed on May 2, 2016.
(60) Provisional application No. 62/291,564, filed on Feb. 5, 2016.
(60) Provisional application No. 62/155,537, filed on May 1, 2015.

(51) Int. Cl. H04L 12/58; G06F 17/30; G06F 3/023; G06F 17/22

(52) U.S. Cl. CPC H04L 51/10; H04L 51/08; G06F 17/30038; G06F 17/2223; G06F 3/0236; G06F 3/0237; G06F 3/0238

(57) ABSTRACT

Methods and systems described in this disclosure are directed to creating linked images to include as part of a message sent to other user(s) via a messaging application on a user's device. A linked image can be generated by creating links between one or more images and a content item such as a word, an expression, a collection of characters, or an emoji. Linked images are meant to be a visual substitute or representation of a content item. The images used in creating linked images can be obtained from a variety of sources. Linked images can be saved in the form of a library or a folder in a user's devices. The present disclosure facilitates generating multiple linked images for a single content item, thus providing the choice to represent a word or an emoji by multiple linked images.

### CROSS REFERENCE TO RELATED APPLICATIONS

This application is a continuation-in-part of International Application No. PCT/US2016/030402, entitled “PERSONALIZED IMAGE-BASED COMMUNICATION ON MOBILE PLATFORMS,” filed on May 2, 2016, which claims priority to U.S. Provisional Patent Application No. 62/291,564, entitled “Personalized Image-Based Communication On Mobile Platforms,” filed on Feb. 5, 2016, and to U.S. Provisional Patent Application No. 62/155,537, entitled “Image Tagging For Mobile Messaging,” filed on May 1, 2015, the contents of each of which are incorporated by reference in their entireties for all purposes.

### BACKGROUND

Current image-based communication options, whilst popular, are very difficult to personalize whilst maintaining the speed at which users communicate. Commercially available specialized types of images such as emojis and digital stickers are limited in their styles and number and cannot be personalized by a user. Emojis are also represented differently depending on the software and hardware requirements of the system on which the emojis are displayed. In some situations, if a first user communicating with a second user sends an emoji via text messaging or multimedia messaging, the emoji sent by the first user can change appearance upon receipt by the second user.

Images are one of the primary ways in which people express themselves. Collectively they can represent what people like, whom they know, what they wear, how they want the world to see them and how they see themselves. Users today have large quantities of images saved on various platforms (e.g., phone, online collaborative spaces, photo sharing platforms, photo backup platforms, etc.) which can be difficult to access at the speed at which users communicate. This difficulty can lead to standardized and non-personalized communications.

An opportunity exists to create a system through which users can create, classify, acquire, access and distribute images at fast speed for use in conducting personalized image-based communication via a variety of mobile platforms, applications and devices, as well as to provide other benefits.

### BRIEF DESCRIPTION OF THE DRAWINGS

FIG. 1 illustrates a block diagram showing a sequence of steps demonstrating how ink sets are generated.

FIG. 2 illustrates an example starting point for a text messaging session.

FIG. 3 illustrates an example scenario where a user enters content items corresponding to a linked image.

FIG. 4 illustrates an example scenario of a text message sent by a user and including a linked image.

FIG. 5 illustrates an example scenario of a text message received by a user and including a linked image.

FIG. 6 illustrates an example scenario of the text linked to an image having been revealed.

FIG. 7 illustrates a display of a conversation, in which the recipient of a message inputs text to respond to a message.

FIG. 8 illustrates an example scenario of the text linked to an image having been revealed over multiple images.

FIG. 9 illustrates an example scenario of enlarging an image included within a message received.

FIG. 10 illustrates an example scenario of a user linking text to an image.

FIG. 11 illustrates the various options available for a user to link an image to text.

FIG. 12 illustrates an example scenario of a user linking text to an image using the “take photo” option.

FIG. 13 illustrates an example scenario of a user cropping an image.

FIG. 14 illustrates an example scenario of an image ready to be linked to text.

FIG. 15 illustrates an example scenario in which the text input has been converted to the linked image.

FIG. 16 illustrates an example scenario of a user linking text to an image using the “image search” option.

FIG. 17 illustrates an example of the web search results from the word “run.”

FIG. 18 illustrates an image a user has chosen to be linked from the web search results.

FIG. 19 illustrates an example of an image ready to be linked to text.

FIG. 20 illustrates an example scenario in which the text has been converted to the linked image from the web image search.

FIG. 21 illustrates an example scenario of a user linking text to an image using the “photo library” option.

FIG. 22 illustrates an example page from a user's photo library.

FIG. 23 illustrates an example of an image that a user has chosen from their photo library.

FIG. 24 illustrates an example scenario in which the text has been converted to the linked image from a user's photo library.

FIG. 25 illustrates an example scenario in which a user links an image to text by first choosing/creating an image.

FIG. 26 illustrates an example scenario in which a user is offered options for adding an image.

FIG. 27 illustrates an example scenario in which an image has been added using the “take photo” option.

FIG. 28 illustrates an example scenario in which a user inputs text.

FIG. 29 illustrates an example scenario of the linked image inserted within the compose message field.

FIG. 30 illustrates an example scenario in which a user continues typing a message.

FIG. 31 illustrates an example scenario of a message having been sent.

FIG. 32 illustrates an example scenario in which the text linked to the image is revealed within the message.

FIG. 33 illustrates an example of a user starting a message.

FIG. 34 illustrates an example of a blank web image search screen.

FIGS. 35A and 35B illustrate examples of web image search results.

FIG. 36 illustrates an example scenario of an image added using the “image search” option.

FIG. 37 illustrates an example scenario in which a user inputs text and links the image to text.

FIG. 38 illustrates an example scenario of a user inputting additional text after the linked image has been inserted within the compose message field.

FIG. 39 illustrates an example scenario of a user's ink set library.

FIG. 40 illustrates an example of the options available in creating a new ink set via the “create ink set” option.

FIG. 41 illustrates an example scenario of an image having been added using a “take photo” option.

FIG. 42 illustrates an example scenario of inputting text to link an image.

FIG. 43 illustrates an example scenario of an image having been linked to text directly from the ink set library.

FIG. 44 illustrates an example scenario of the newly created ink set within the ink set library.

FIGS. 45-53 illustrate an example scenario of how to edit an existing ink set.

FIG. 45 illustrates an example of a part of a user's ink set library.

FIG. 46 illustrates an example of an individual ink set.

FIG. 47 illustrates an example scenario of a user inputting additional text into an existing ink set.

FIG. 48 illustrates an example scenario where additional text has been added to an existing ink set.

FIG. 49 illustrates an example scenario of a user inserting an additional image into an existing ink set.

FIG. 50 illustrates an example scenario of a user taking a photo to add to an ink set.

FIG. 51 illustrates an example scenario in which a new image has been added to an existing ink set.

FIGS. 52-57 illustrate an example scenario of an image being linked to an emoji via the ink set library.

FIG. 52 illustrates an example scenario of image having been input.

FIG. 53 illustrates an example scenario of a user opening the emoji keyboard.

FIG. 54 illustrates an example scenario of a user inputting an emoji to link with an image.

FIG. 55 illustrates an example scenario where a user is prompted to link the emoji.

FIG. 56 illustrates an example scenario in which the emoji is now linked to the image.

FIG. 57 illustrates an example scenario showing a newly created ink set included within a user's ink set library.

FIGS. 58-60 illustrate an example scenario of multiple emojis being input in combination along with alphanumeric keys, as the text against which to link an image.

FIGS. 58-59 illustrate an example scenario of multiple emojis input as text.

FIG. 60 illustrates an example scenario of additional alphanumeric text input.

FIG. 61 illustrates an example scenario in which the text input is readied to link with an image.

FIG. 62 illustrates an example scenario of the method by which to source an image is chosen.

FIG. 63 illustrates an example scenario in which an image is chosen using a “photo library” option is used in FIG. 62.

FIG. 64 illustrates an example scenario of the text included within the compose message field converted to the linked image.

FIG. 65 illustrates an example scenario showing the message received on the recipient's device.

FIG. 66 illustrates an example scenario of the linked text revealed.

FIG. 67 illustrates an example scenario in which multiple images linked to emojis are used to compose a message.

FIG. 68 illustrates an example scenario showing the receipt of a message with text revealed.

FIG. 69 illustrates an example scenario showing a user inputting text.

FIG. 70 illustrates an example scenario in which text is being converted automatically to the default image included within an ink set.

FIG. 71 illustrates an example scenario of both the linked text along with any other images (variations) linked with the text being revealed.

FIG. 72 illustrates an example scenario in which a user taps on one of the variations to change the image.

FIG. 73 illustrates an example scenario in which a user, having changed the image, continues typing a message.

FIG. 74 illustrates an example scenario of a message having been sent.

FIG. 75 illustrates an example scenario in which the default image for the ink set has now changed.

FIG. 76 illustrates an example scenario of a message including an ink set ready to be sent.

FIG. 77 illustrates an example scenario in which a user has tapped on the image included within the compose message field to convert it to the linked text.

FIG. 78 illustrates an example scenario in which the message has been sent as text only.

FIG. 79 illustrates an example scenario of an empty compose message field.

FIG. 80 illustrates an example scenario in which a user has turned off the automatic conversion of text to image functionality. The system is now in default text mode.

FIG. 81 illustrates an example scenario in which a message is composed with the system in default text mode. Text which has been linked to an image(s) appears differentiated within a border.

FIG. 82 illustrates an example scenario in which the image(s) linked to text included within a border are revealed.

FIG. 83 illustrates an example scenario of text being replaced by an image.

FIG. 84 illustrates an example scenario of a message sent.

FIG. 85 illustrates an example scenario in which an image has been manually converted back to text prior to sending.

FIG. 86 illustrates an example scenario of a message sent as text.

FIG. 87 illustrates an example scenario of a message sent.

FIG. 88 illustrates an example of a message received.

FIG. 89 illustrates an example scenario to copy or delete a message.

FIG. 90 illustrates an example scenario to “delete” a message.

FIG. 91 illustrates an example scenario of a message checked and ready to be deleted.

FIG. 92 illustrates an example scenario of a user being asked to confirm the delete request.

FIG. 93 illustrates a blank message thread.

FIG. 94 illustrates copying a message on an alternate platform.

FIG. 95 illustrates pasting text into an ink compose message field.

FIG. 96 illustrates text pasted into an ink compose message field.

FIG. 97 illustrates a starting point for an image search within a personal ink set library.

FIG. 98 illustrates search results for images within a personal ink set library.

FIG. 99 illustrates options available to a user for image search results.

FIG. 100 illustrates an example scenario of linked text including multiple words.

FIG. 101 illustrates an example scenario of the automatic conversion of text to image with multiple words included within a single linked image.

FIG. 102 illustrates an example scenario of the image being sent and received in 1:1 aspect ratio.

FIG. 103 illustrates an example scenario in which the image expands to reveal the linked text.

FIG. 104 illustrates an example scenario of an ink set library.

FIG. 105 illustrates an example scenario in which a user places a check mark against some ink sets.

FIG. 106 illustrates an example scenario of a user's Friends screen.

FIG. 107 illustrates an example scenario of choosing Friends with whom to share ink sets.

FIG. 108 illustrates an example scenario of an ink set library.

FIG. 109 illustrates an example scenario of an individual ink set.

FIG. 110 illustrates an example scenario of editing an ink set.

FIG. 111 illustrates an example scenario where an image(s) and text(s) are selected to delete.

FIG. 112 illustrates an example scenario in which a user is prompted for confirmation.

FIG. 113 illustrates an example scenario showing selected items having been deleted.

FIG. 114 illustrates an example scenario of a blank compose message field.

FIG. 115 illustrates an example scenario of the system ready to accept dictation.

FIG. 116 illustrates an example scenario in which a message is dictated into the device.

FIG. 117 illustrates an example scenario of the system automatically converting linked text(s) included within the message to image(s).

FIG. 118 illustrates an example scenario of a message created using voice recognition, having been sent.

FIG. 119 illustrates an example scenario showing the receipt of a message revealing linked text.

FIGS. 120-126 illustrate an example scenario in which a message is created and shared on a platform outside ink.

FIG. 120 illustrates an example of a user's Friends list.

FIG. 121 illustrates an example scenario of a blank compose message field used to compose and share a message outside ink.

FIG. 122 illustrates an example scenario in which a message is created.

FIGS. 123-124 illustrate examples of platforms on which a message can be sent/posted.

FIG. 125 illustrates an example of a rendered version of a message, ready to be sent via SMS.

FIG. 126 illustrates an example scenario of a rendered message having been received.

The process described in FIGS. 120-126, can be replicated on various other platforms.

FIG. 127 illustrates an example scenario of a message received.

FIG. 128 illustrates an example scenario of an image enlarged.

FIG. 129 illustrates an example scenario of available options to share/save an image only or image plus linked text.

FIG. 130 illustrates an example of a user preparing to save an enlarged image received, along with the linked text, to their personal ink set library.

FIG. 131 illustrates an example of an ink set saved to a device.

FIG. 132 illustrates an example scenario in which a newly saved ink set is used in the creation of a message.

FIG. 133 illustrates an example scenario in which a message is received and text revealed.

FIG. 134 illustrates an example scenario in which a recipient enlarges a message.

FIG. 135 illustrates an example scenario in which a user prepares to save the image to their personal ink set library. Both the image and its linked text are shown.

FIG. 136 illustrates an example scenario in which a user chooses to link an image to alternate text.

FIG. 137 illustrates an example scenario of an image saved with alternate linked text.

FIG. 138 illustrates an example scenario in which the image saved previously is used in the creation of a message.

FIG. 139 illustrates an example scenario in which the same image is shown in the body of messages linked to different text by separate users.

FIG. 140 illustrates an example scenario of a conversation thread between users in different languages.

FIG. 141 illustrates a sample paradigm in which acronyms are used in the creation of ink sets.

FIG. 142 illustrates an example scenario of a text abbreviation linked to an image.

FIG. 143 illustrates an example scenario in which a phrase is input for conversion.

FIG. 144 illustrates an example scenario in which a branded image linked to a phrase has been enlarged.

FIG. 145 illustrates an example scenario a GIF created by a user sent in a message and enlarged.

FIGS. 146-149 illustrate examples of the ink software development kit being utilized on other messaging applications and social media platforms to compose messages.

FIG. 150 illustrates a sample paradigm in which a branded ink set is created.

FIG. 151 illustrates a sample paradigm of a personal ink set.

FIG. 152 illustrates an example scenario of a message composed using brand ink.

FIG. 153 illustrates an example scenario of a brand image enlarged.

FIG. 154 illustrates an example of various brand inks within a brand library.

FIG. 155 illustrates an example scenario of search results from the ink brand library for specific text.

FIG. 156 illustrates an example of an individual branded ink set including a populated word set.

FIG. 157 illustrates an example of various brand inks.

FIG. 158 illustrates an example scenario in which a user chooses to download a brand ink.

FIG. 159 illustrates an example scenario of the composition of a message using branded ink sets.

FIG. 160 illustrates an example scenario of a message with text revealed.

FIG. 161 illustrates an example scenario of an enlarged image.

FIG. 162 illustrates an example scenario of a brand-designated web page, accessible via a hyperlink attached to a brand ink.

FIGS. 163A-163B illustrate an example scenario of the use of a branded font.

FIG. 164 illustrates an example scenario of various brand inks downloaded to a device.

FIG. 165 illustrates an example scenario of various brand inks having been turned off.

FIG. 166 illustrates an example of a message thread composed with a brand ink.

FIG. 167 illustrates an example of a message thread composed with a brand ink with text revealed.

FIG. 168 illustrates an example of a brand homepage.

FIG. 169 illustrates an example scenario of a message sent from a brand.

FIG. 170 illustrates an example of an enlarged branded image.

FIG. 171 illustrates an example of the system being utilized on a smartwatch/smart device accessory.

FIG. 172 is a block diagram illustrating an overview of devices on which some implementations can operate.

FIG. 173 is a block diagram illustrating an overview of an environment in which some implementations can operate.

FIG. 174 is a block diagram illustrating components which, in some implementations, can be used in a system employing the disclosed technology.

FIG. 175 is a flowchart showing the steps of operation of a mobile application for generating linked images according to embodiments of the present disclosure.

FIG. 176 is a sequence diagram showing interactions between devices and components according to embodiments of the present disclosure.

### DETAILED DESCRIPTION

This application discloses a system and related methods that allow a user to link images from a personal album or camera, licensed image(s)/collections, public-domain sources, publically available images, as well as copyright protected images (with the permission of the copyright holder), to content items (e.g. a word, an expression, a collection of characters, a number, an alphanumeric character, or an emoji), and use the linked images in mobile messaging. As disclosed herein, a mobile application program running on a user's mobile device creates links between an image and a content item, thereby creating a linked image which is stored in a memory of the mobile device of the user. When a user inputs or enters the same content item (e.g., a word) used in creating a linked image, the mobile application program facilitates the automatic conversion of that word to the linked image, ready to be sent either in a text message by a text messaging application or via alternate messaging or social media platforms. In some embodiments, the disclosed mobile application allows toggling between the linked image and the content item when a user clicks or taps on a linked image. Thus, for example, when a user enters a word in a text message, the word is automatically converted into a linked image and included in the text message. When the user clicks on the linked image, the linked image is converted into the word within the text message. Alternatively, the system can enable content items to be inserted, without automatically converting the content item(s) to linked image(s). In this case, content items already linked to an image(s) are differentiated from text entries/content items that are not linked (for example, by being displayed in another color/font/size, or as depicted for the purposes of this application, being displayed surrounded by a border, or emphasized by being bolded, highlighted, or noted in a different text font). The user can then change a content item to a linked image by tapping on any content item that is shown differentiated. This functionality is referred to in this application as the “default text mode.” As used herein, the term “text message” refers broadly to any kind of message, including and not limited to messages composed using components of short messaging service (SMS) and/or multimedia messaging service (MMS).

The disclosed mobile application enables images to be incorporated directly within the body of a message so that they appear in-line with other images and text. Images appear in sequence and are in context with the message body, rather than being sent separately. Images are sent along with linked text as part of the message. In addition to linked images, the message can also include additional images that are not necessarily linked to a content item.

The disclosed system also includes APIs (application programming interfaces) and an SDK (software development kit) to allow linked images to be used by other platforms and applications, including, but not limited to, keyboards, email, messaging applications, social media applications and platforms, etc. The system also provides a method of image indexing, storing and retrieval, allowing users to organize images by linking them with text, facilitating ease of access at speed.

In some embodiments, the mobile application allows the user to input text via dictation, which can be converted to linked images. The techniques disclosed in this application can be implemented on a computing device, including a mobile device, such as a cellular phone, a tablet, a laptop computer, or a wearable device.

In some embodiments, the present disclosure also discloses a method by which brands, organizations, and entities are able to establish their own image-based vocabulary, allowing customers or followers of a brand to communicate, (even within personalized settings), in branded images. This enables brands to become a part of the user narrative, to fit in with what the user wants to discuss, at the very moment the user wants to have the conversation. Specifically, the mobile application automatically converts content items into corresponding linked images for use in text message communication. Users and brands can communicate either (1) one to one, (2) one to group, or (3) one to many.

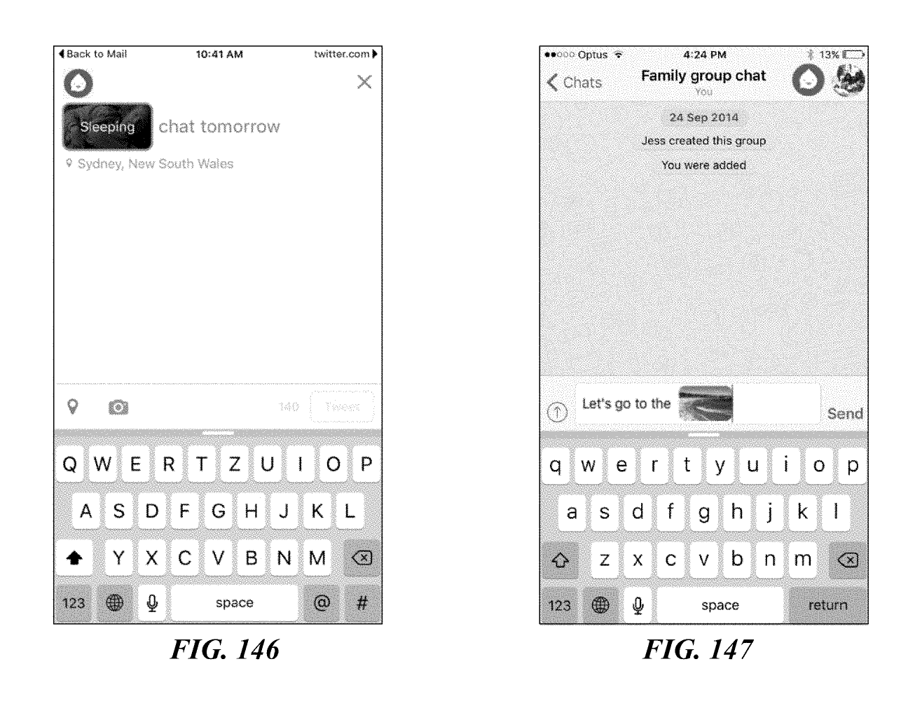

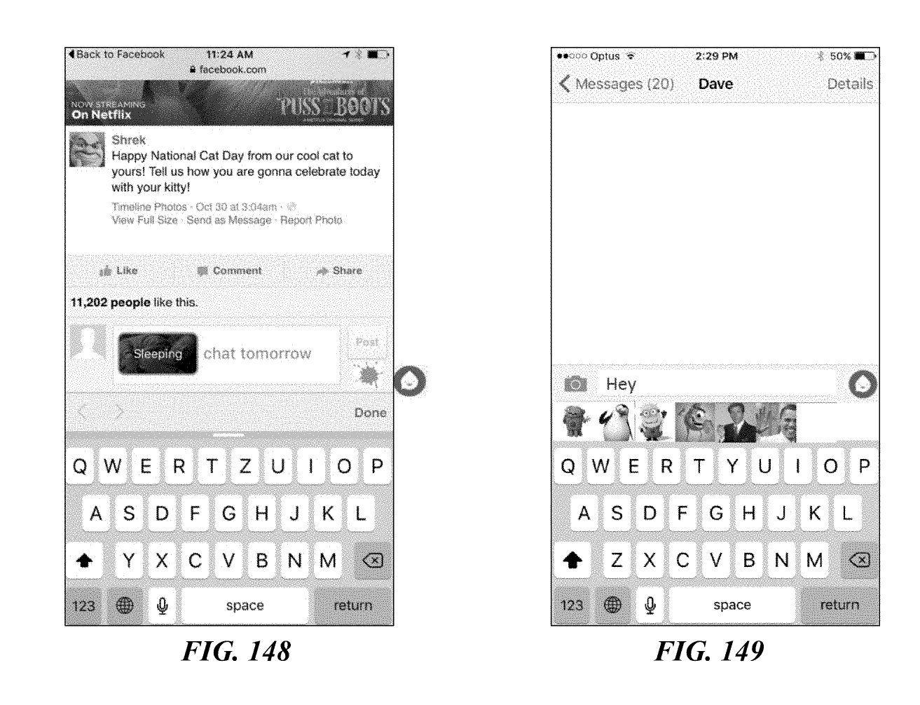

The present disclosure also provides APIs (application programming interfaces) and an SDK (software development kit) to allow linked images to be utilized by other platforms and applications, including, but not limited to, keyboards, email, messaging applications, social media platforms, etc. In some embodiments, the linked images can be included for use in a licensed API/SDK within other applications, platforms and operating systems. The use of linked images within an operating system's native messaging application and other messaging platforms is illustrated in the example scenarios in FIGS. 146-149.

The terms used in this specification generally have their ordinary meanings in the art, within the context of this disclosure, and in the specific context where each term is used. Certain terms that are used to describe the disclosure are discussed below, or elsewhere in the specification, to provide additional guidance to the practitioner regarding the description of the disclosure. Alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

An “image” refers to any image-based representation, including, but not limited to, figures, branded fonts, photos, ideograms, GIFs, videos, drawings, clip art, vectors, etc. A “personal image” refers to an image created by a user or taken from the public domain for use by the user. A “default image” refers to that image within an image set, which is automatically assigned for conversion. A “limited edition branded image” refers to an image with a set number of copies available. A “default text mode” refers to a functionality that disables the automatic text-to-image conversion and instead displays content items that are linked to images, differentiated from content items that are not linked. An “image set” refers to a set of associated images. An “image source” refers to any location from which an image is sourced. A “base word” is a word that is associated with one or more linked images (also referred to herein as an ink set of linked images). An “ink set” refers to a combination of a word set and its associated image set. A “personal ink” refers to a compilation of images or “ink sets” created using a user's content and/or various branded content (with the permission of the copyright holder). A “personal ink set library” is a collection of ink sets compiled by a user from various sources and stored as a database, table or any suitable data structure to permit rapid searching and retrieval. “Linking,” “link” or “linked” refers to an action whereby an image(s) is associated with text(s) (more generally, content items) in a way that facilitates automatic conversion between a linked image and an associated content item representative of that image. “Text,” also referred to herein as a “content item” refers to any input inserted into a text field by use of but not limited to the following: a keyboard, voice recognition, copy and paste, etc., and that can take the form of words, text, phrases, terms, expressions, abbreviations, acronyms, ideograms, etc. In some embodiments, more than one base word can be associated with a linked image. A “brand” is a content provider for ink sets. A “content provider” refers to an individual or company that creates an image. A “data source” refers to a location from which text can be sourced. A “branded font” refers to a particular font used in conversion of a content item into a linked image and vice-versa. A “branded image” can be one or more copyright-protected images. A “brand ink” is a group of ink sets from the same content provider. A “branded ink set” refers to a combination of a one or more words and its associated branded image set. A “brand library” is an image repository that stores images (linked to text). In some embodiments, “communication” refers to an exchange of information through text and images typically in a mobile environment through text messaging, email, etc.

A “variation(s)” refers to those images included within an image set, other than the default image. A “user” refers to anyone using the system. A “word frequency list” is a list of commonly used words in English and their synonyms). A “word set” refers to a set of words, text, phrases, terms, expressions, abbreviations, acronyms, ideograms, etc., compiled from various data sources. A word set can include as few as one or as many inputs as necessary.

In the following description, for the purposes of explanation, numerous specific details (e.g. screen shots) are set forth in order to provide a thorough understanding of embodiments of the present technology. It will be apparent, however, that embodiments of the present technology may be practiced without some of these specific details.

### Creation of Ink Sets

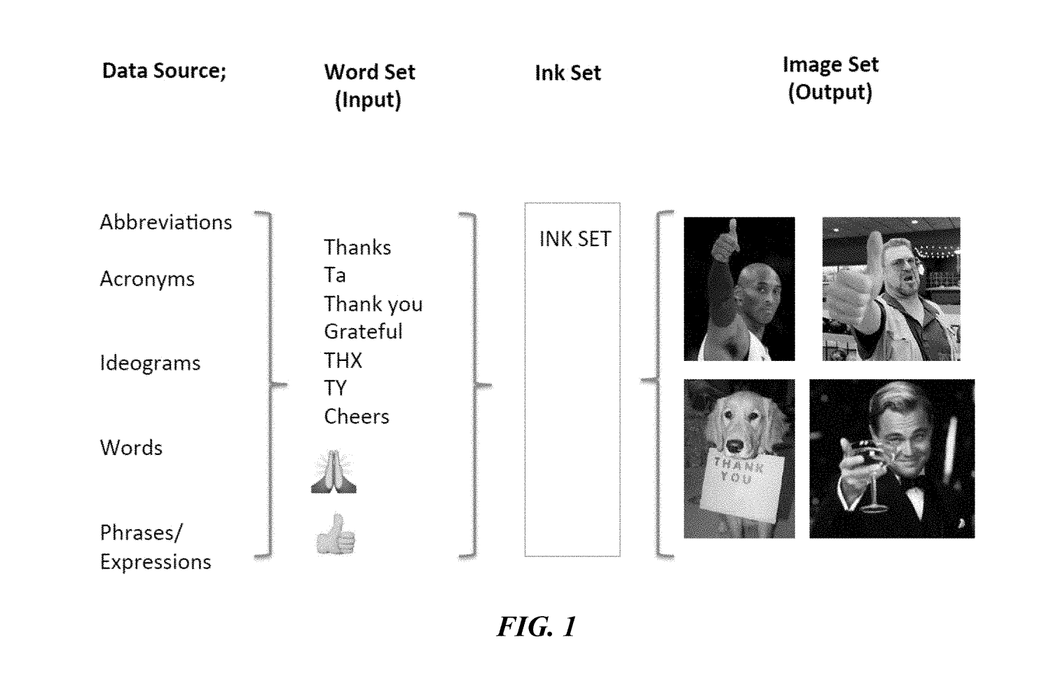

FIG. 1 illustrates a block diagram showing a sequence of steps demonstrating how ink sets are generated. Content items (e.g., an abbreviation, an acronym, an ideogram, a word, a phrase, or an expression) received from a data source are used as a word set for generating ink sets. The word set, for example, can also include emojis, as shown in FIG. 1. In this example, the content items “Thanks,” “Ta,” “Thank you,” “Grateful,” “THX,” “TY,” “Cheers,” and two emojis are associated with four images to create four linked images.

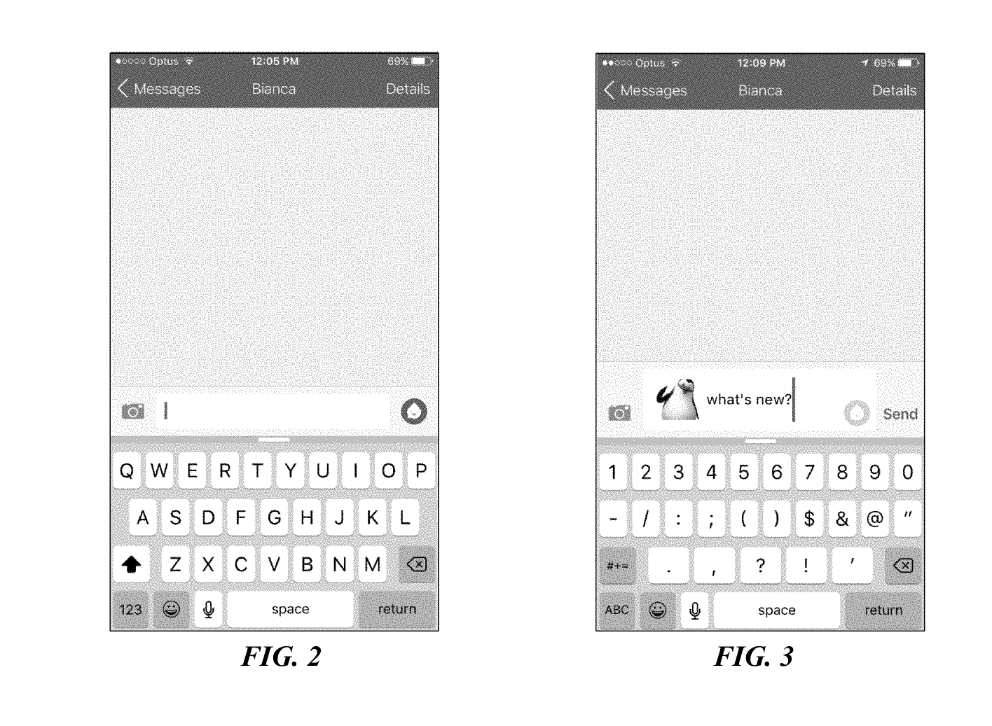

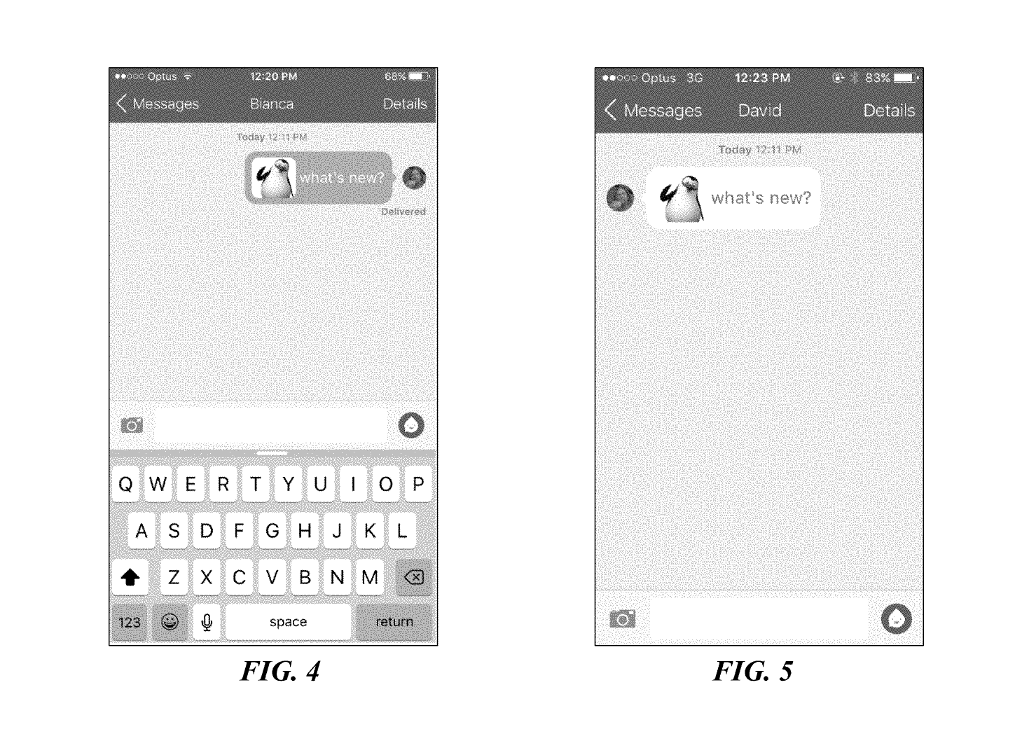

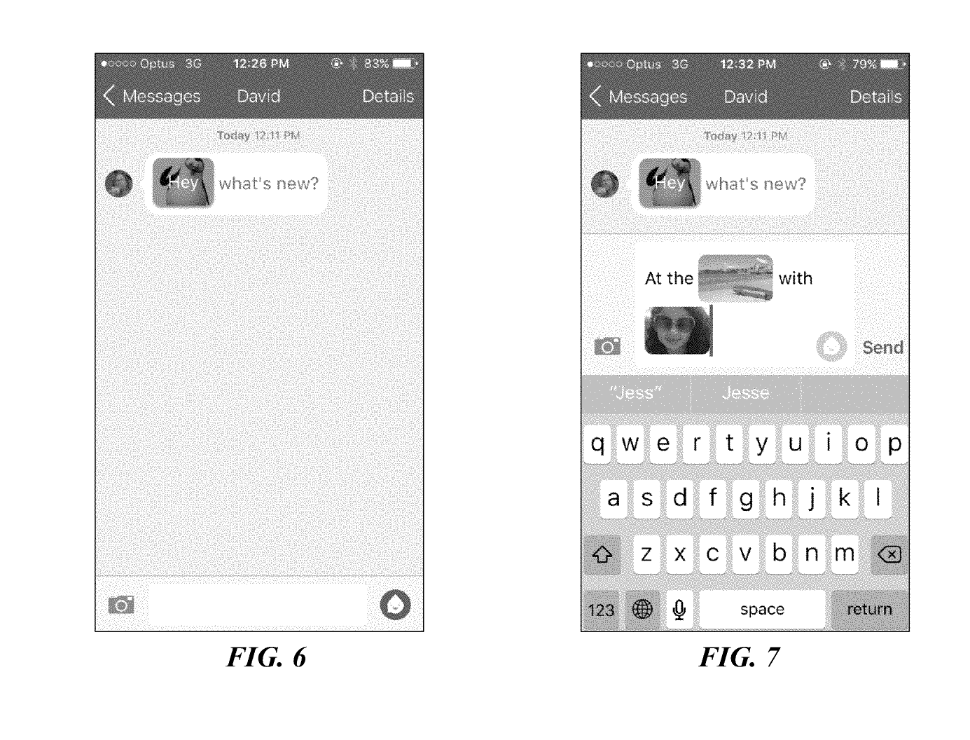

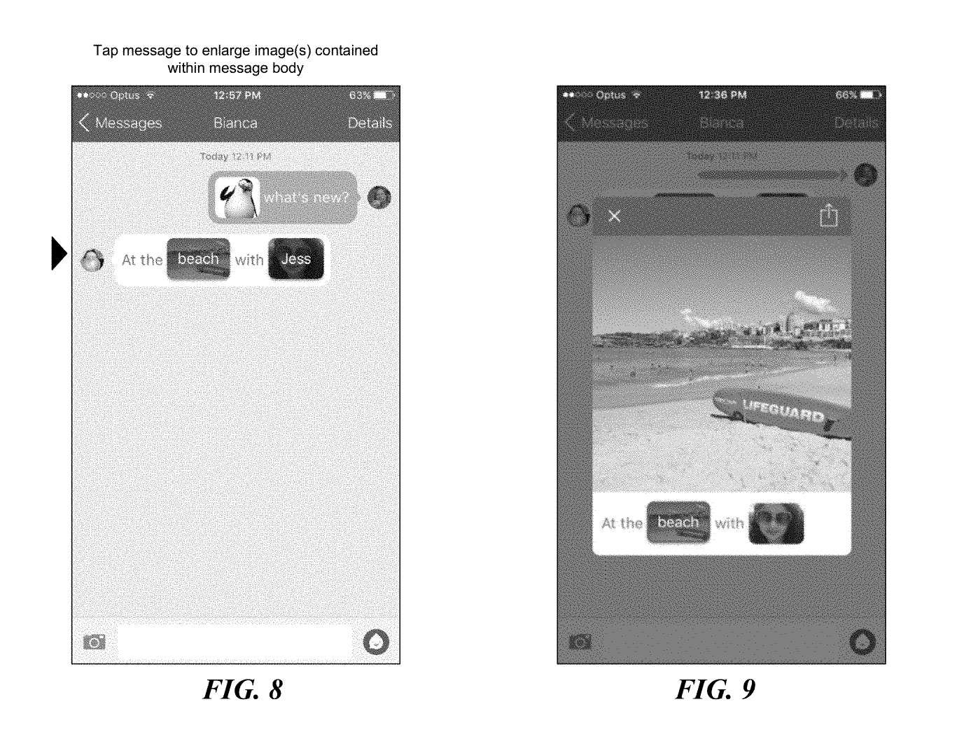

FIGS. 2-9 illustrated example text messaging (or, specifically typing) interfaces including linked images or words/content items associated with linked images. The user can be typing a message to a second user. The second user can be included in a contact list stored on the user's mobile device.

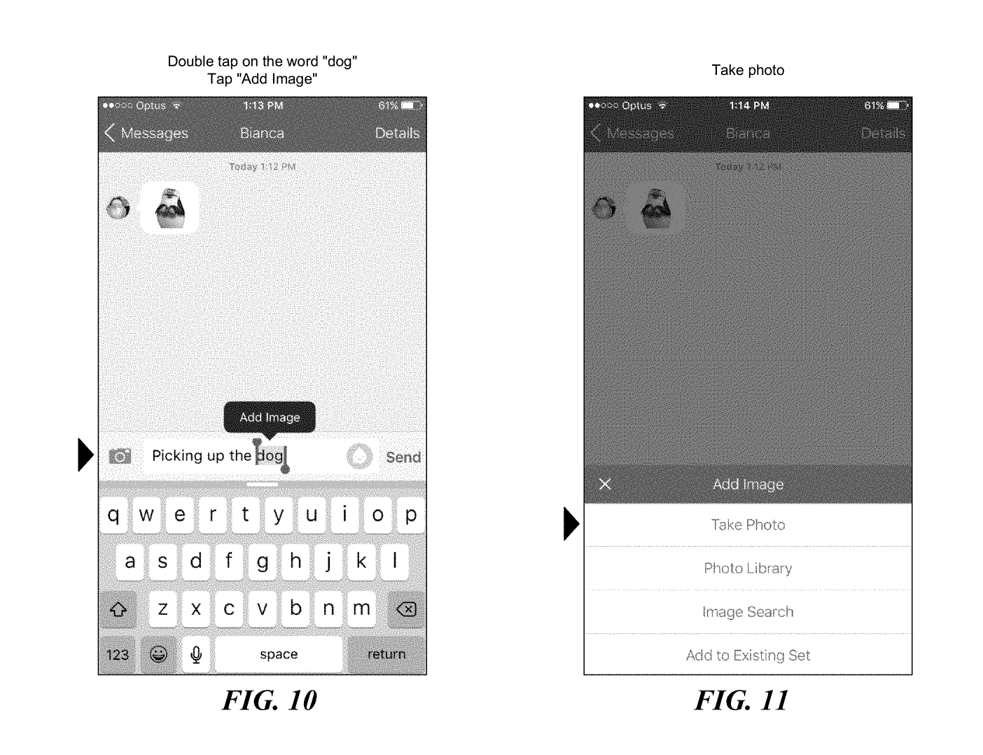

FIGS. 10-15 illustrate an example linked image generated by a mobile application running on a user's mobile device. Specifically, in this example, the disclosed mobile application generates a linked image corresponding to (or, representative of) the word “dog” and the user captures an image of the dog using a camera on the user's mobile device. FIG. 10 illustrates a typing interface in which a user inputs text into the compose message field of a mobile application (e.g., a text messaging application). To link a word to an image, the user double taps on a word, for example, the word “dog.” This action both highlights the text and displays additional menu options for the user to select, as indicated in FIG. 11. By tapping “add image,” the user is then prompted to choose a method for adding an image to generate a linked image corresponding to the word “dog.”

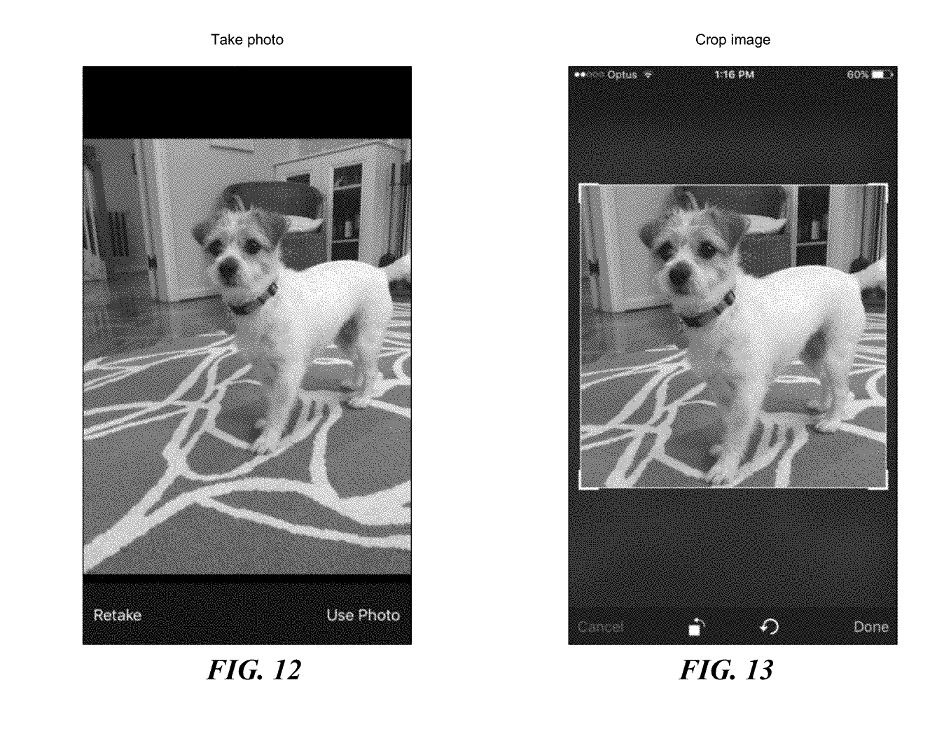

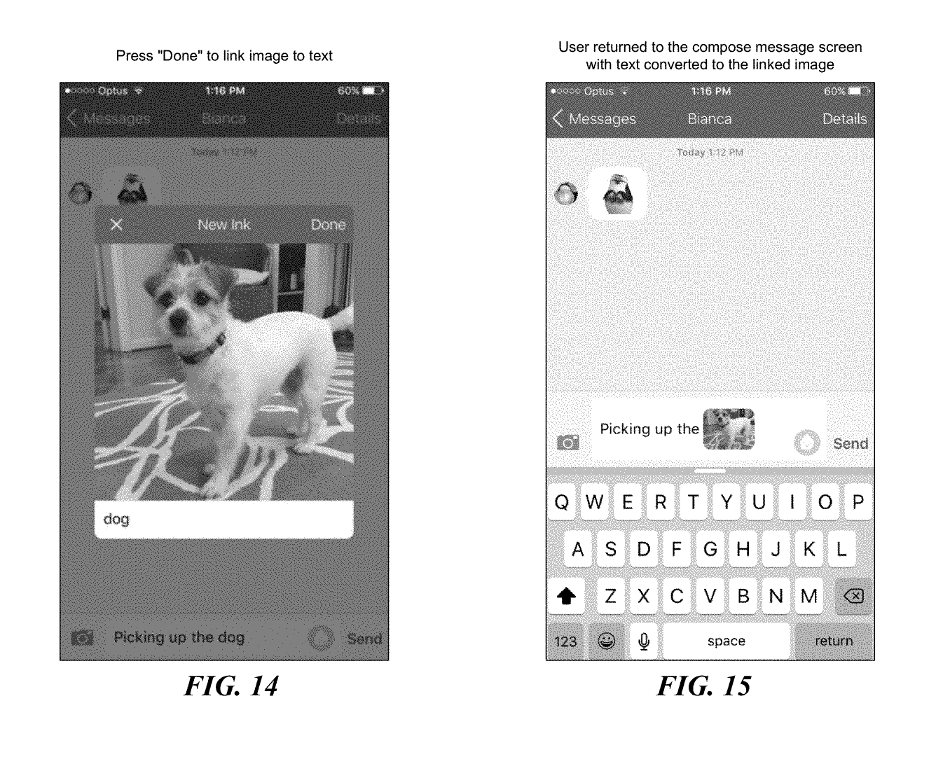

The example shown in FIG. 11 illustrates a user selecting the “take photo” option. When the user clicks on the “Take photo” option depicted in FIG. 11, the camera application on the user's mobile device launches automatically (FIG. 12). The user captures an image (in this example, a picture of a small dog) and is then able to crop the image (FIG. 13). Once cropped, the image is displayed (FIG. 14) within a pop-up window, along with the text previously highlighted (e.g., the word “dog”). As disclosed herein, the pop-up window is generated by the disclosed mobile application and is overlaid on a text messaging interface (e.g., shown in the background of the pop-up window in FIG. 14) of the text messaging application. In some embodiments, the text messaging application can be a default text messaging application associated with an operating system running on the user's mobile device. In some embodiments, the text messaging application can be a third party application running on the user's mobile device. Thus, the disclosed mobile application provides the functionality of integrating or communicating with one or more mobile applications running on the user's mobile device. In some embodiments, the disclosed mobile application is the text messaging application for composing text messages that include one or more linked images corresponding to content items. Tapping “done” in FIG. 14 saves the text and image together as an ink set (e.g., a linked image). The user is then returned to the compose message field on the typing interface, where the text has been converted automatically to the linked image of the dog, as illustrated in FIG. 15. FIG. 15 also shows that the disclosed mobile application inserts a condensed (e.g., smaller) version of the linked image into a text message composed by the user. The mobile application automatically converts the word “dog” to the linked image when the word “dog” is entered by the user in subsequent text messages composed by the user. If the user desires to use the word “dog” instead of the linked image in a text message, the user can click or tap on the linked image to toggle between the linked image and the word corresponding to the linked image. This example demonstrates that linked images can be generated dynamically at the time of composing a text message, and are not necessarily pre-stored in a memory of the user's mobile device. Furthermore, the images used in linked images can also be captured in real time, (e.g., when creating a linked image).

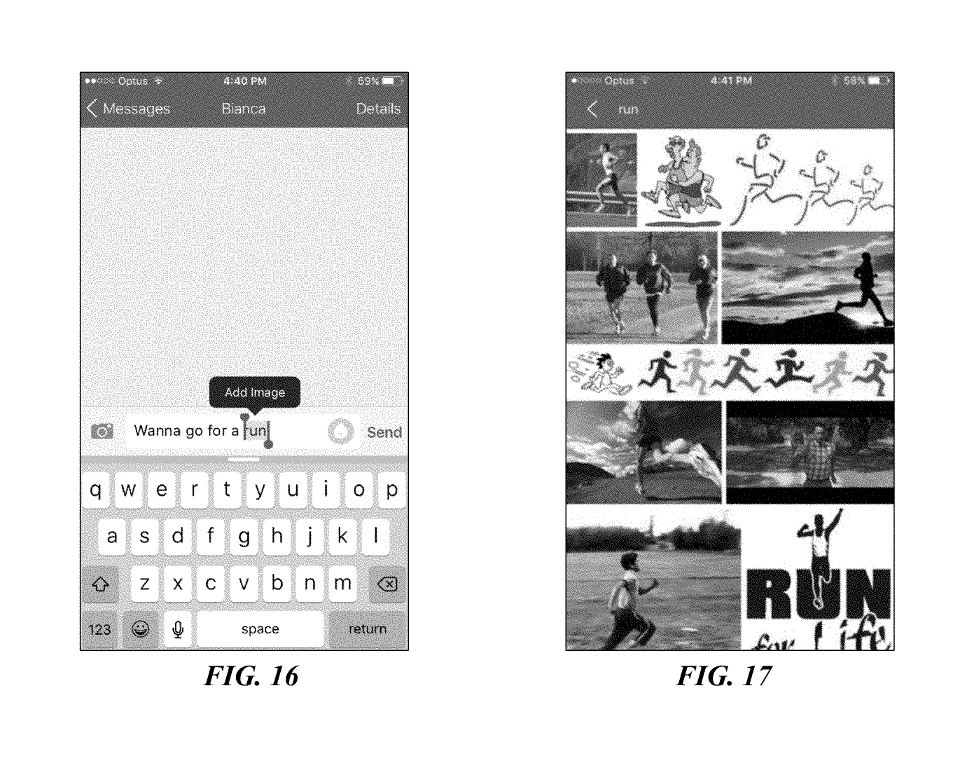

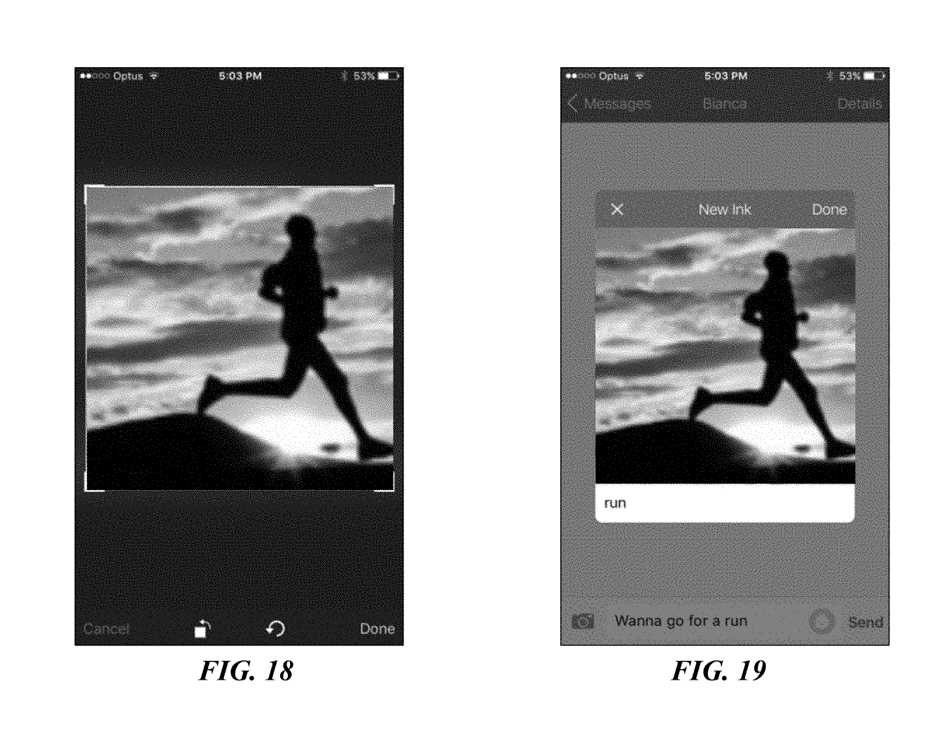

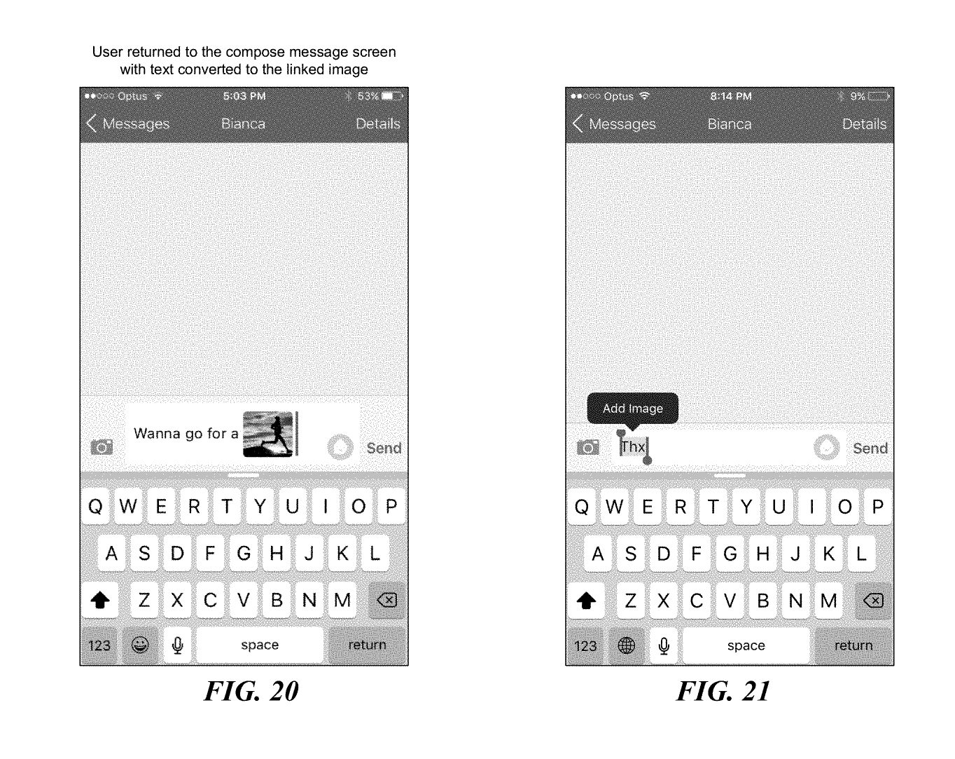

In some embodiments, images that are used in linked images can also be received from online image libraries. FIGS. 16-20 illustrate an example linked image generated by a mobile application running on a user's mobile device. Specifically, in this example, the image is received from an online image library. In such embodiments, the mobile application can access the online images when a user clicks on the “image search” option shown in FIG. 11. The user highlights the text (e.g., the word “run”) to link (FIG. 16) on a typing interface of a text messaging application, taps “add image” and selects the “image search” option (FIG. 11). As illustrated in FIG. 17, the search box is automatically populated with the highlighted text and image search results (e.g., received from an online library) corresponding to the highlighted text. FIGS. 18-19 illustrate the user choosing an image from the search results (in the example, a person running outdoors) to link with the highlighted text. Once linked, the user is automatically taken back to the compose message field on the typing interface of the text messaging application wherein the highlighted text is automatically converted to the linked image, as illustrated in FIG. 20. FIG. 20 also demonstrates that the disclosed mobile application inserts a condensed version of the linked image into a text message composed by the user using the typing interface. This example demonstrates that linked images can be generated dynamically at the time of composing a text message, and are not necessarily pre-stored in a memory of the user's mobile device. Furthermore, an image used in generating a linked image can be received in real time from an online repository or library of images.

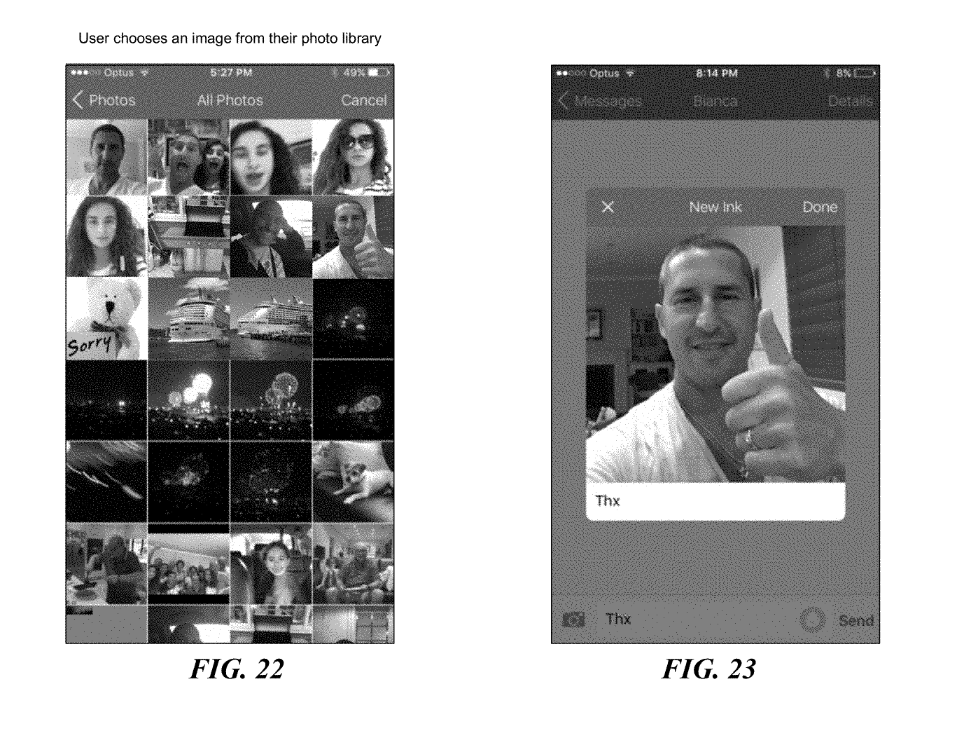

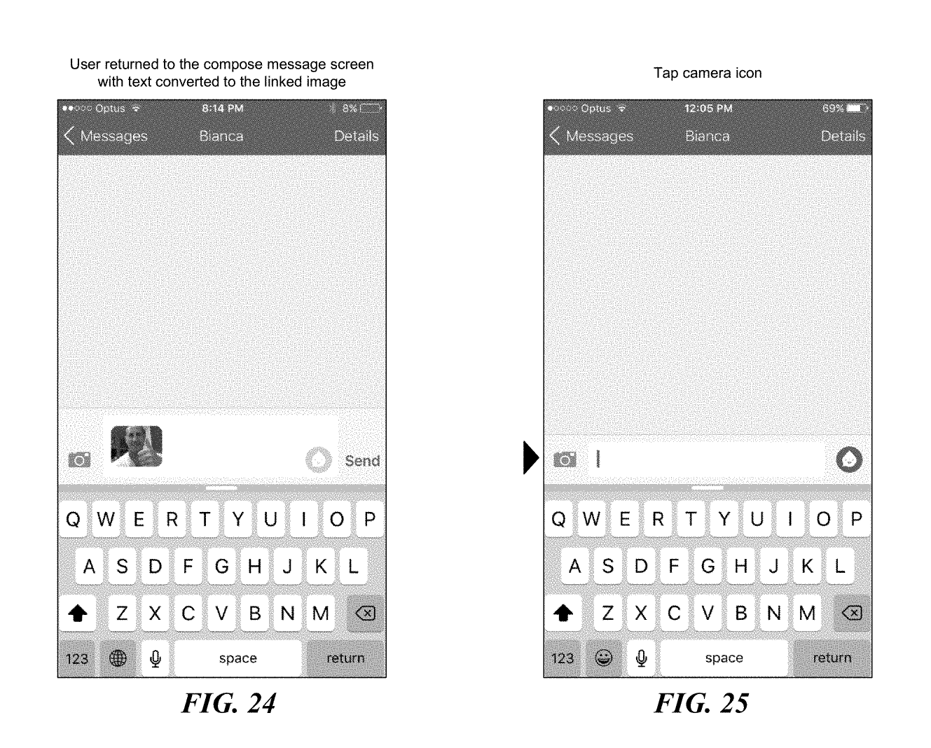

In some embodiments, a linked image can be generated using an image (e.g., a personal image) stored in a photo library of the user's mobile device. FIG. 21 illustrates an example scenario of a user inputting a collection of characters (e.g., the abbreviation “thx”) as text/content items. FIGS. 22-24 illustrate an example scenario in which the user taps on the “photo library” option (displayed in FIG. 11), chooses an image (in this example, a man smiling and giving a thumbs up gesture), links the image and is taken back to the compose message field, with the linked image in place, as illustrated in FIG. 24. A condensed version of the linked image is included in a text message composed by the user on the typing interface.

The three examples (using “take photo,” “image search,” and “photo library” options in FIG. 11) described above can also be referred to as “creating an ink on the fly.” These examples demonstrate that in disclosed embodiments content items and images can be linked while a message is being composed.

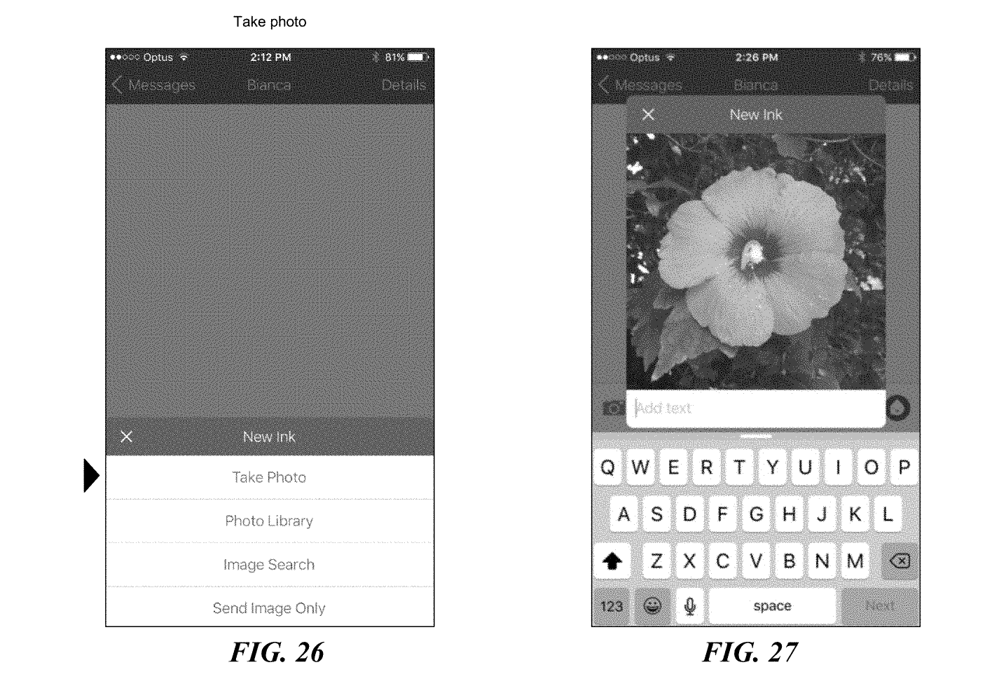

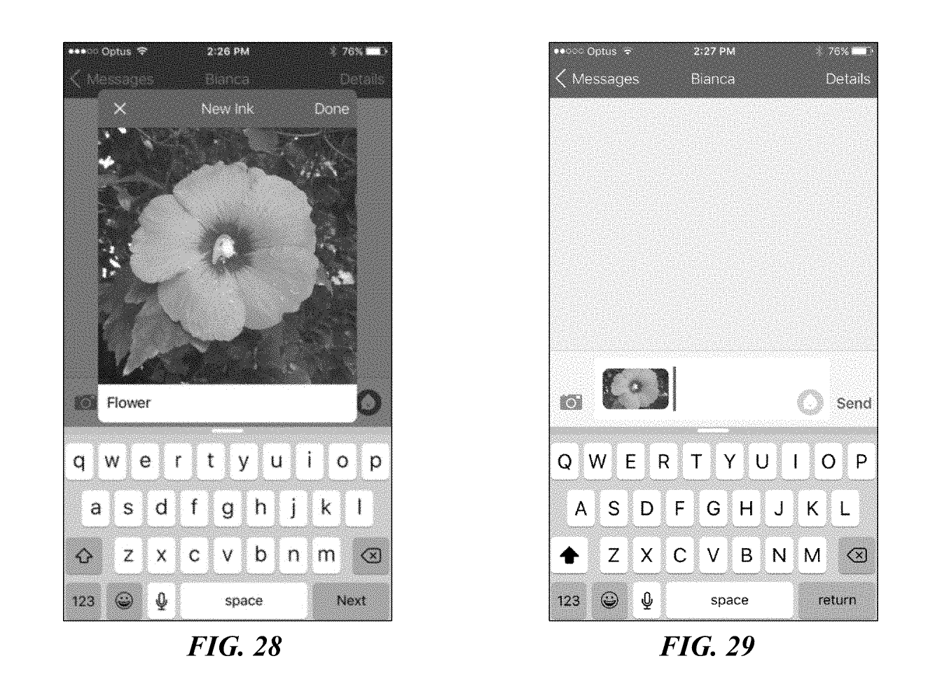

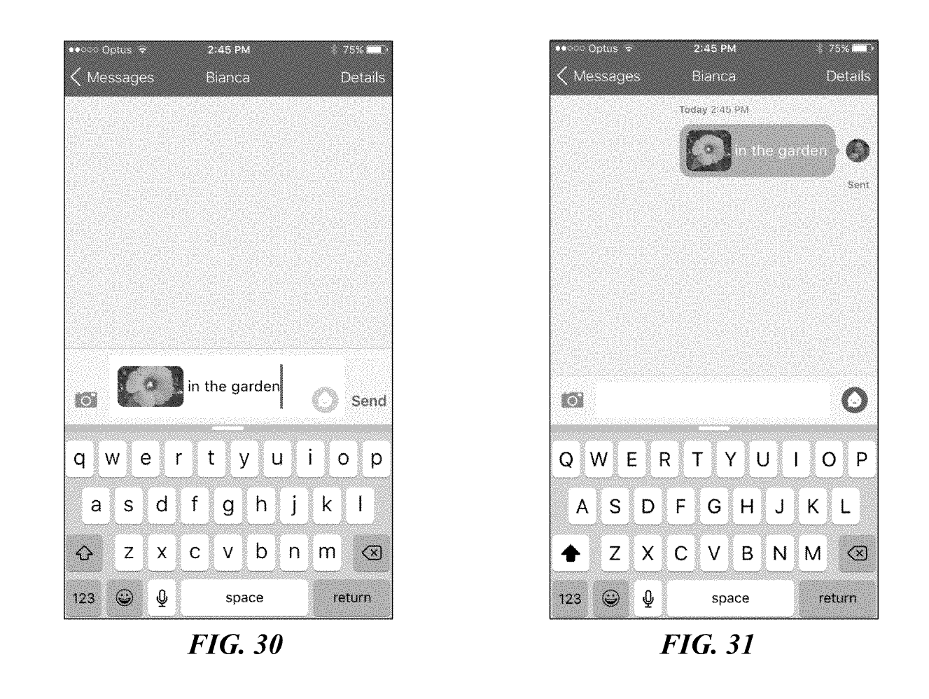

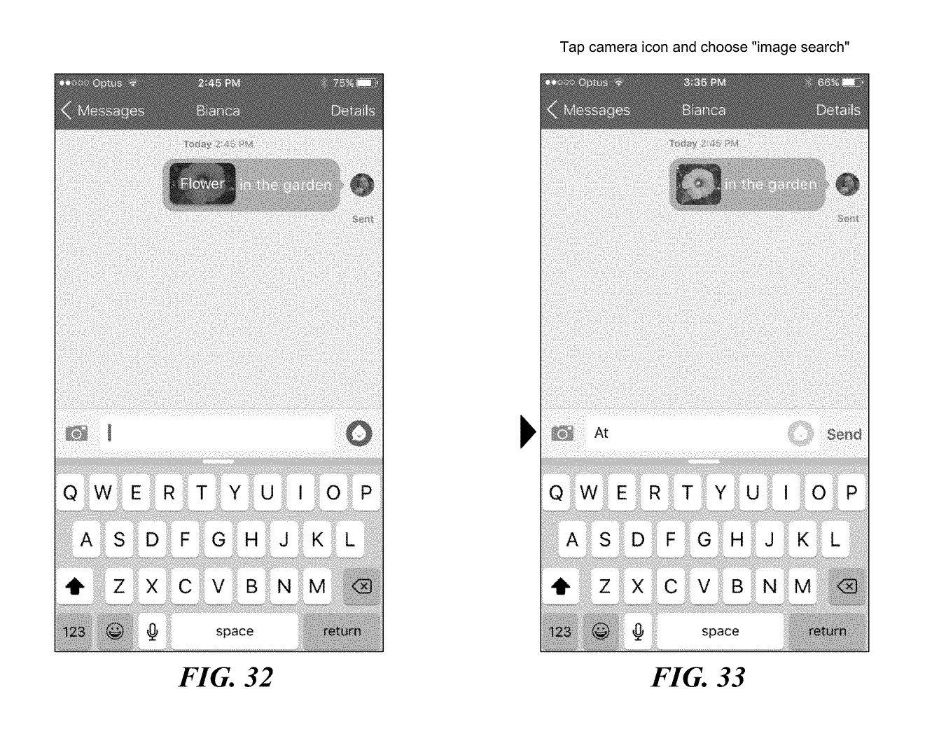

In some embodiments, ink sets (e.g., a collection of linked images and content items corresponding to the linked images) can also be created “on the fly” by choosing an image prior to inputting text on a typing interface (e.g., as demonstrated by the examples in FIGS. 10-24). In such embodiments, a user chooses an image prior to inputting text by tapping on the camera icon (FIG. 25) to open options (shown in FIG. 26). In this example, the user chooses the “take photo” option depicted in FIG. 26. The user captures an image (in this example, a flower), using a camera on the user's device, then crops the image and is prompted to “add text” to link the image as shown in FIG. 27. In this example, the user inputs the word “flower” (FIG. 28) via a pop-up window generated by the disclosed mobile application. Once the linked image is saved, the user is taken back to a compose message field on a typing interface of a text messaging application, with a condensed version of the linked image inserted in the typing interface (FIG. 29). The user can then continue composing the message, as illustrated in FIG. 30, “flower in the garden.” FIG. 31 indicates that the message is sent by the text messaging application. The text (e.g., content item) linked to the image can be revealed by swiping over the sent message as illustrated in FIG. 32. The procedure described in FIGS. 26-32 is also applicable when a user chooses to input an image from their photo library, with a user choosing the “photo library” option and the image being sourced from the devices library.

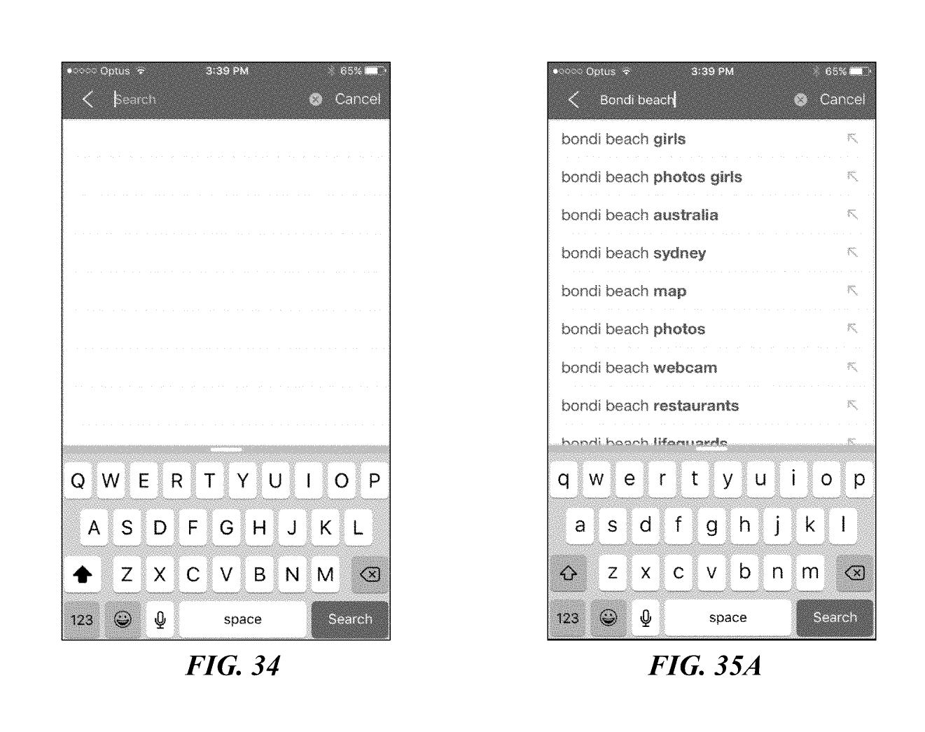

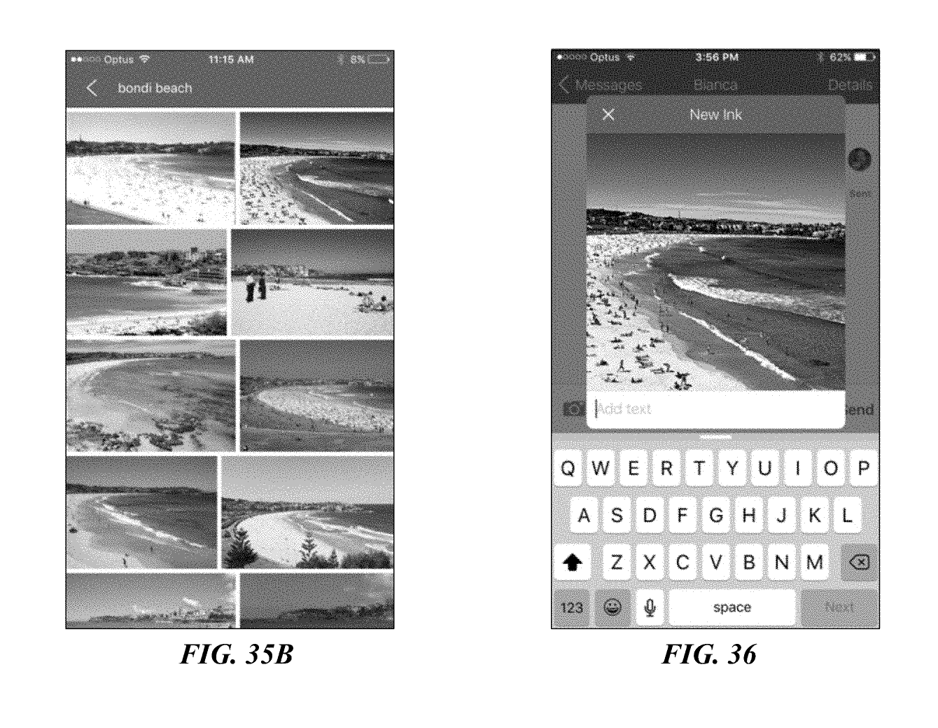

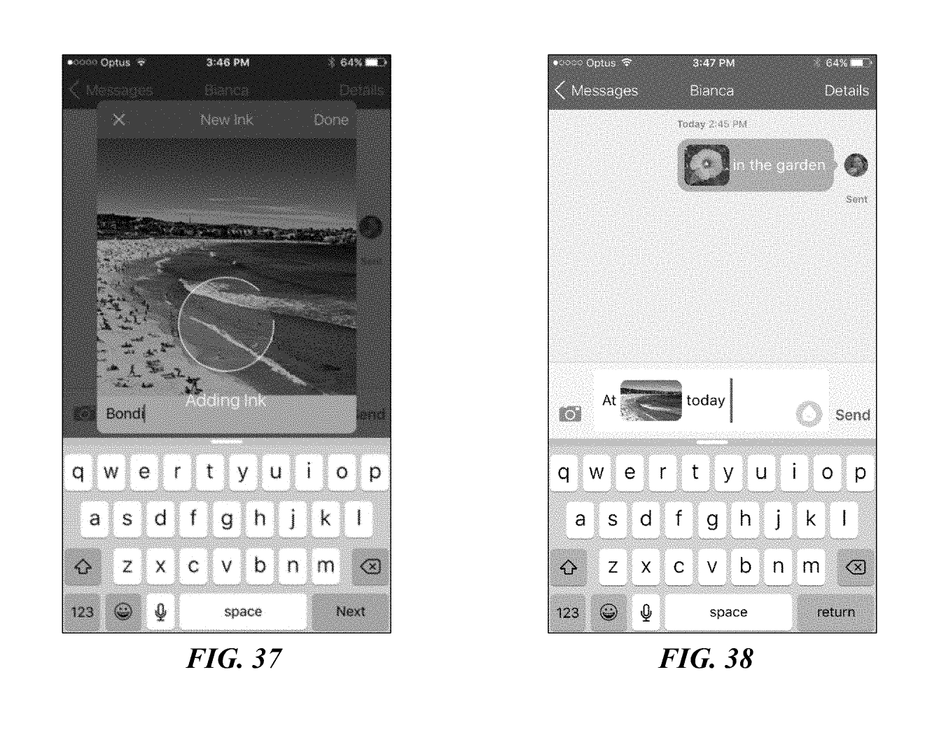

FIGS. 33-34 illustrate an example scenario in which the “image search” option of FIG. 26 is selected. The user is taken to the image search screen to insert text in the search field, as illustrated in FIG. 34. The user then inputs the required image search information (in this example “Bondi beach”) as illustrated in FIG. 35a, and chooses an image from the image search results shown in FIG. 35b. The image search results in FIG. 35 can be received from an online library of images. The user then crops the image and is prompted to “add text” to link the image. In FIG. 37, the word “Bondi” is entered by the user and linked to the image. Once linked, the user is taken back to the compose message field on the typing interface of the messaging application, with a condensed version of the linked image inserted in the text message. The user continues composing the message, “at Bondi today,” as illustrated in FIG. 38 and hit “send”. Once sent, the linked image can be viewed by a recipient of the message included in the text message composed by the user.

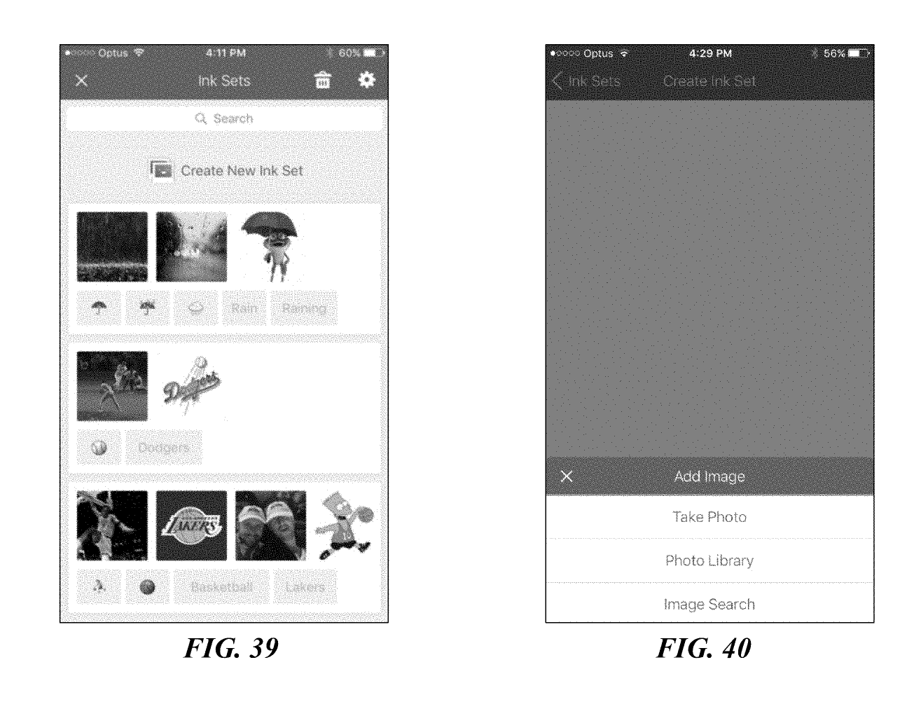

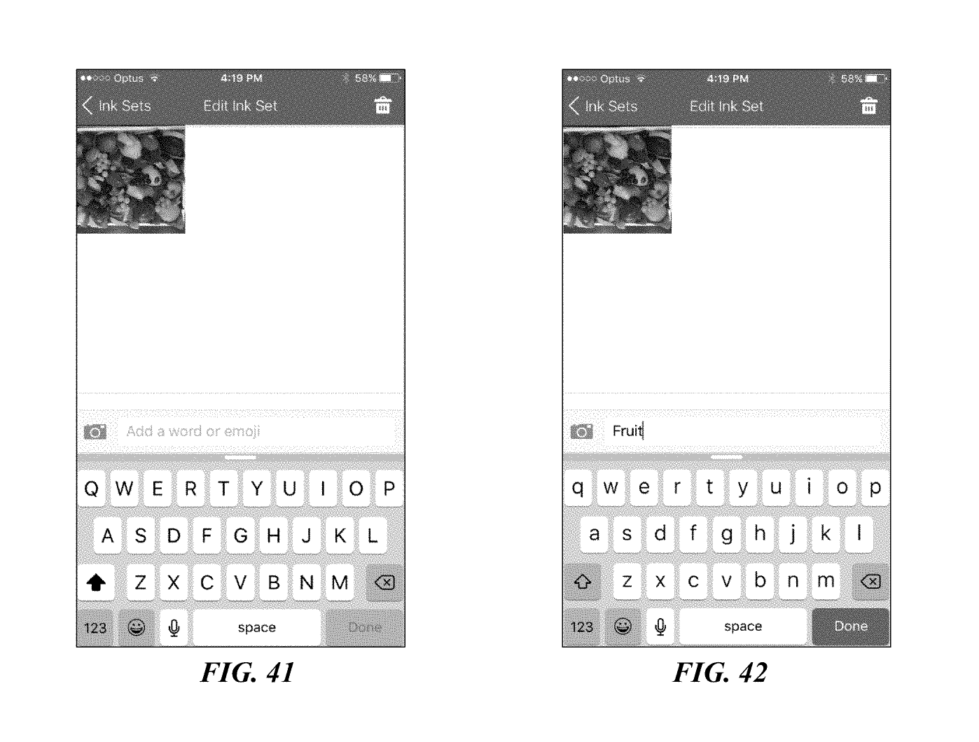

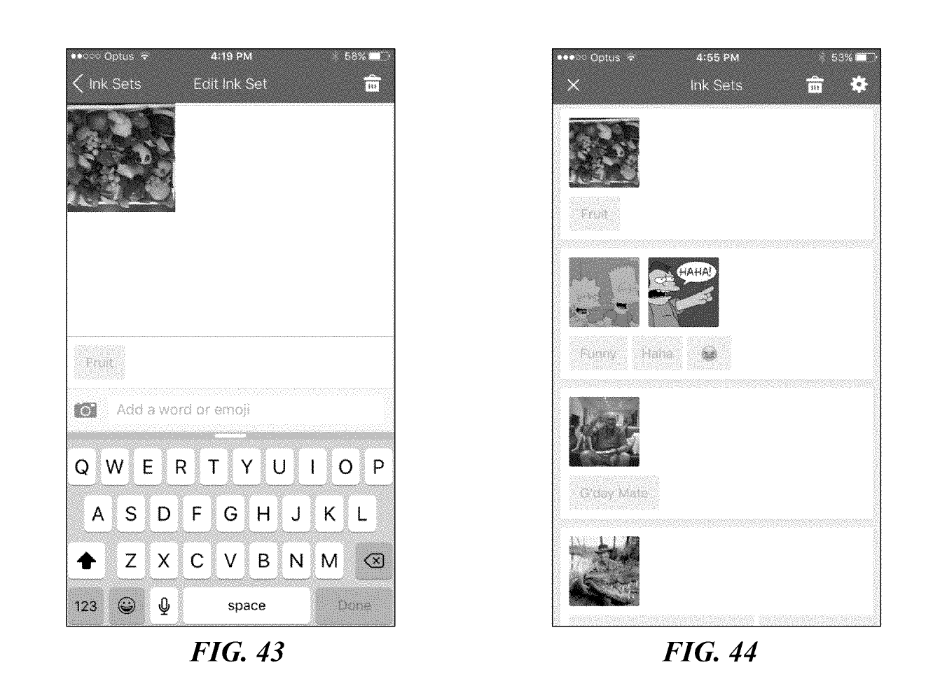

FIG. 39 shows an alternate method of creating an ink set (a collection of linked images) is via the user's personal ink library. The user taps “create new ink set” and is offered options to add an image (FIG. 40). After the user selects an image (in this example, an image of various fruits), the user is prompted to add a content item to create a link between the image and the content item. For example, FIG. 41 illustrates an “add a word or emoji,” typing box. After the user enters the word “Fruit” (as illustrated in FIG. 42) and taps “done,” a link is created between the content item “fruit” and the image. The linked image and associated content item are shown linked, as illustrated in FIG. 43. The new linked image is now included in the user's personal ink set library (FIG. 44), and is available for use in composition of messages. The procedure described in FIGS. 39-44 is also applicable when a user chooses to create a new ink set directly from the ink set library using the “photo library” or “image search” options.

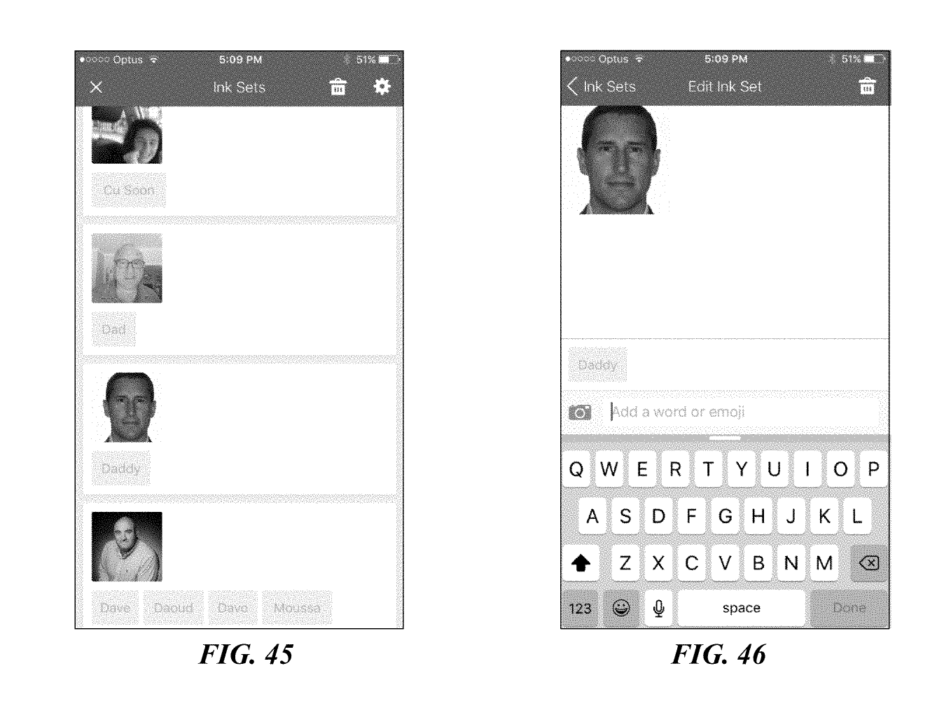

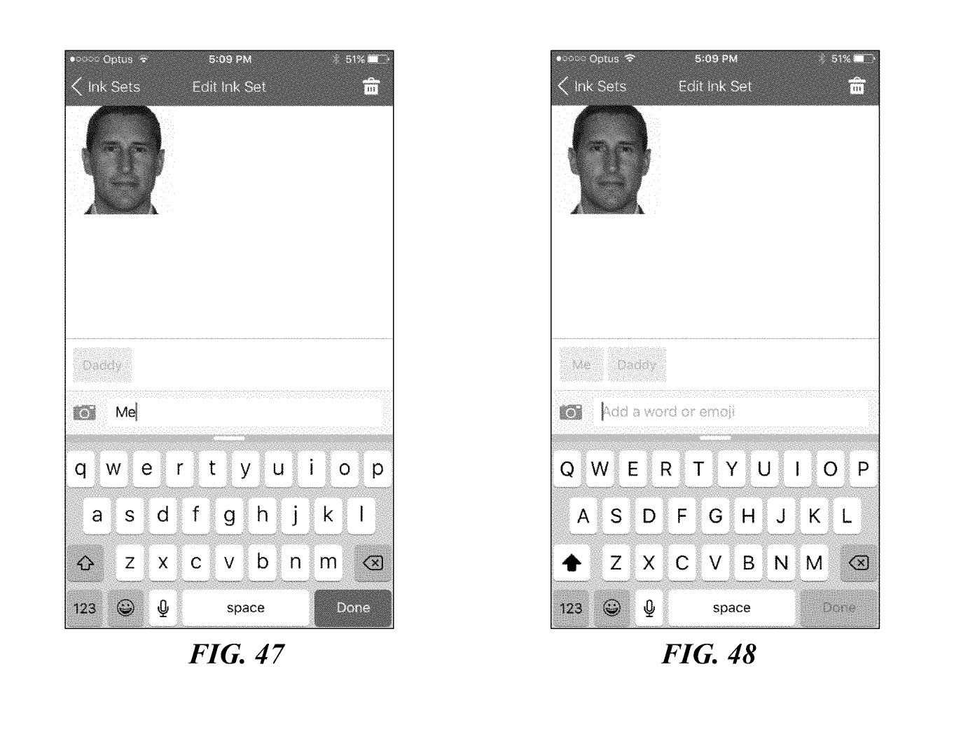

In some embodiments, ink sets can be edited within a personal ink set library. To edit an ink set, a user opens the personal ink set library (FIG. 45) and taps on an ink set/linked image. FIG. 45 shows an interface with four linked images/ink sets saved in the user's library. Clicking on a linked image (e.g., “Daddy”) of FIG. 45 causes the disclosed mobile application to display an “Edit Ink Set” screen. In this screen, a user can add/delete images and/or content items to the ink set “Daddy”. FIGS. 47-48 illustrate an example scenario of a user inputting and linking additional text. Thus, an existing linked image “Daddy” can be additionally linked to the content item “Me” when the user enters the content item “Me,” as illustrated in FIG. 47. The linked image, the content item “Daddy,” and the content item “Me” are defined as a set. According to disclosed embodiments, editing an existing linked image by including additional content items does not necessarily involve adding extra images to the set.

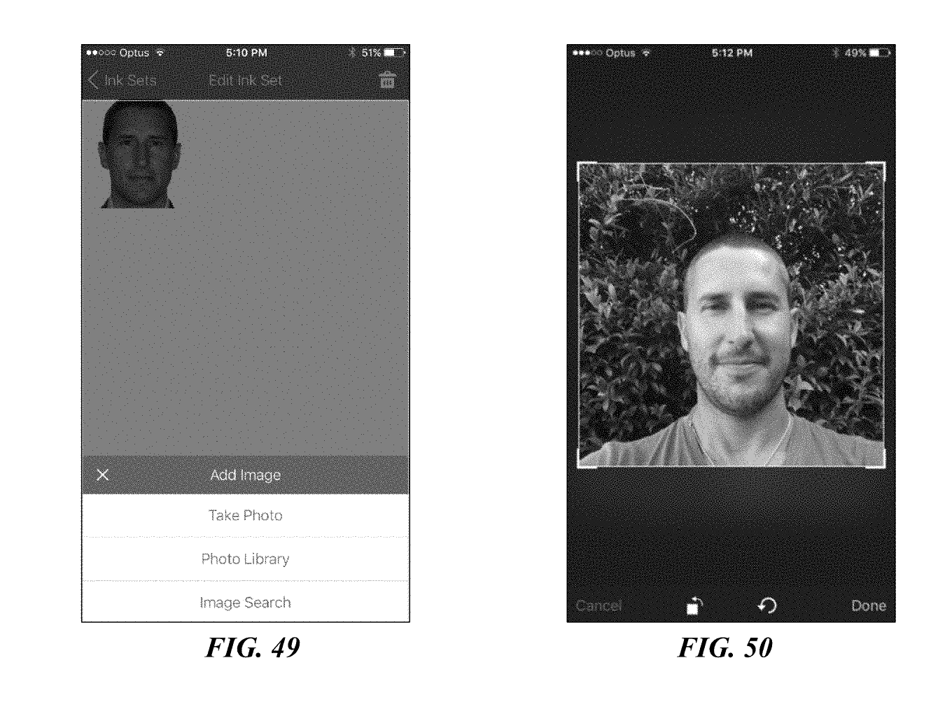

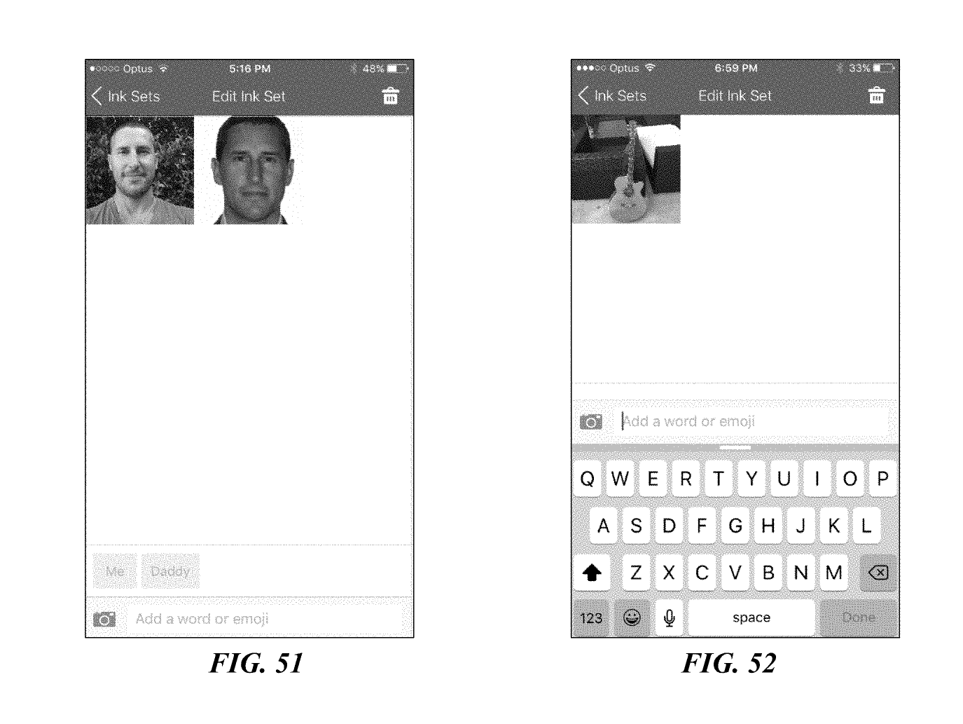

In some embodiments, a user can edit an existing ink set to include additional images. FIGS. 49-51 illustrate an example scenario of a user selecting the “take photo” option to add an image (in this example, a photo of the same man as seen in FIG. 46 smiling), and adding it to the existing ink set. Thus, the ink set includes two images and two content items, “Me” and “Daddy.”

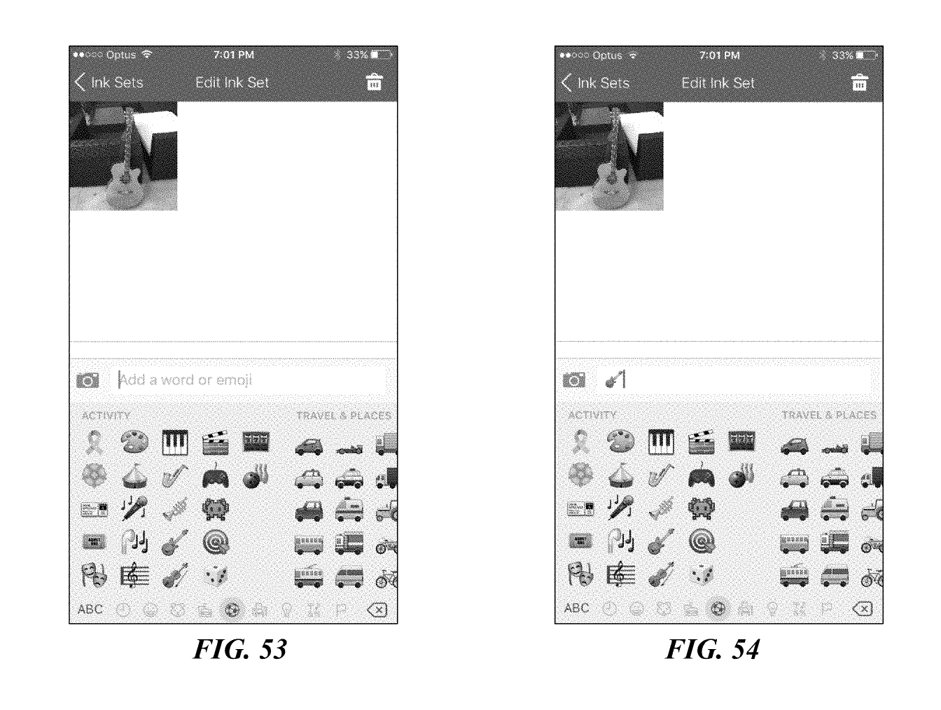

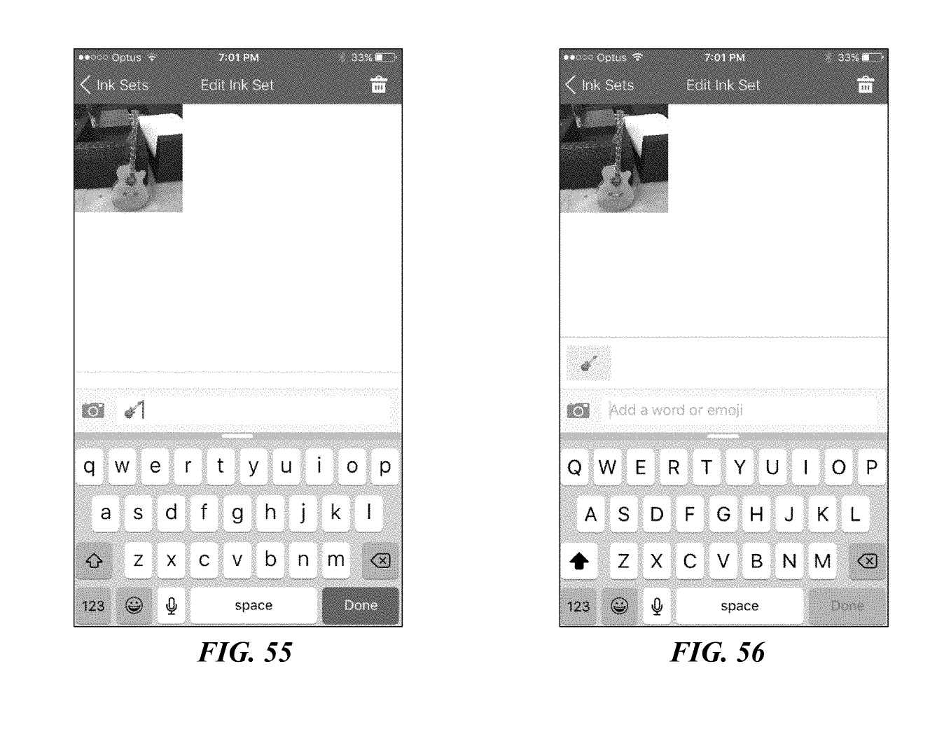

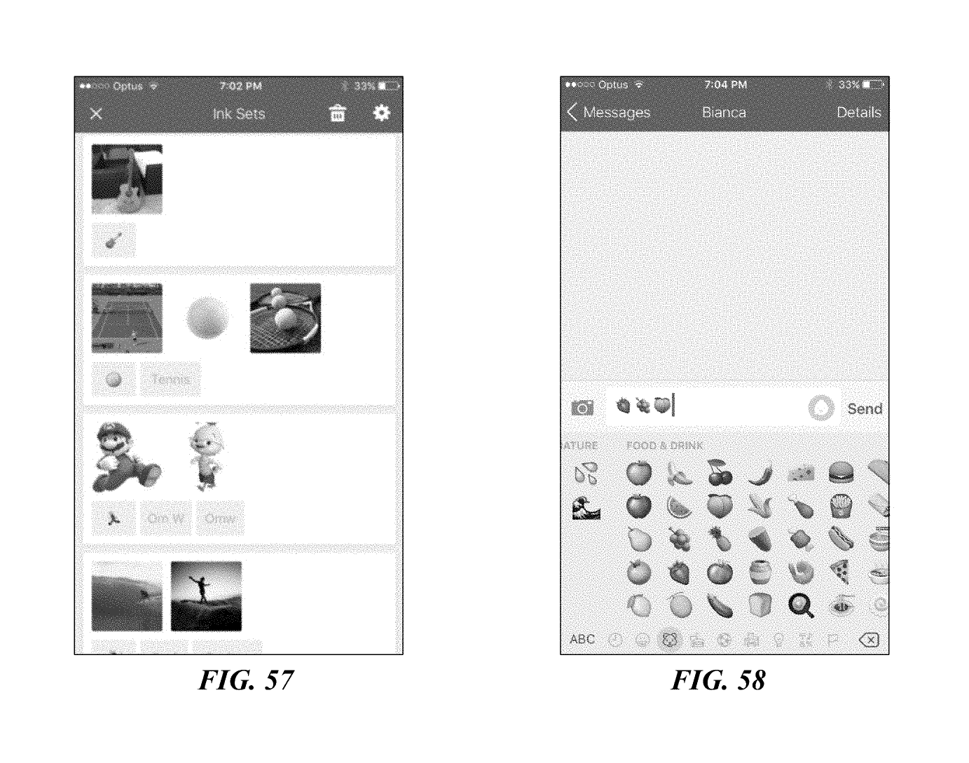

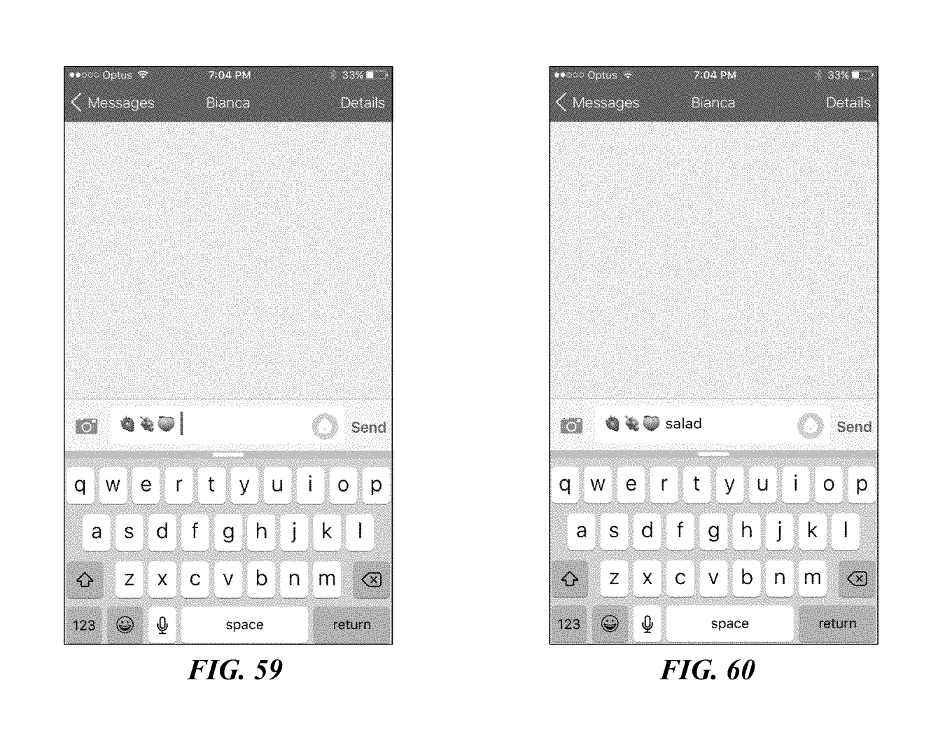

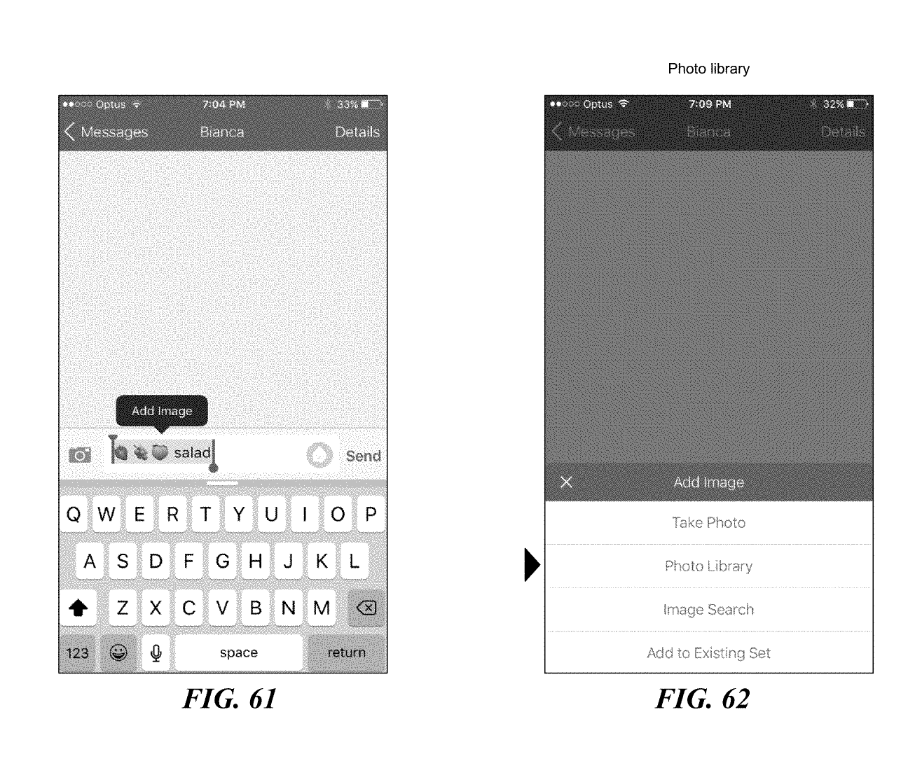

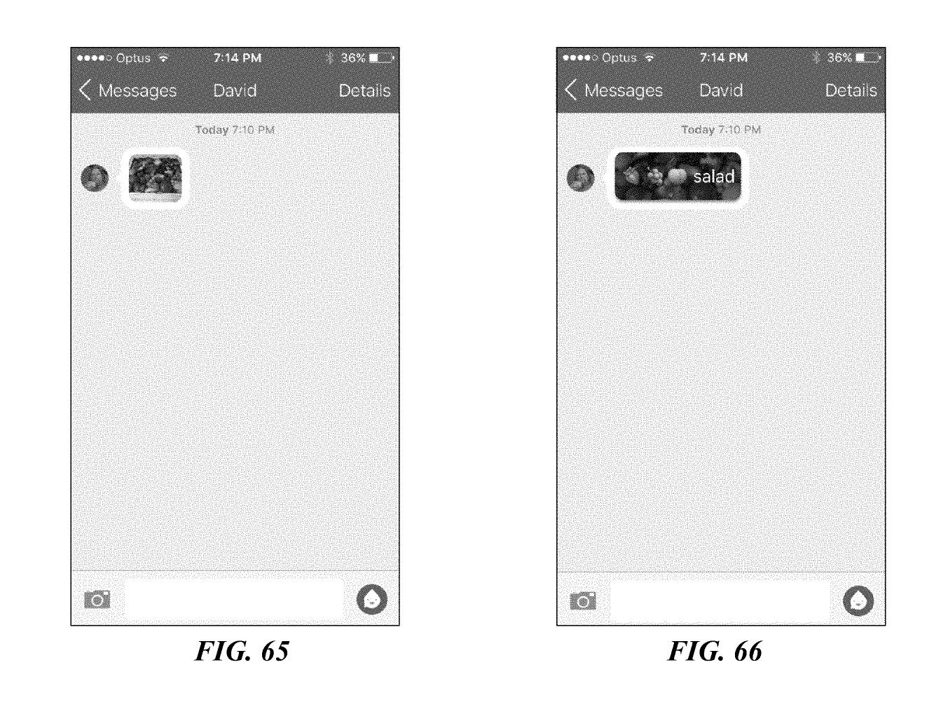

FIGS. 52-68 illustrate example scenarios in which emojis are used as content items in the creation of an ink set. FIG. 52 is an image of a guitar included within a user's personal ink set library. When the user clicks on the “Add a word or emoji” box, the user is given the option to select an emoji from the emojis displayed on the emoji keyboard as illustrated in FIG. 53. After the user selects an emoji representing a “guitar” (FIG. 54), a link is created between the emoji (content item) and the image of the guitar. After the user taps “done,” shown on the interfaces illustrated in FIGS. 55-56, the newly created ink set is now included within the user's personal ink set library and is available for use in the composition of messages, as illustrated in FIG. 57.

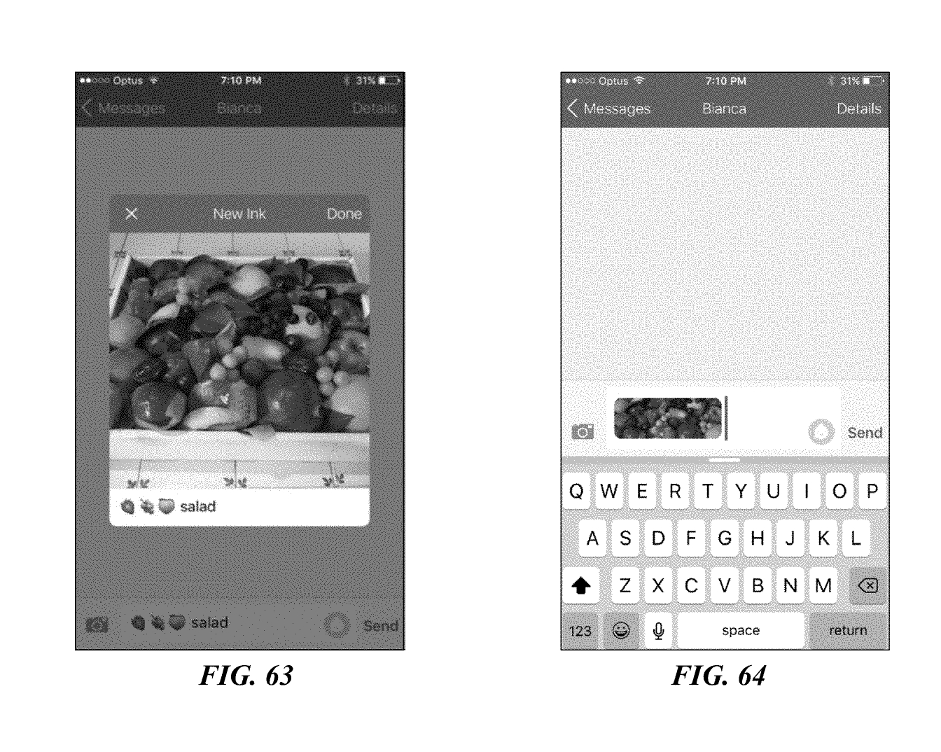

FIGS. 58-64 illustrate an example scenario in which an ink set is created “on the fly” using a combination of emoji and alphanumeric keys as inputs for text. In this example, the user enters emojis for a “strawberry, grapes and a peach,” along with the word “salad.” FIGS. 63-64 illustrate an example of the user choosing an image from their photo library (in this example, a box of fruit) to link with the highlighted text appearing automatically within the text field of the pop-up (FIG. 63). Once linked, the user is automatically taken back to the compose message field of the typing interface with the highlighted text converted to the linked image, as illustrated in FIG. 64. Swiping over the message overlays the image with the linked text as illustrated in FIG. 66.

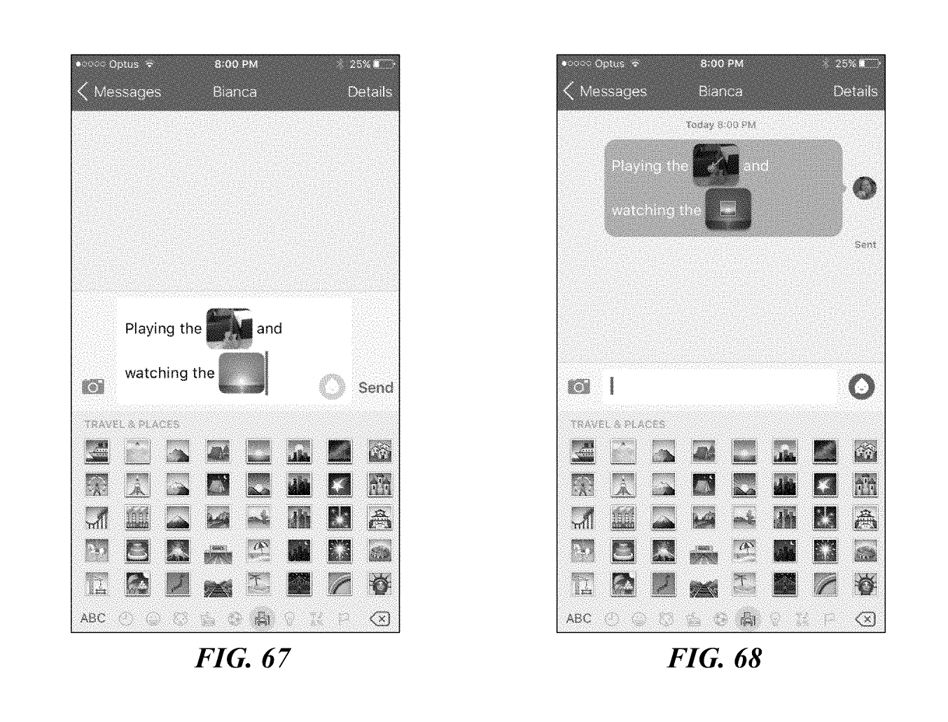

FIGS. 67-68 illustrate the use of multiple ink sets including images linked to emojis, in the body of a single message. In this example, the user inputs the text: “Playing the guitar (represented by an emoji of a guitar) and watching the sunset (represented by an emoji of the sun setting).” The procedure described in FIGS. 52-68 is also applicable when a user chooses to create a new ink set using emojis, using the “take photo” option or “image search” option displayed in FIG. 62.

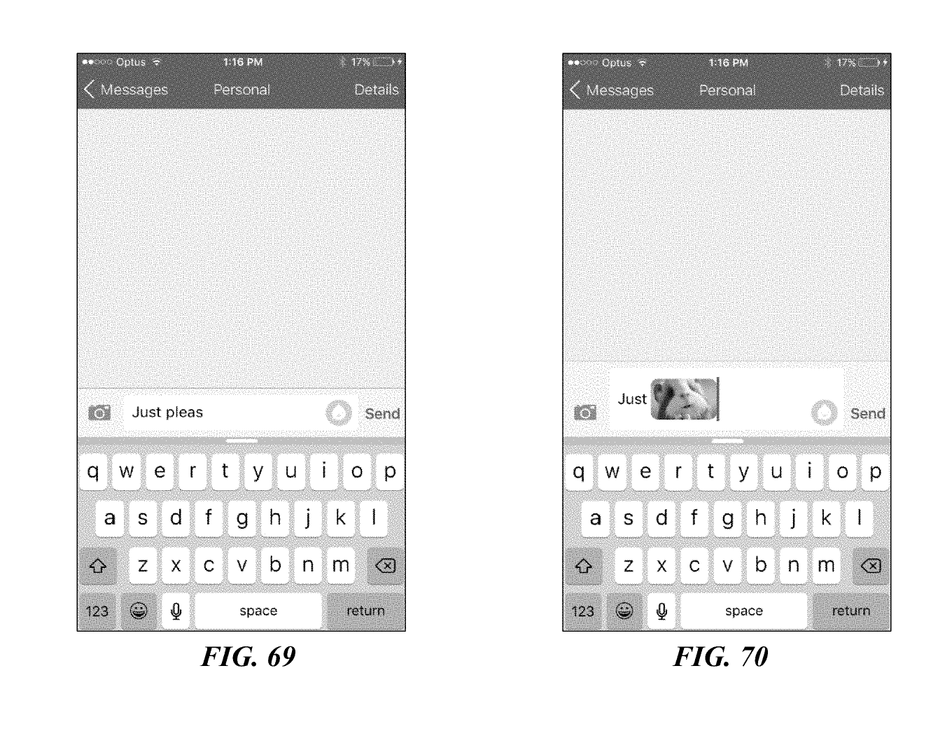

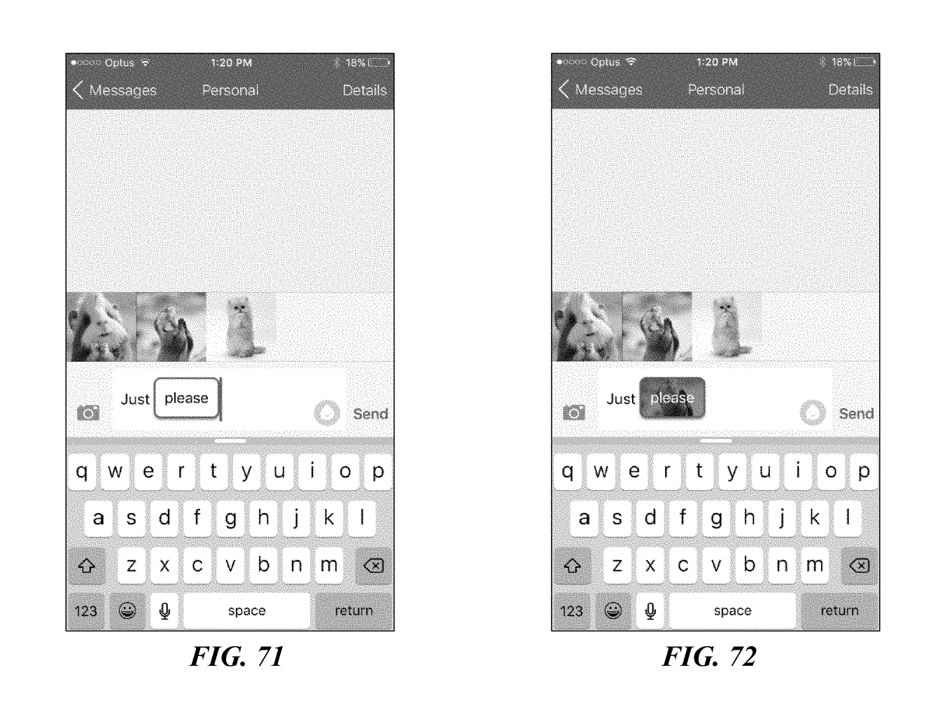

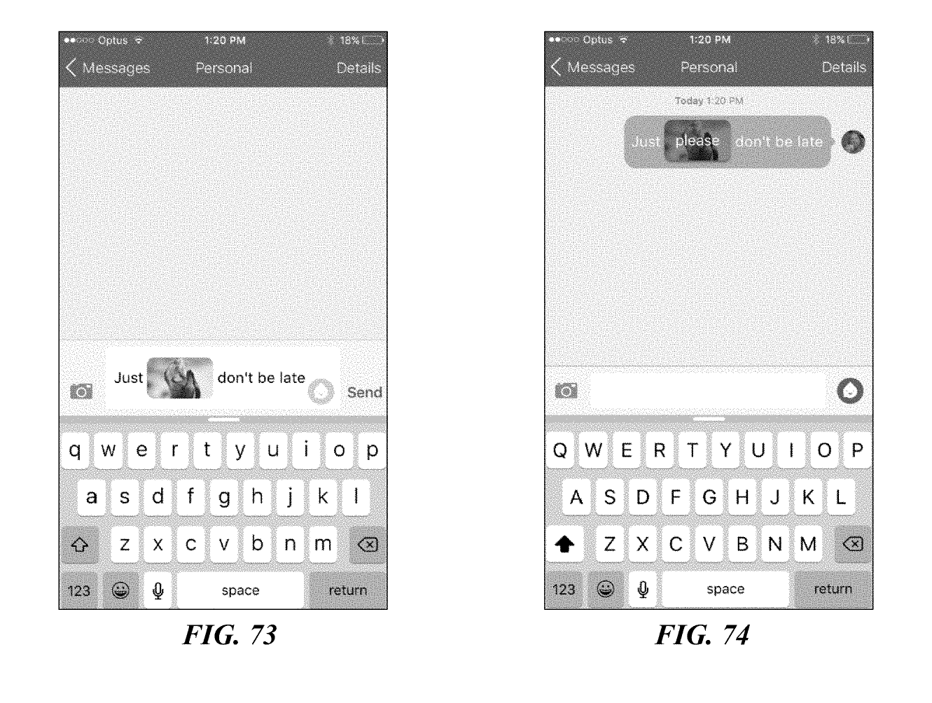

In some embodiments, an ink set can include multiple linked images associated or linked with a content item. FIGS. 69-75 illustrate an example scenario in which the variations (e.g., multiple linked images corresponding to a content item) included within an ink set are revealed during the composition of a message via a messaging application. FIG. 70 illustrates an example of a default image for the text “please.” To reveal variations, the user taps on the default image (FIG. 70). Tapping on the default image results in the variations included within the ink set, along with the default image, appearing above the compose message field (FIG. 71). In some embodiments, the content item is displayed on the typing interface as being included inside a region defined by a border (FIG. 71). A user is then able to view and change between images included within the ink set. To select a different image, the user taps on it. In some embodiments, tapping on the default image can also result in the default image being converted to the linked content item which was entered during the composition of the message (FIG. 72). As illustrated in FIG. 73, the image selected then forms part of the message included within the message field (in the example, the image is changed from a guinea pig depicted in FIG. 70 to a sea otter depicted in FIG. 73). The user can then continue composing the message, as illustrated in FIG. 73. The message is then ready to be sent with the alternate image (e.g., the sea otter) selected. FIG. 74 illustrates that the message is sent by the messaging application.

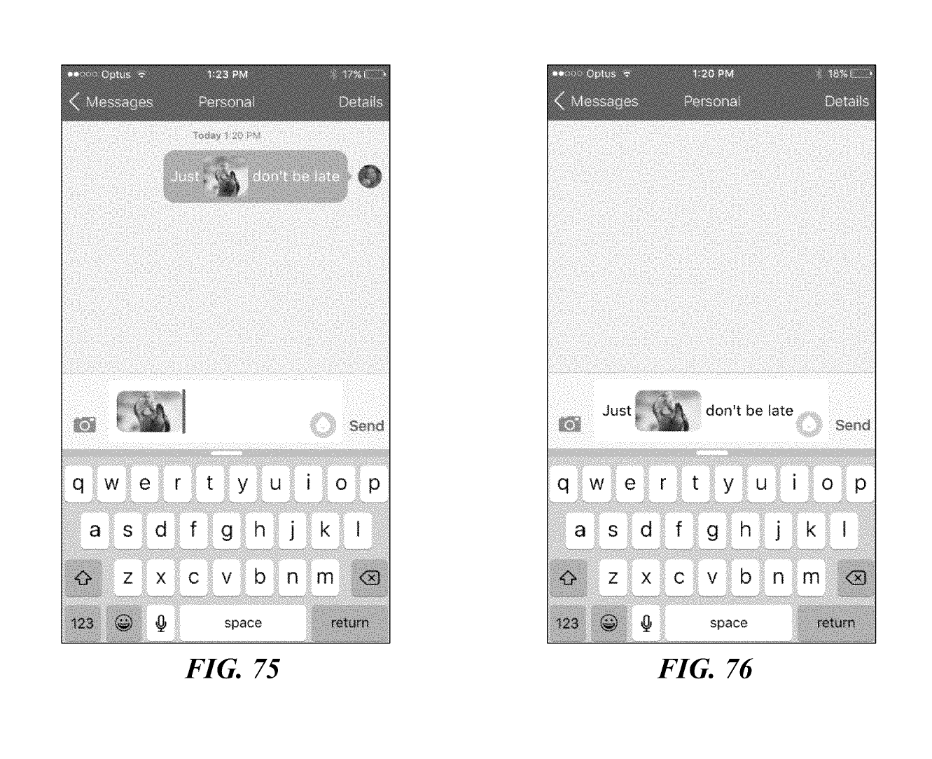

In order to accommodate for the various personas or avatars a user might have when communicating with different people, the disclosed mobile application allows for different default images to appear depending on who the recipient of the text message is. Accordingly, the disclosed mobile application is automatically aware of the linked image that was last used for a content item in a message composed for a specific contact or group. When a user inputs the name of a contact to whom a message is to be sent, the system “recalls” the most recently used images for each content item used in communicating with that contact. The last linked image is offered as the default linked image for that content item when the user enters the same content item again in subsequent text messages to the same contact. FIG. 75 illustrates an example scenario in which the default linked image (e.g., the guinea pig) for the ink set shown in FIG. 72 has now changed to the linked image (e.g., the sea otter) selected and sent in FIG. 74.

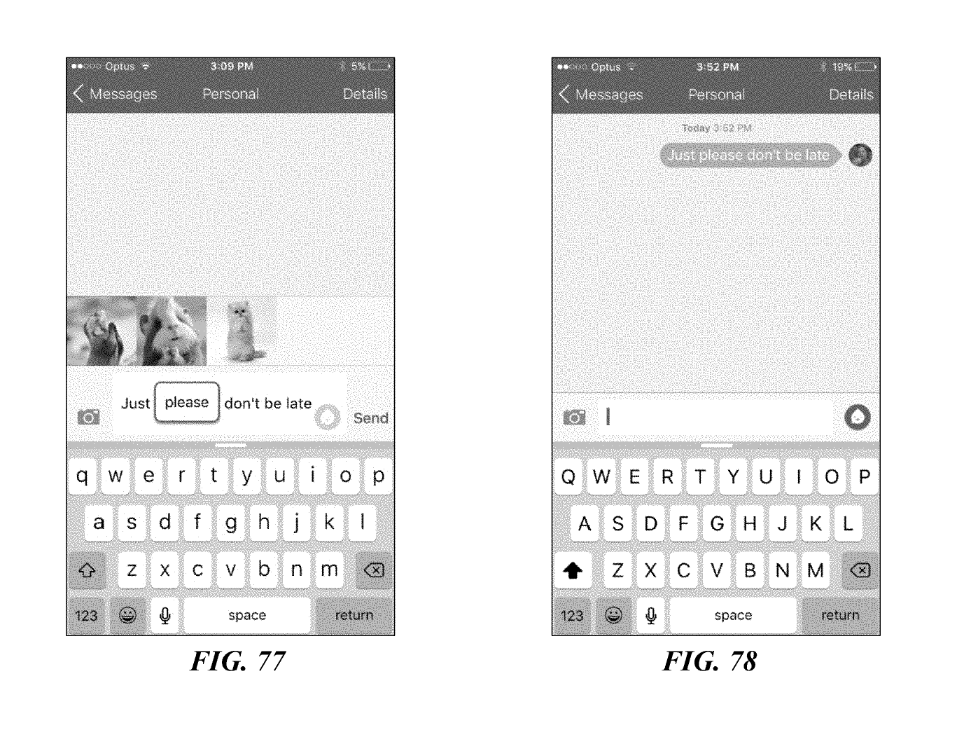

FIGS. 76-86 illustrate example scenarios in which a user can send a text message without including a linked image, and wherein the content item is included in place of the linked image. FIG. 76 illustrates an example scenario in which the mobile application converts a linked image to a content item during the composition of a message. When a user taps on a linked image, the linked image is replaced by the content item (e.g., the content item is shown as included in a region within a border as illustrated in FIG. 77). The text message can then be sent with the content item and not include the linked image. As illustrated in FIG. 78, the recipient of the message now receives the message with the word “please,” formatted in text, instead of an image.

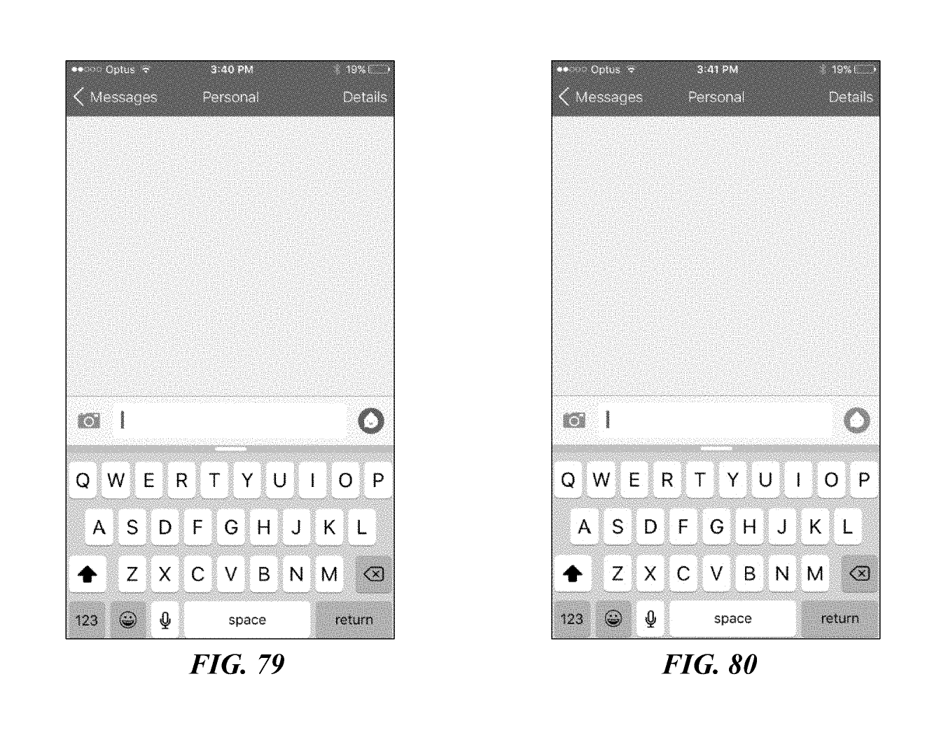

An alternate method, known as the “default text” option is illustrated in FIGS. 79-86. This method enables a user to compose an entire message comprised of content items only, regardless of whether any of the content items have been linked to images. As explained below, the “default text” option prevents the linked image from being included in a message. FIG. 79 illustrates a starting point to compose a message. In FIG. 79, the button shown to the right of the compose message field is modified by the disclosed mobile application to correspond to user interface features of the disclosed mobile application. By tapping on the button, a user is able to disable the automatic conversion of content items to linked images functionality. As illustrated in FIG. 80, tapping on the button repeatedly toggles this feature, turning the “default text” option off and on.

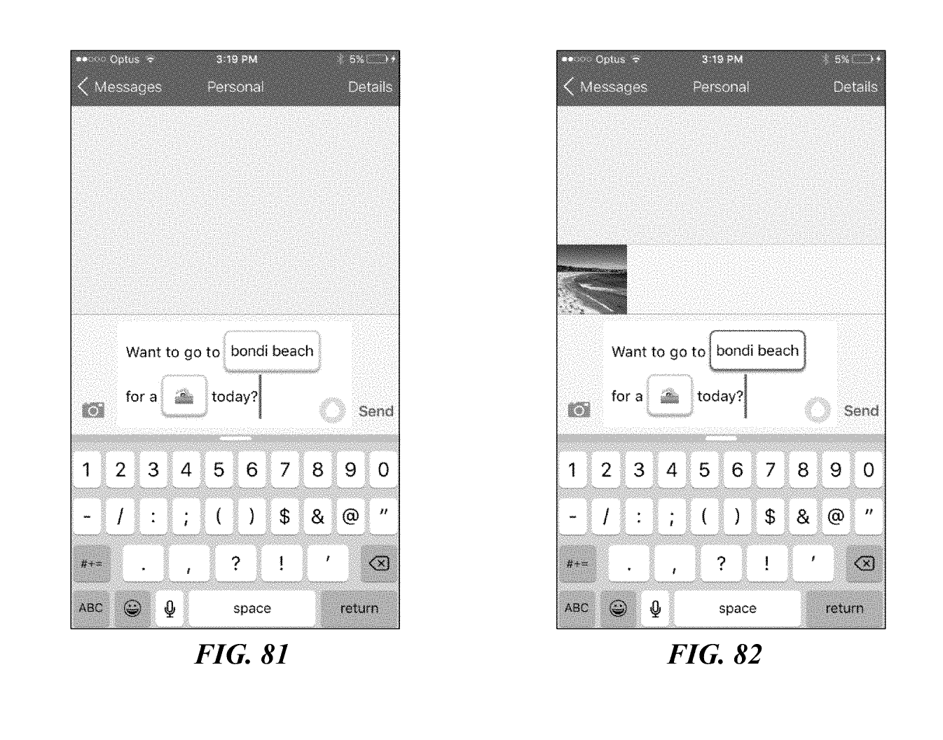

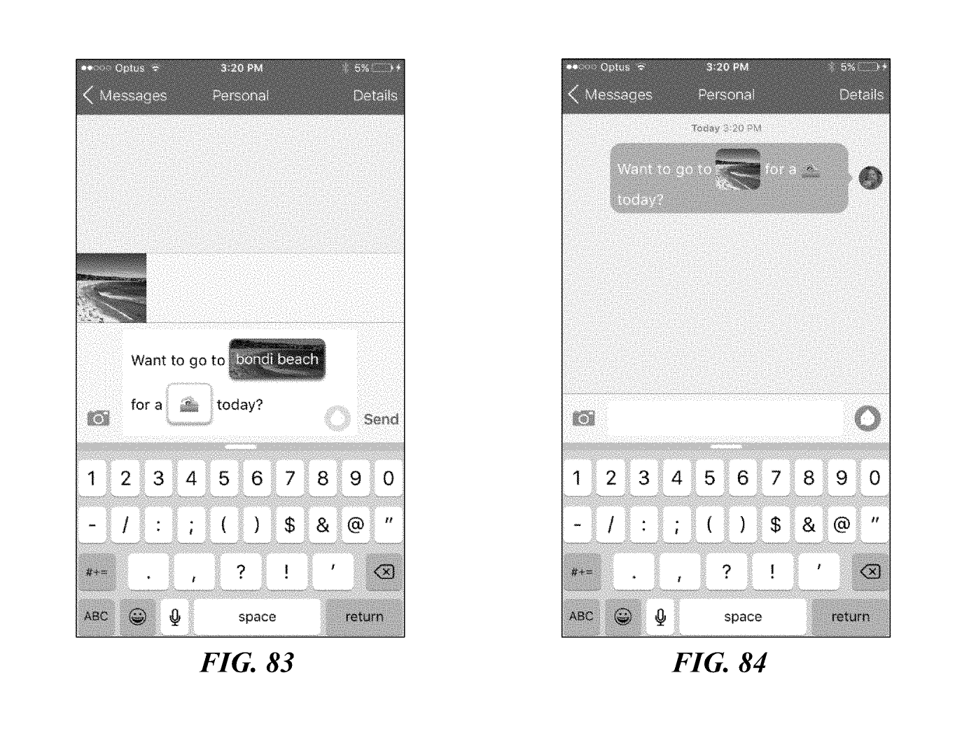

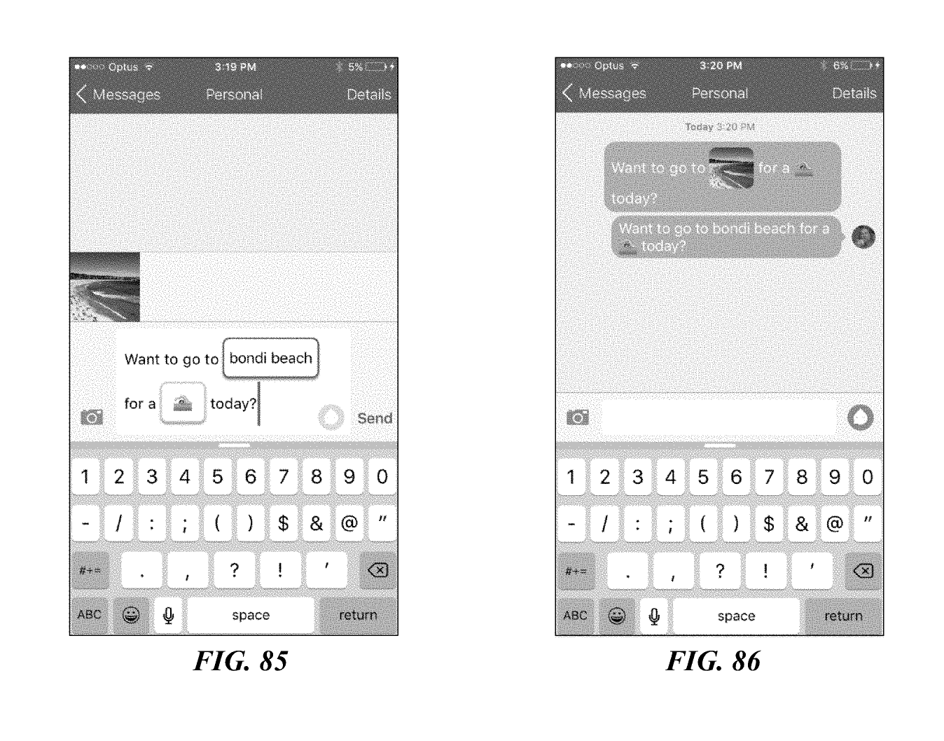

When a user composes a message with the conversion functionality disabled, content items corresponding to linked images is differentiated from unlinked content items using a border. In the examples shown, content items corresponding to linked images are displayed in a region included within a border, while unlinked content items are displayed in a regular manner. In the example shown in FIG. 81, the user inputs the message: “Want to go to Bondi beach for a swim (illustrated by an emoji depicting a person swimming) today?” The message is displayed in text format, with the words “Bondi beach” and the emoji for “swim” shown within borders inside a region. When a user taps on a content item included within a border, the user can view the linked images corresponding to the content item, as illustrated in FIG. 82. In this example, when the user taps on the content item “Bondi beach,” the linked image corresponding to the content item “Bondi Beach” is displayed. When the user taps on the linked image, the content item “Bondi Beach” is replaced by the linked image, ready to be sent as a text message, as illustrated in FIG. 83. FIG. 84 illustrates the message sent. The example scenario in FIGS. 85-86 illustrate an example in which the text message is composed and sent as regular text without including linked images corresponding to content items in the text message.

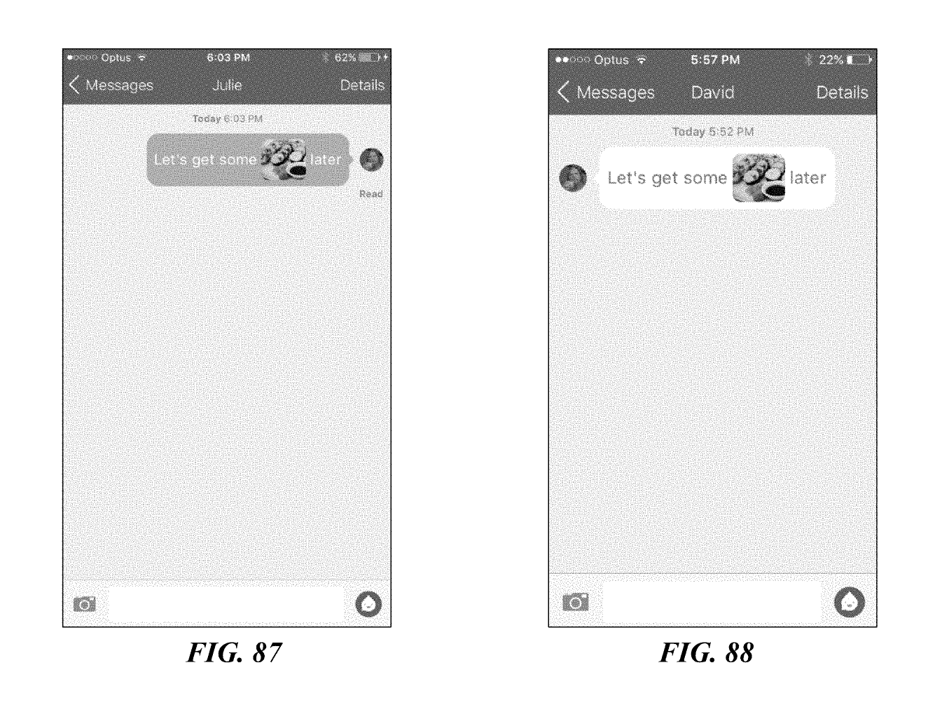

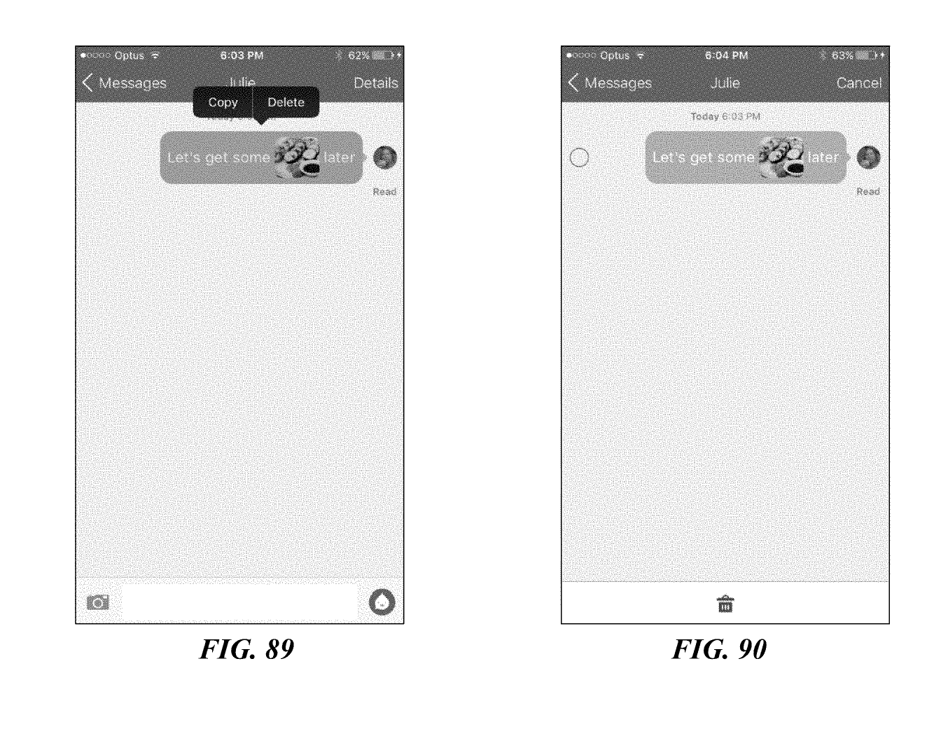

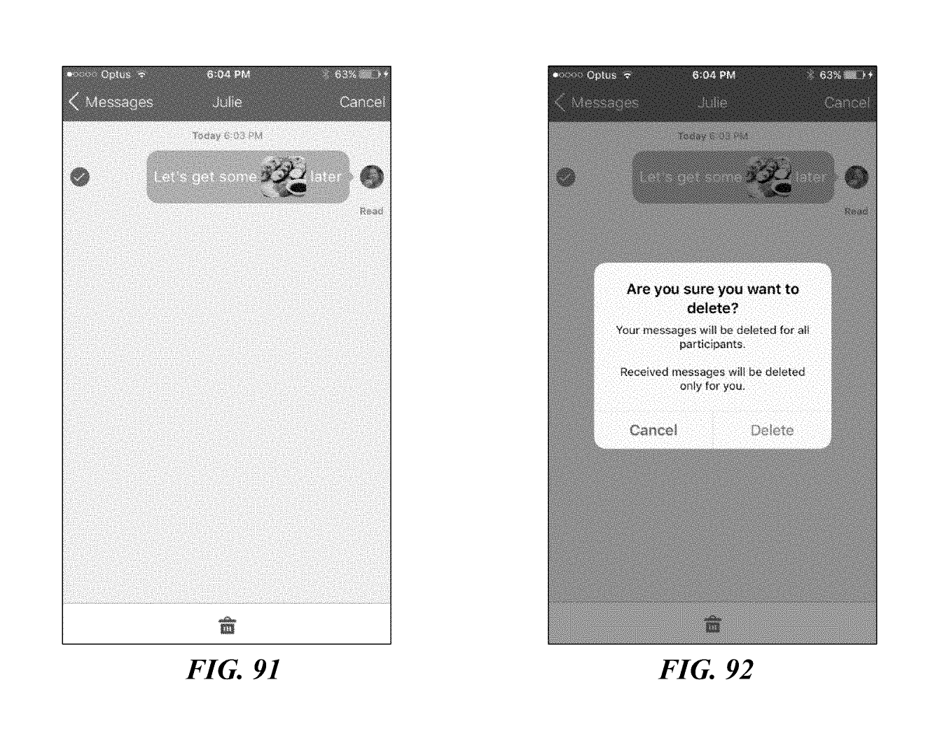

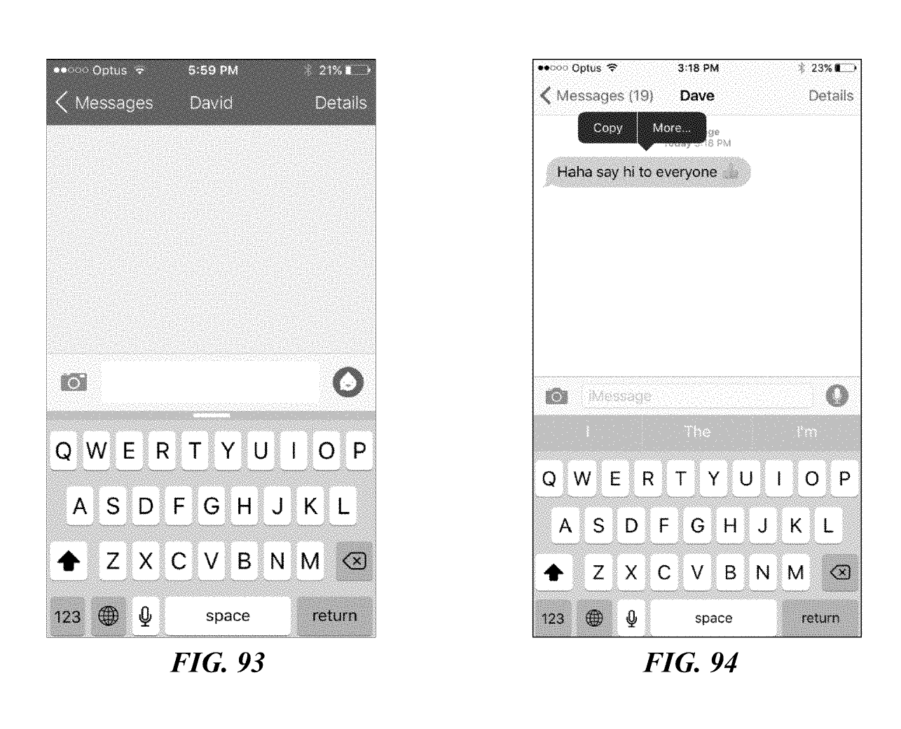

FIGS. 87-96 illustrate example scenarios in which messages are copied and deleted. FIG. 87 illustrates an example scenario of a message already sent. Holding down on a message displays a “copy/delete” tab (FIG. 89). FIG. 90 illustrates an example in which a user has chosen the delete option. The user can select single or multiple messages to delete (FIG. 91). Prior to deleting a message(s), the user is prompted to confirm the request, as illustrated in FIG. 92. The disclosed mobile application provides a delete functionality according to which if a user chooses to delete a message(s) the message is deleted not only at the mobile device of the user but is also deleted from the device(s) of the recipient(s) of the message. Thus, according to embodiments as disclosed herein, the disclosed mobile application is in electronic communication over a network with a remote server. This server can receive a request for deleting a text message from the user via the disclosed mobile application. In response to the request for deleting the text message, the remote server can verify that the text message is received by the recipient at the recipient's mobile device. In some embodiments, the remote server can delete the text message sent by the user at the recipient's mobile device. In some embodiments, the disclosed mobile application can delete a text message (sent by the user) from the user's mobile device. FIG. 88 illustrates an example screen of a message as received on a recipient's device. FIG. 93 illustrates the same screen on the recipient's device, after the message was deleted by the sender.

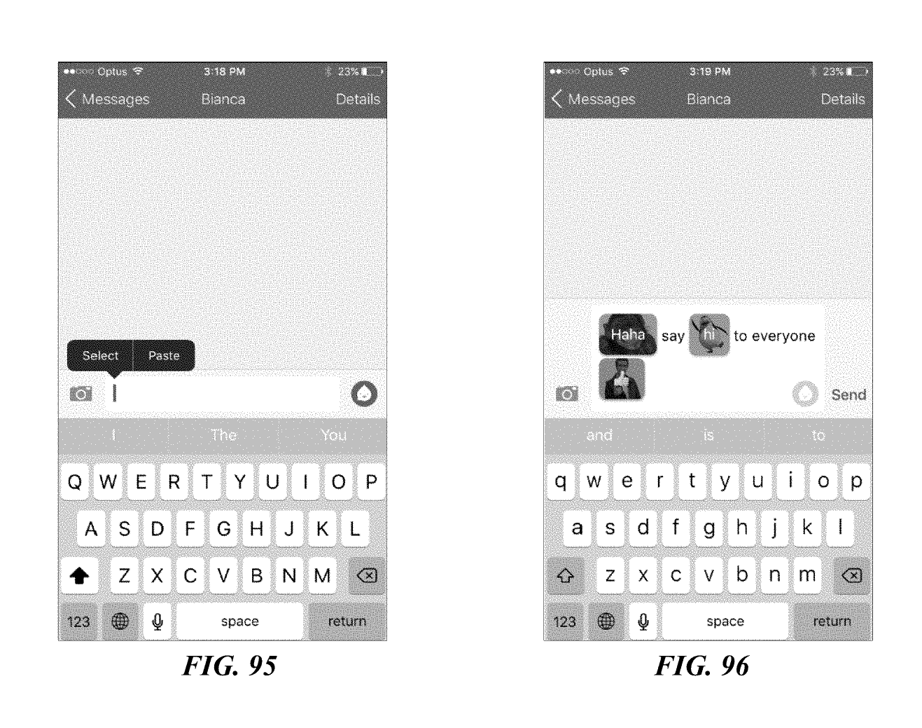

FIGS. 94-96 illustrate an example scenario in which text composed or received on alternate apps/platforms, etc., can be copied and pasted into the system on a user's device. FIG. 94 illustrates an example in which a user copies the content of a message received (e.g., via SMS) on his or her device. In the example, the user copies the message (received from “Dave”) and pastes the message into a new message (composed for “Bianca”), as illustrated in FIGS. 95-96. The content items “Haha,” “hi,” and an emoji in the message received from Dave was in the form of text and a thumbs-up emoji. The disclosed mobile application detects that these content items are associated with linked images (e.g., stored in a designated folder accessible by the disclosed mobile application) on the user's mobile device. Upon detection of content items that correspond to linked images, the disclosed mobile application automatically converts the content items into the linked images when a user pastes an incoming text message into the composition field of an outgoing text message (e.g., for another user or a group of users).

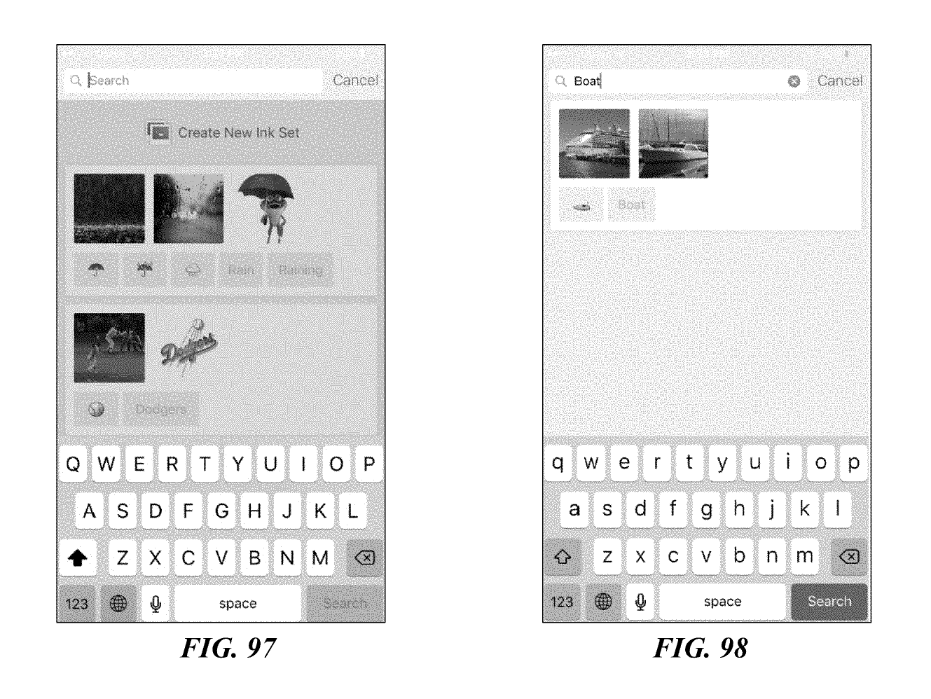

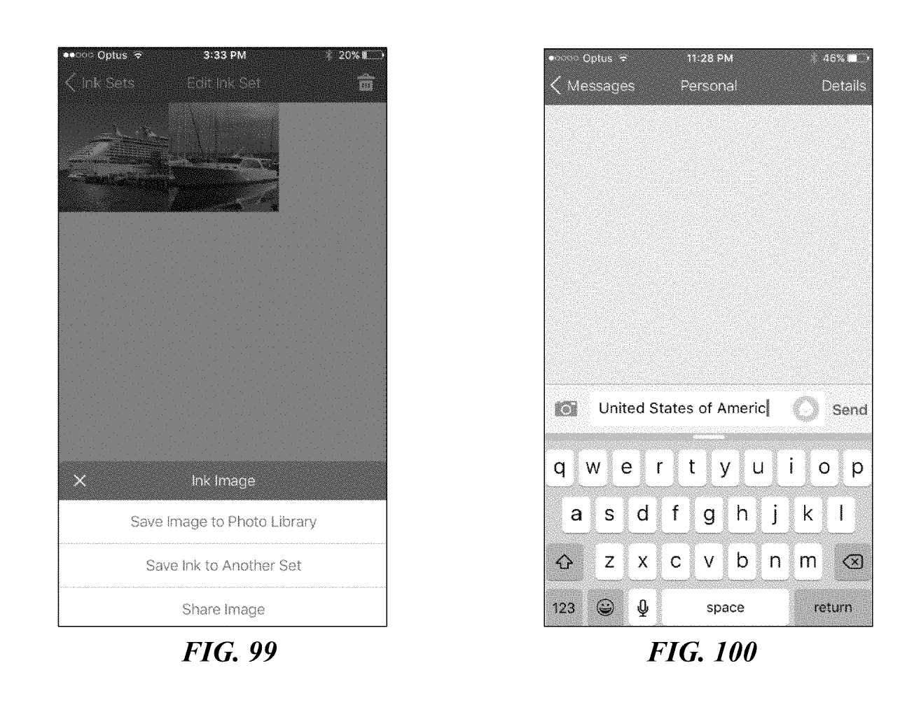

In some embodiments, the disclosed system provides for a method of indexing, storing and retrieving text messages, enabling users to organize images for fast retrieval, by linking them with content items. Linked images and the associated content items, saved in a user's personal ink set library, are made available to view in alphabetical order, or they can be searched by a search query. FIG. 97 illustrates an example scenario of a starting point for an image search within a user's personal ink set library. FIG. 98 illustrates an example scenario in which a user has entered the word “boat” into the search field. The disclosed mobile application searches the user's mobile device (e.g., a designated folder or ink set library) and displays linked images corresponding to the content item “boat.” The user is then able to either save or share the linked image(s), either as a stand-alone image, or as a linked image, illustrated in FIG. 99 as “Ink Image”.

In some embodiments, a repository of linked images can be a user's personal ink set library. In some embodiments, a repository of linked images can belong to a brand (e.g., representing icons, avatars, emblems, or logos identifying a sports team, a beverage maker, or a car manufacturer). Such a repository is a core component of the disclosed system and is available within a software development kit (SDK) for use on alternate applications, platforms and services. Such a SDK can be downloadable from an entity or organization's web portal. In some embodiments, the SDK is downloadable from a mobile application marketplace (e.g., App Store™, Chrome Store™, or Google Play™).

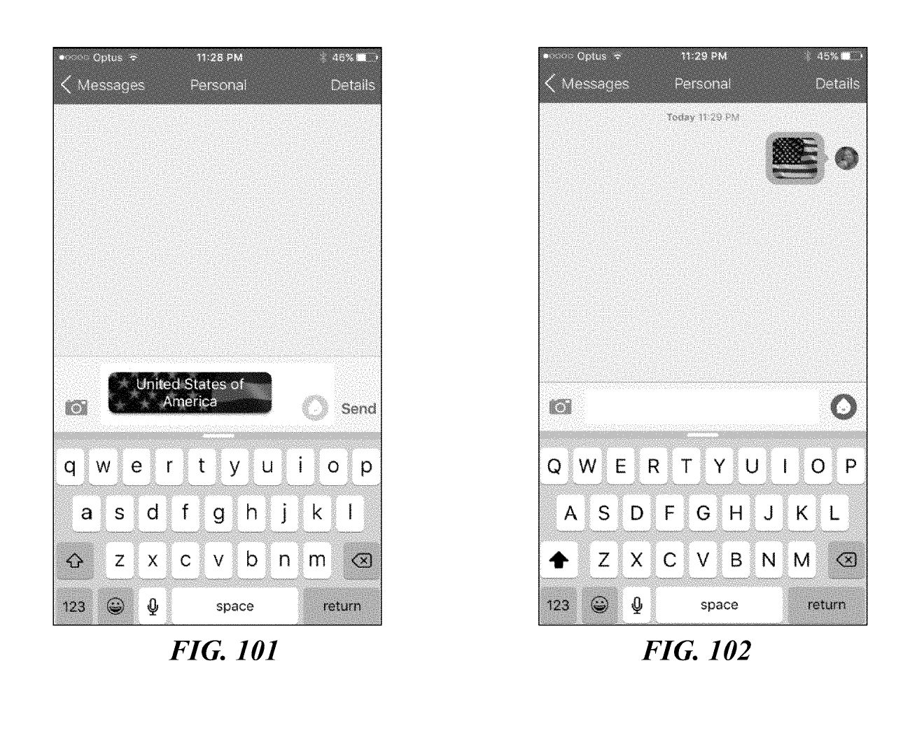

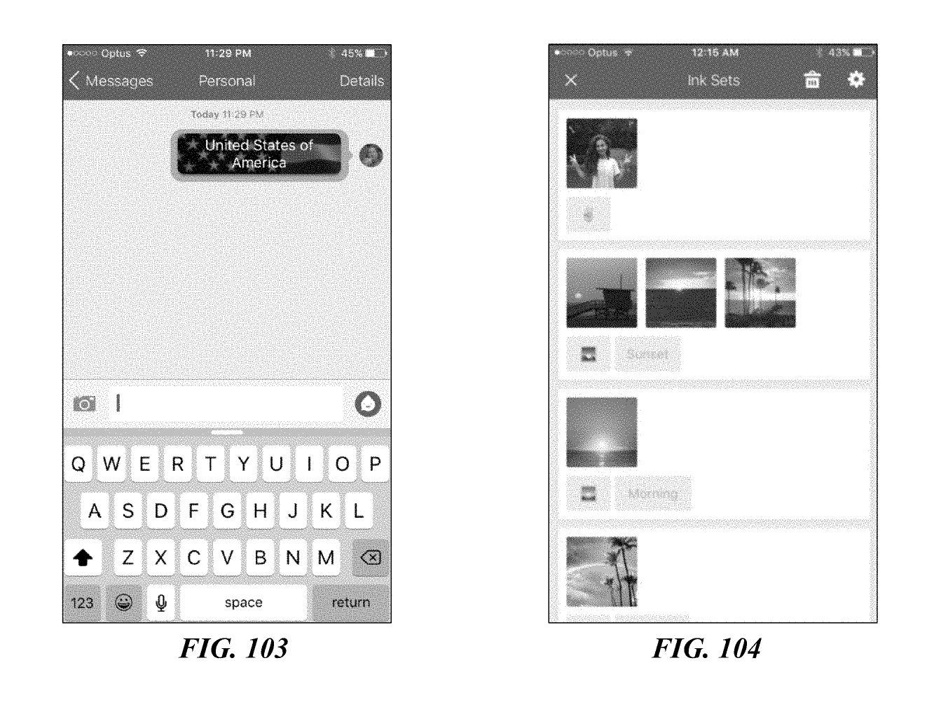

In some embodiments, linked images are sent and received in a 1:1 aspect ratio. For example, linked images can be sent or received by the disclosed mobile application on a user's mobile device. Linked images can also be sent or received by a server that is in electronic communication, and for example, manages/stores an online library of linked images. When a user inputs content items in the compose message field, linked images are shown cropped to allow for text to be displayed, as shown in the example scenario illustrated in FIGS. 100-101. In this example, the user inputs “United States of America.” The image linked image corresponding to this content item (in this example, the flag of the United States of America) is displayed cropped to allow for the full text to be displayed. FIG. 102 illustrates the message sent and received in 1:1 aspect ratio. When the sender (e.g., user), taps on/swipes right a linked image included in a text message, the linked image gets reformatted to reveal the corresponding content item. For example, tapping on the linked image (flag of the United States) included in a text message depicted in FIG. 102 causes reformatting of the linked image by the disclosed mobile application thereby revealing the content item (the words “United States of America” in FIG. 103).

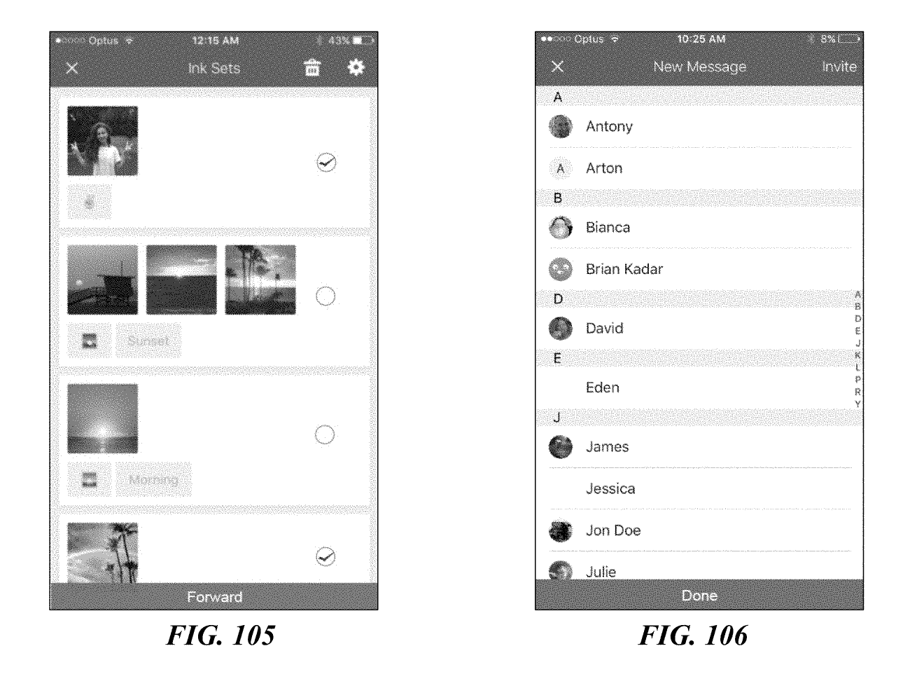

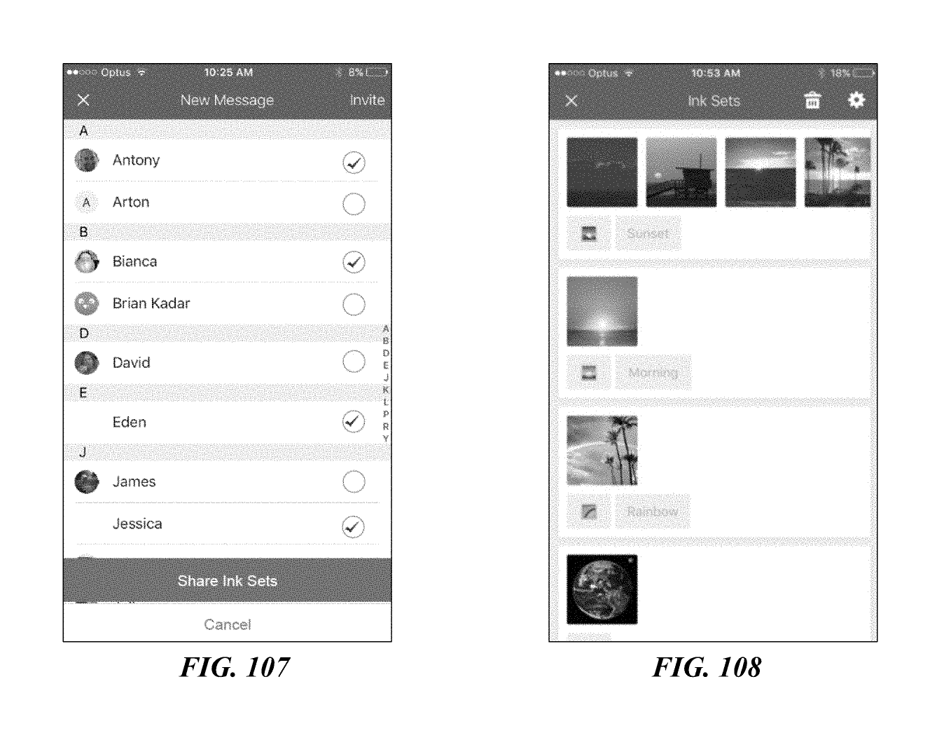

FIGS. 104-107 illustrate an example scenario in which a user selects various ink sets (linked images and their corresponding content items) from his or her personal ink set library to share with other users. After receiving an ink set, a recipient can save the ink sets to his or her own personal ink set library.

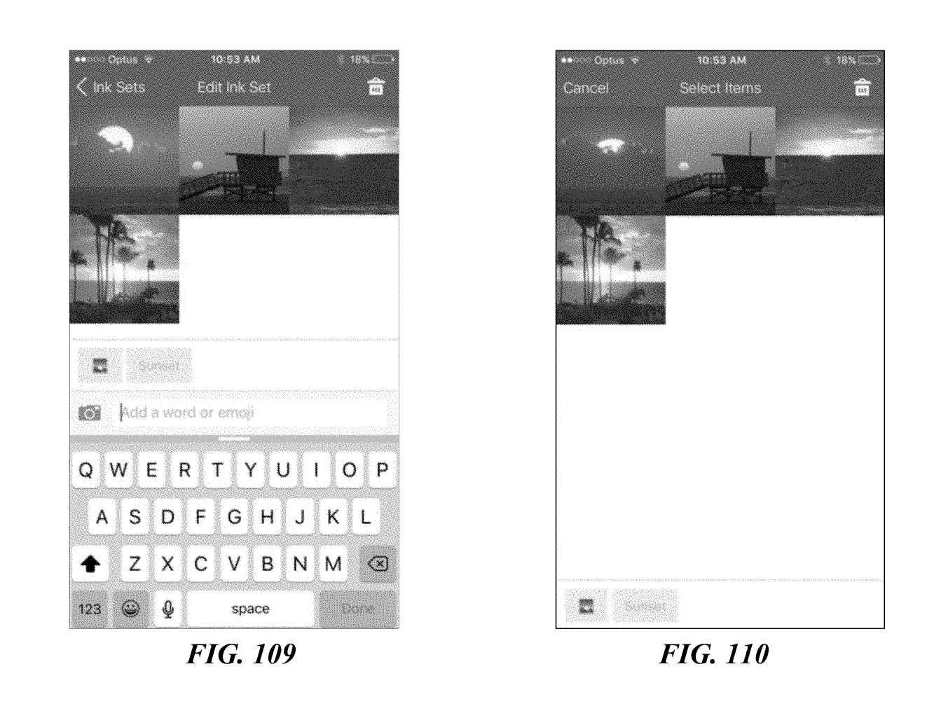

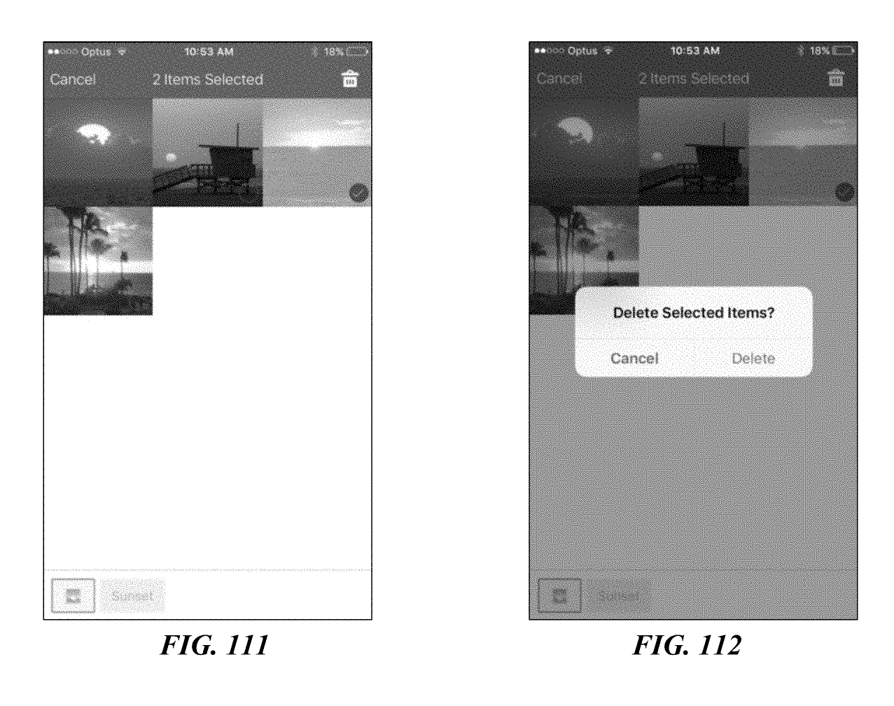

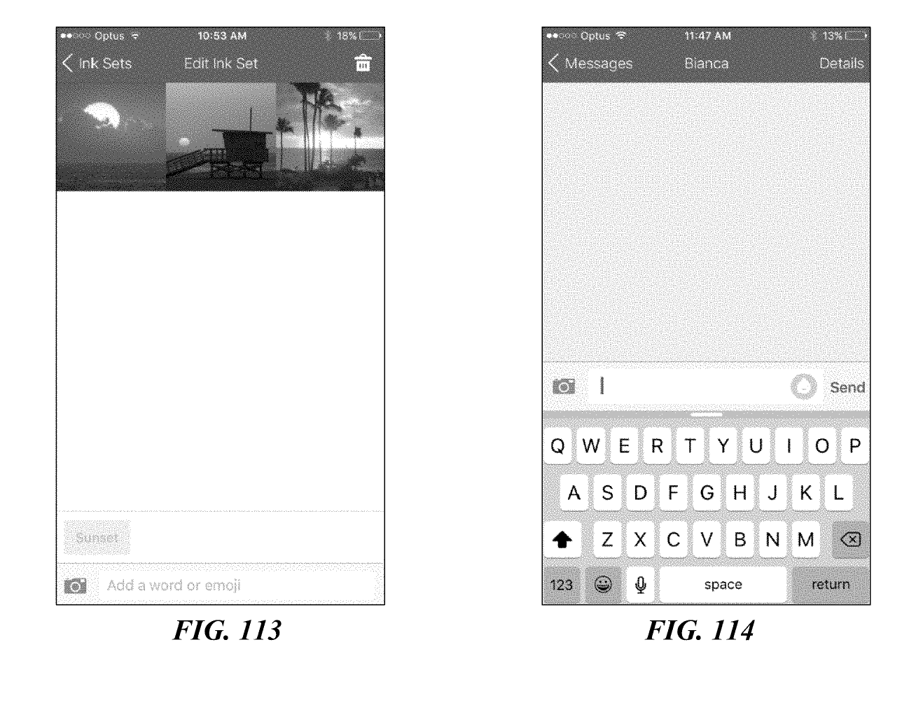

FIGS. 108-113 illustrate an example scenario in which a user can select linked images and content items included within an ink set to delete. In some embodiments, the disclosed mobile application allows a user to delete linked images and/or the corresponding content items.

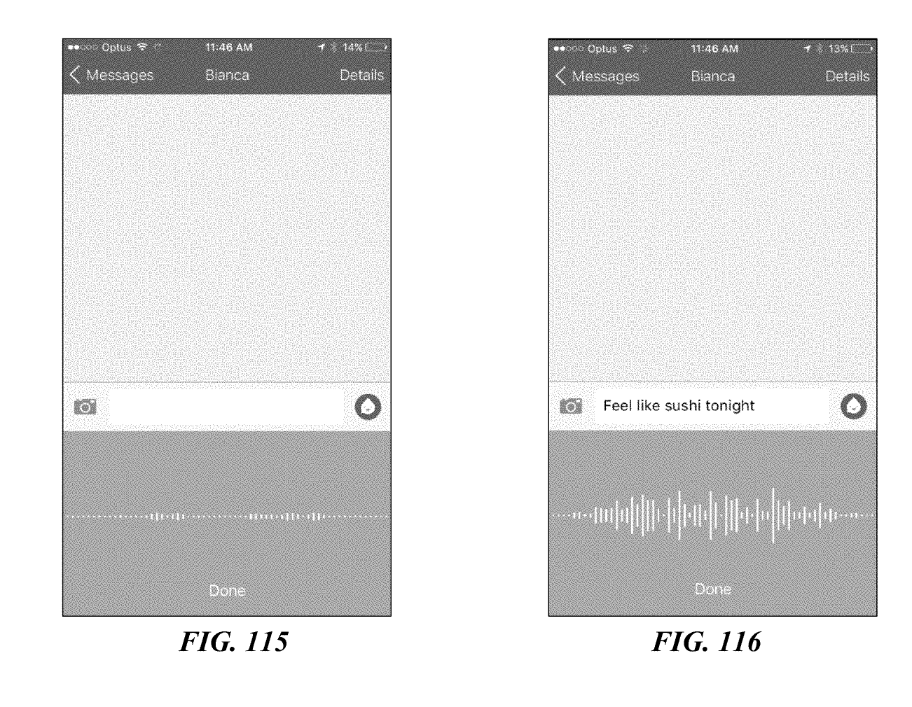

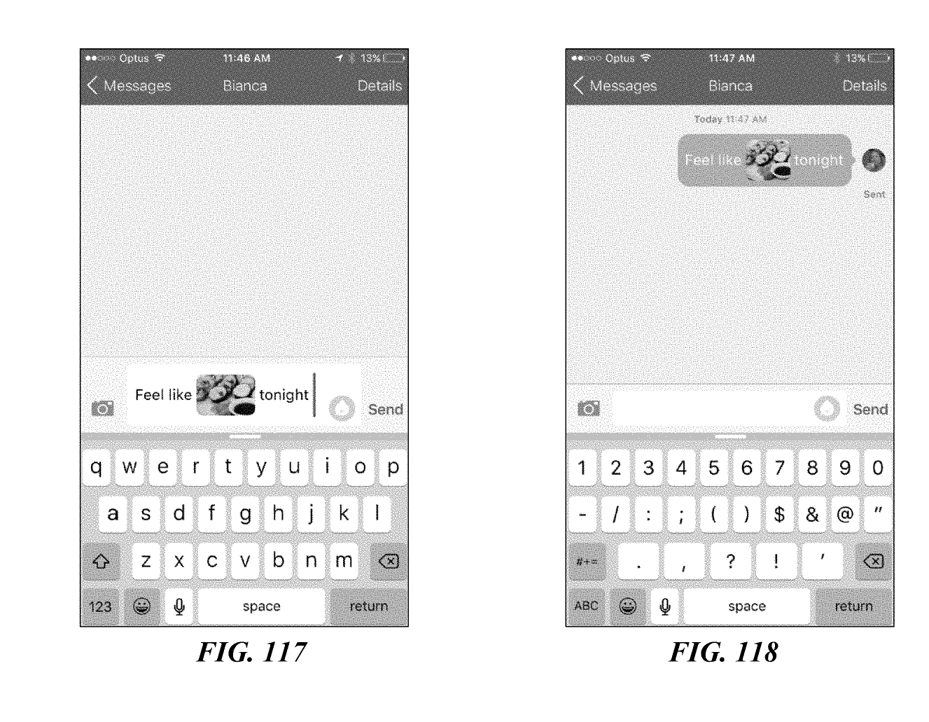

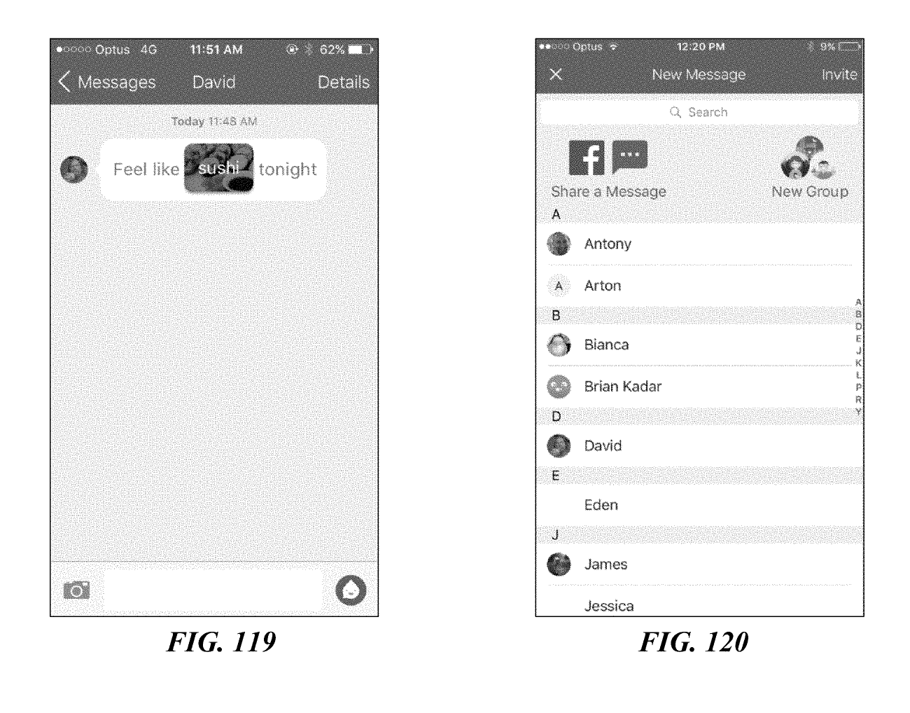

In some embodiments, the disclosed mobile application allows a user to enter a text message via “voice recognition” API, as illustrated in FIGS. 114-119. To utilize this functionality, a user talks into the device, the voice recognition API converts voice to text, and the system then converts the text to linked images. Thus, the disclosed mobile application performs transcription (of voice to text), detection of content items in the text, and conversion of the detected content items into their corresponding linked images. FIG. 116 illustrates an example scenario in which a user dictates the message “feel like sushi tonight” into their device. FIG. 117 illustrates an example of the system automatically detecting the word “sushi” in the transcribed text, and converting the word “sushi” into a linked image. FIGS. 118-119 illustrate the messages as sent and received.

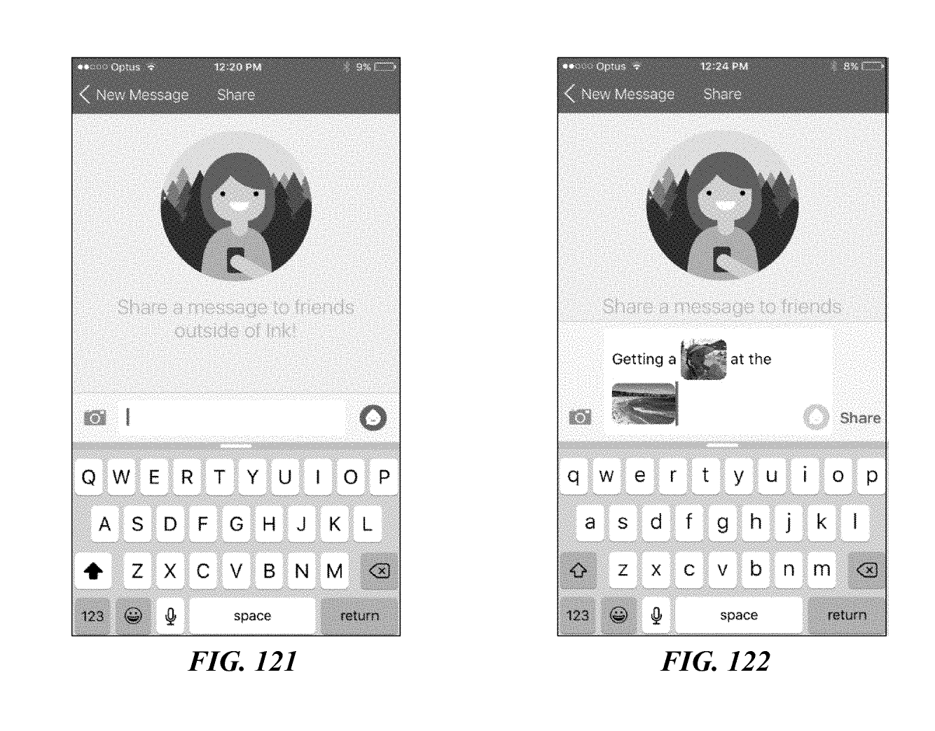

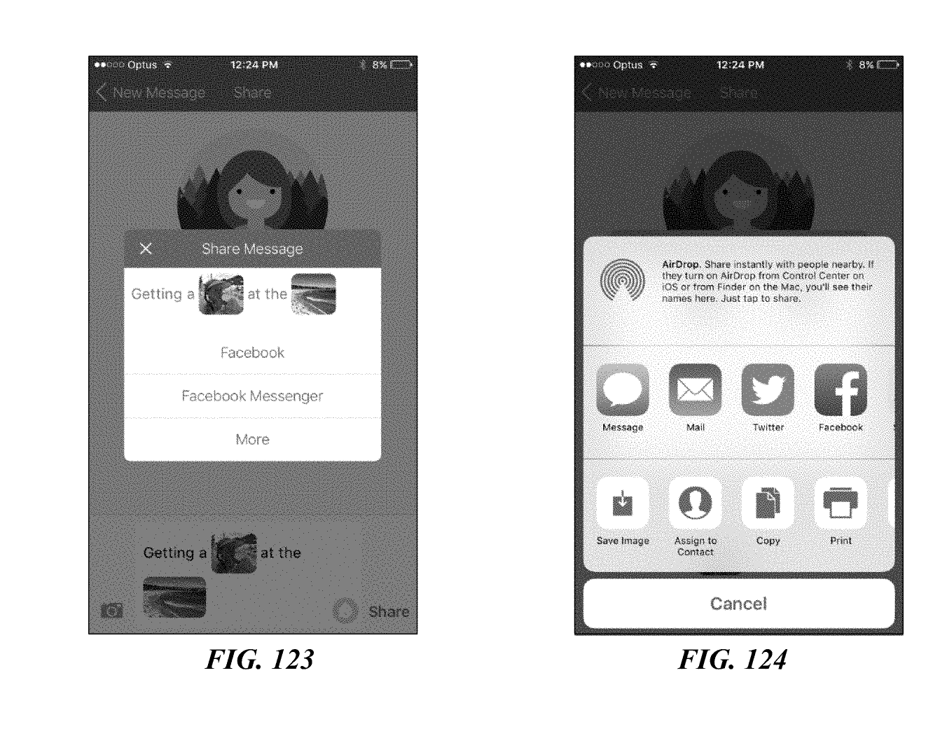

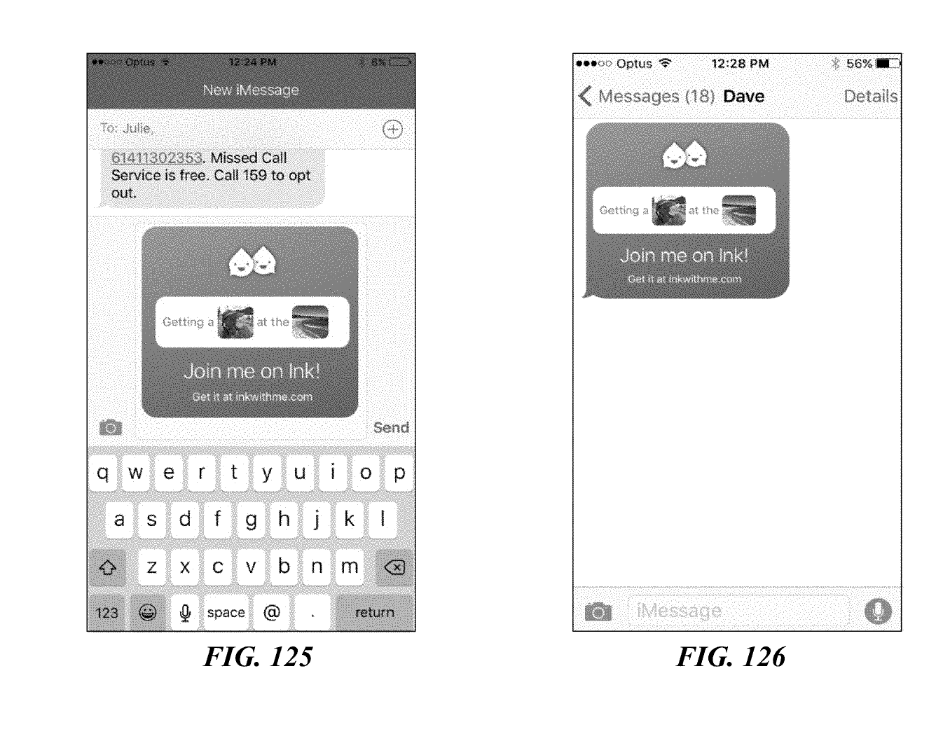

In some embodiments, text messages composed and/or received using the disclosed mobile application, can be shared or posted on other social media platforms and communications platforms outside the system. After a user taps on a “share a message” button illustrated in FIG. 120, the user can compose the message on an interface displayed in FIG. 121. In this example, a user composes the message “getting a shave ice at the beach.” Once ready to send, the user taps the “share” button as illustrated in FIG. 122. A pop-up then prompts the user to select a platform/service on which to share the message, as displayed in FIGS. 123-124. The example shown illustrates a user choosing to share the message as a SMS message with a recipient. If the recipient's mobile device does not have the disclosed mobile application installed, the recipient receives a specialized message including a rendered image along with a link to download the disclosed mobile application, as illustrated in FIGS. 125 and 126.

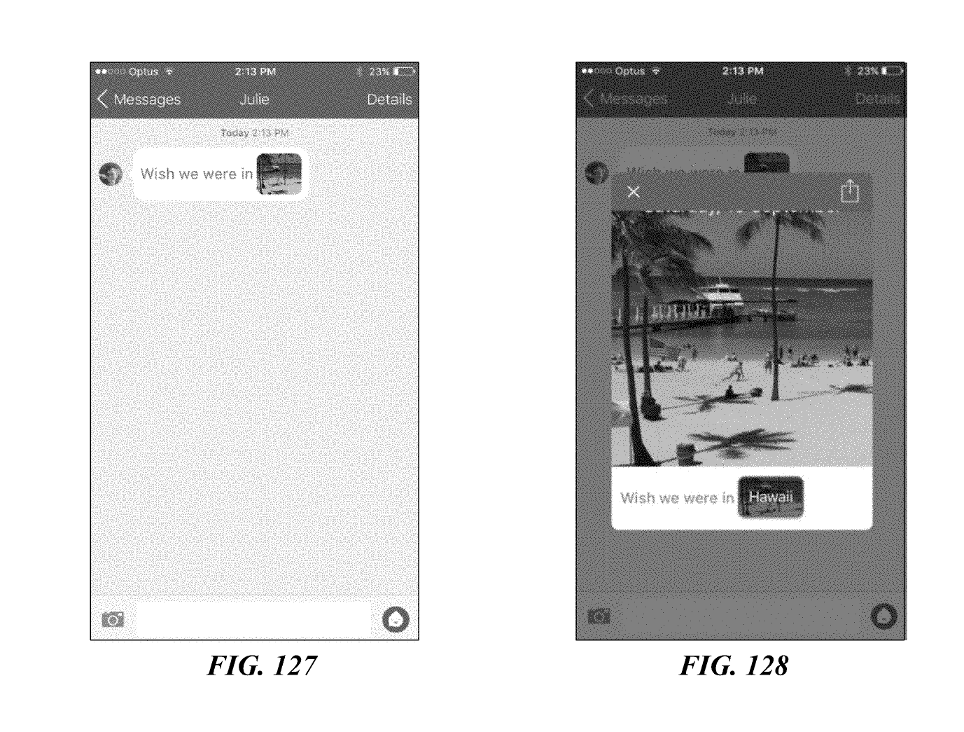

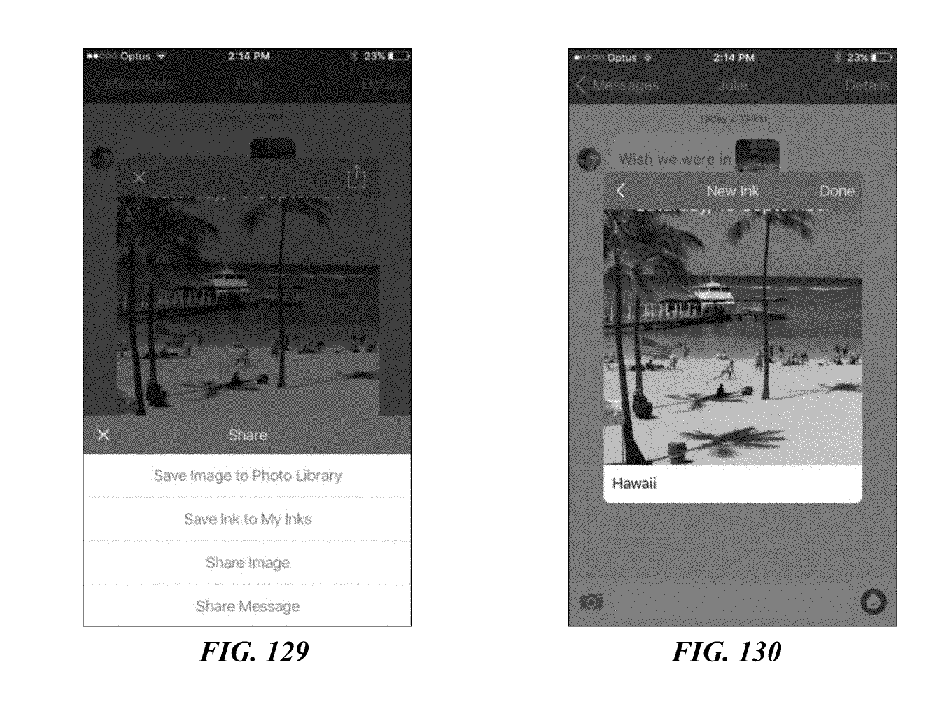

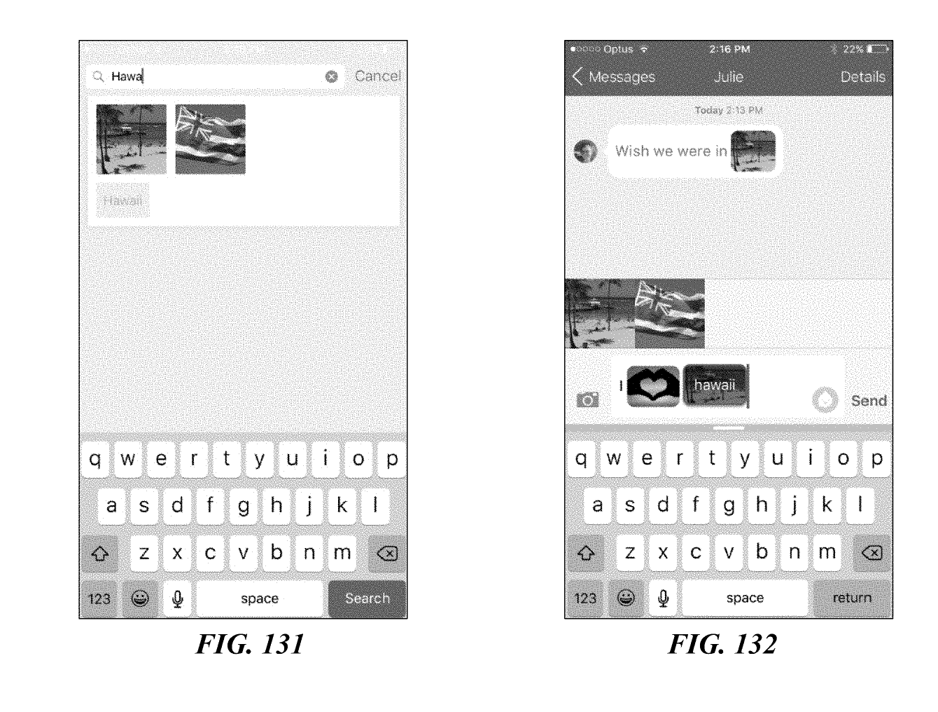

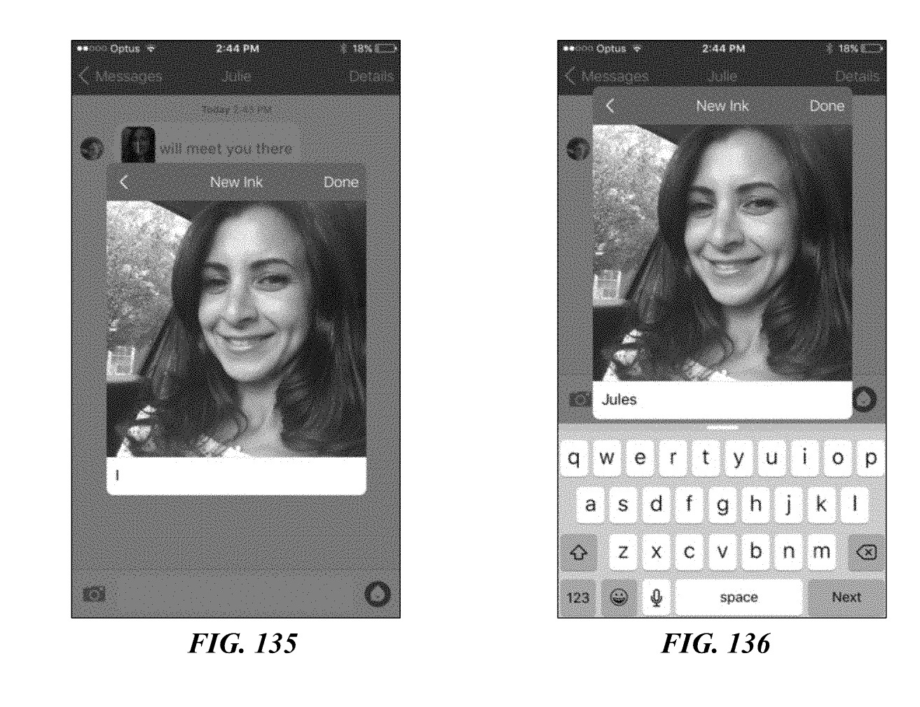

FIGS. 127-139 illustrate example scenarios in which ink sets are created by saving images received in communications with other users. These newly-created ink sets can be in addition to the user's personal ink sets. FIG. 127 illustrates an example scenario in which a user receives a message from “Julie” that states “wish we were in Hawaii.” The user taps on the message from Julie to enlarge the linked image, as illustrated in FIG. 128. Tapping on the share icon located in the top right-hand corner of the pop-up in FIG. 128 reveals an option to “save Ink to my inks,” as illustrated in FIG. 129. Tapping “done” in FIG. 130 saves the image along with the linked text to the user's personal ink set library, as illustrated in FIG. 131. For example, the user's personal ink set library now includes one newly-added linked image (from Julie) corresponding to the content item “Hawaii,” identified as a relevant content item by the user and by Julie. The user is then able to use the linked image in text messages (FIG. 132).

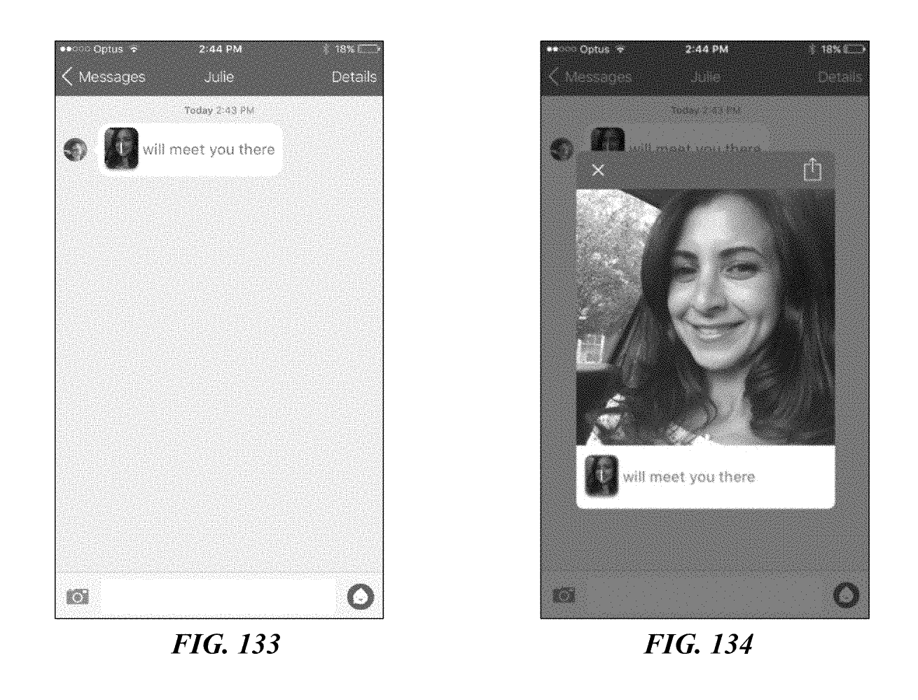

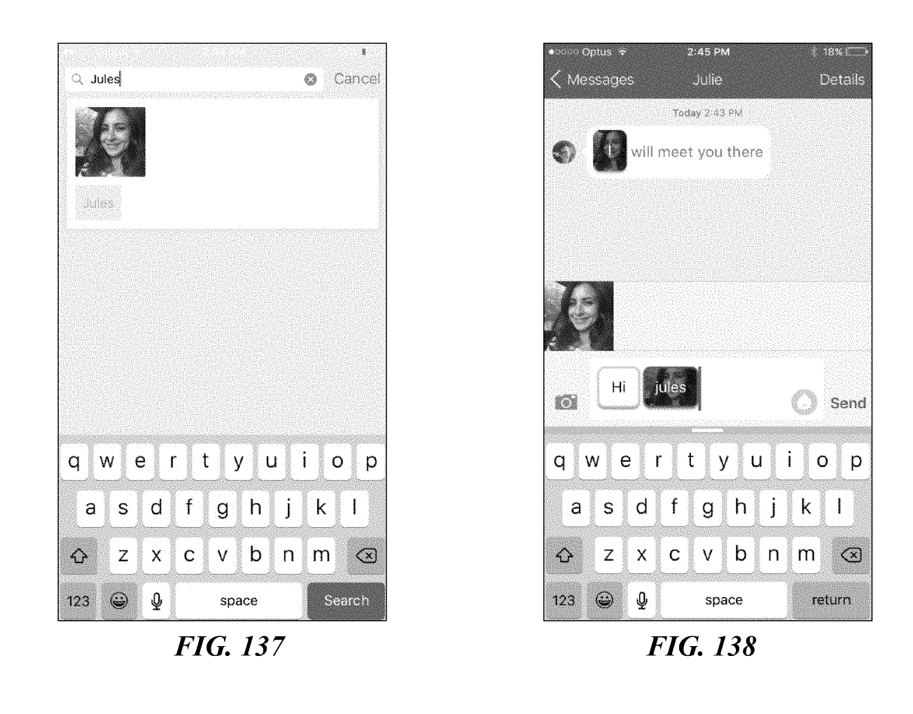

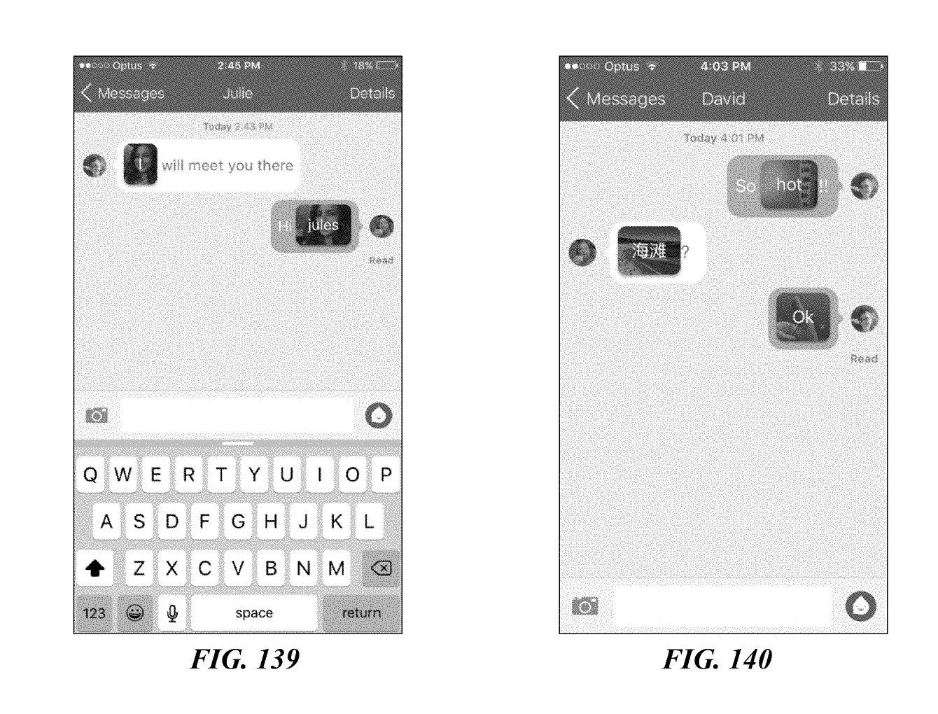

FIGS. 133-139 illustrate an example scenario in which a user replaces the content item corresponding to a linked image (received in a text message from another user) with a different content item. FIG. 133 shows a text message “I will meet you there” received by a user from Julie. The text message includes a linked image corresponding to the word “I.” The user expands the linked image in FIG. 134, and reviews the content item “I” corresponding to the linked image. FIG. 136 illustrates an example scenario in which the user changes the content item “I” sent by Julie to a different content item “Jules.” Tapping “done” results in the creation of a new linked image being saved to the recipient's personal ink set library, as illustrated in FIG. 137. The ink set is now available for use in the composition of a message. In the example illustrated in FIG. 138, the user inputs the message “Hi Jules” and the system automatically converts the text to the linked image. The new ink set is shown sent as part of a message thread in FIG. 139, along with the same linked image but corresponding to a different content item.

Ink sets (linked images) can be used to break language barriers, unifying people across geographical regions. For example, linked images can be sent in text messages composed using different languages, enabling people to bridge language barriers. FIG. 140 illustrates a sample message thread in which a conversation takes place between users in English and Chinese. The conversation begins in English “So hot!!,” is replied to in Chinese “beach?,” with the response in English “OK.”

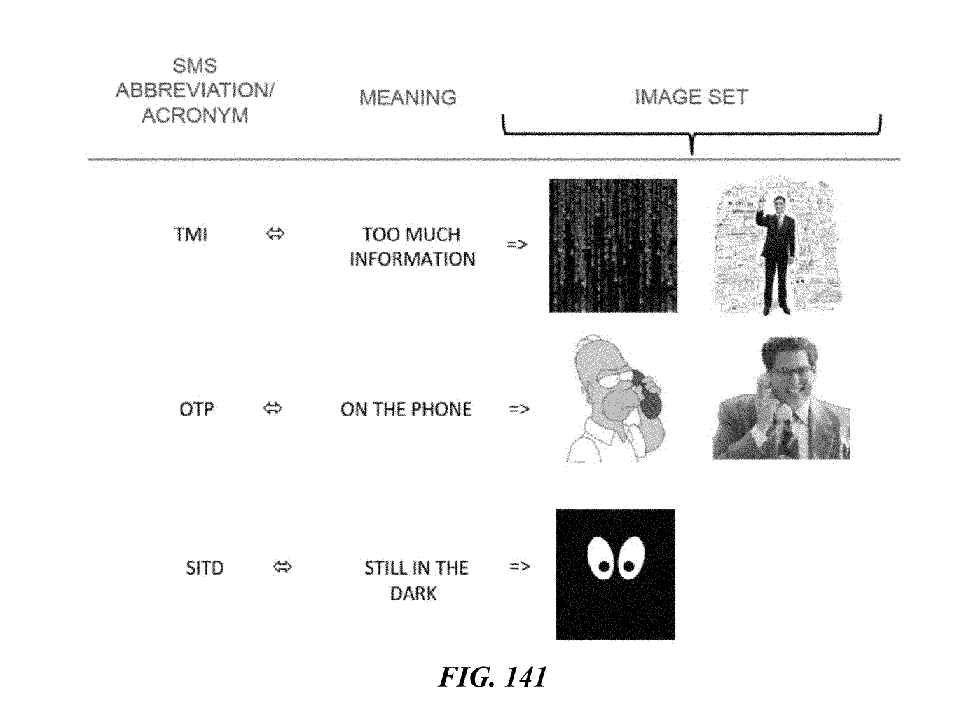

FIG. 141 illustrates an example scenario in which acronyms (content items) are linked to images. The example shown illustrates the acronyms: TMI for “too much information,” OTP for “on the phone,” and SITD for “still in the dark.”

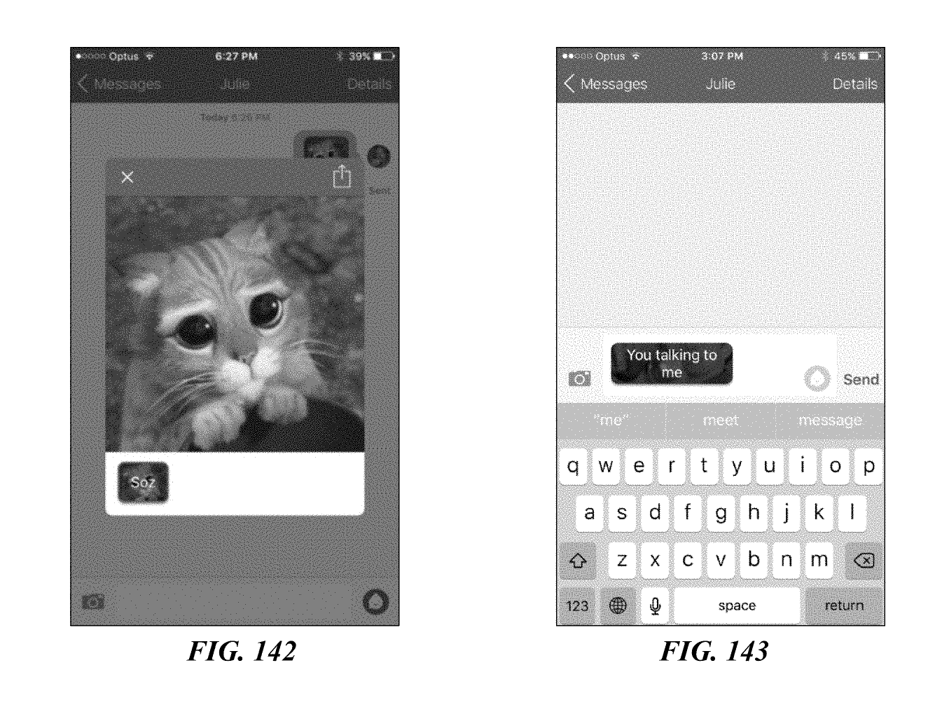

FIG. 142 illustrates an example scenario in which SMS abbreviations (content items) for sorry “SOZ,” has been entered as text and converted to a linked image of Puss in Boots®.

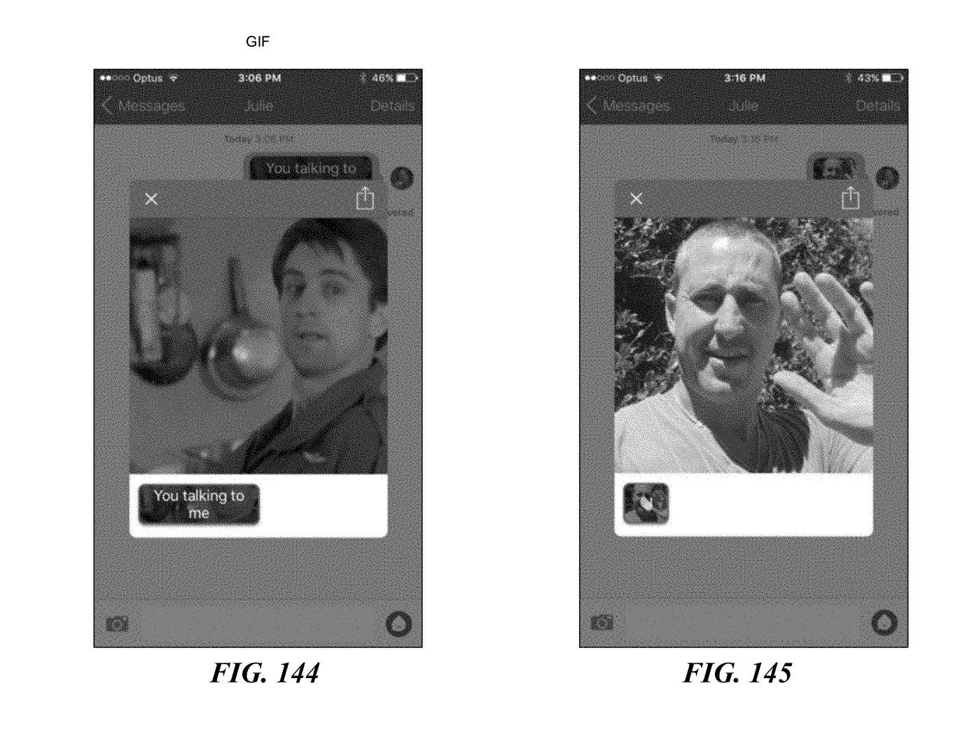

In addition to abbreviations and acronyms, ink sets can also be created for terms and phrases. Images used in creating linked images can be GIF images. FIGS. 143-144 illustrate an example scenario in which a GIF image is linked to a phrase (e.g., a content item). In this example, a GIF image from the movie Taxi Driver has been linked to the generic phrase “You talking to me?”

In some embodiments, GIF images can be created by a user. FIG. 145 illustrates an example of a GIF, created by a user and then linked by the disclosed mobile application to an emoji for use in text messages.

FIGS. 146-149 illustrate examples in which an SDK is utilized to enable users access to their ink sets in the composition of messages while on other messaging or social media platforms/services/apps, or within an operating system's native messaging platform. Users create, store and manage their ink sets via the disclosed mobile application on their device and activate the “linked image functionality” on alternate platforms/services/apps to enable the automatic conversion of content items to linked images within these platforms/services/apps.

### Branded Inks

In addition to the methods already described, users can view and download additional ink sets corresponding to brands of organizations from a brand library—an online image repository that stores images (linked to text) under license, or from external sources. Brands create and attach relevant image sets to content items in order to create their own ink sets. Ink sets from the same content provider form a brand ink, also referred to herein as branded linked images. A brand in this context refers not only to a typical “brand” for a product or services, it can also correspond to a person or a team, such as a sporting team or an individual player, Hollywood celebrity, artist, etc., or any other content provider.

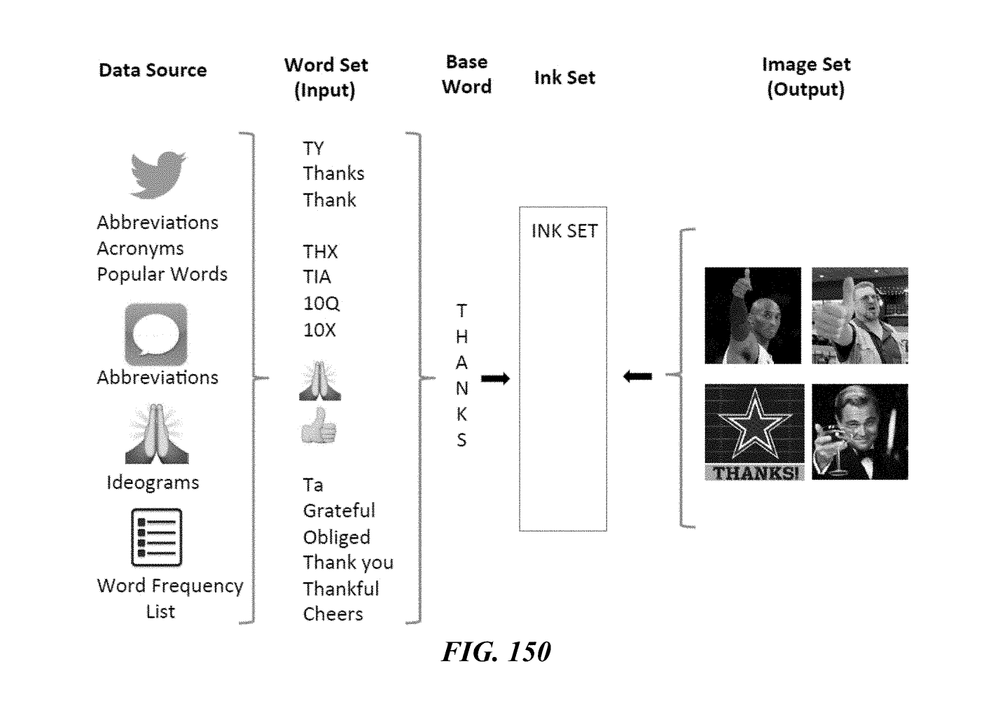

FIG. 150 illustrates a sample paradigm in which branded ink sets are created. Brands distribute linked images, i.e., images linked to a specific content item (base word). In FIG. 150, the base word is “thanks.” The brand then creates a word set with additional words on top of the base word. The word set is linked to images. The text in base words can be provided to a brand by an entity (that provides the disclosed mobile application and the SDK/APIs). The text can include commonly used abbreviations, acronyms and words used on various social media platforms, SMS abbreviations and acronyms, ideograms such as emojis, as well as a word frequency list. Brands can also include additional text to link to an image. The example shown illustrates four separate images, provided by various brands, linked to text.

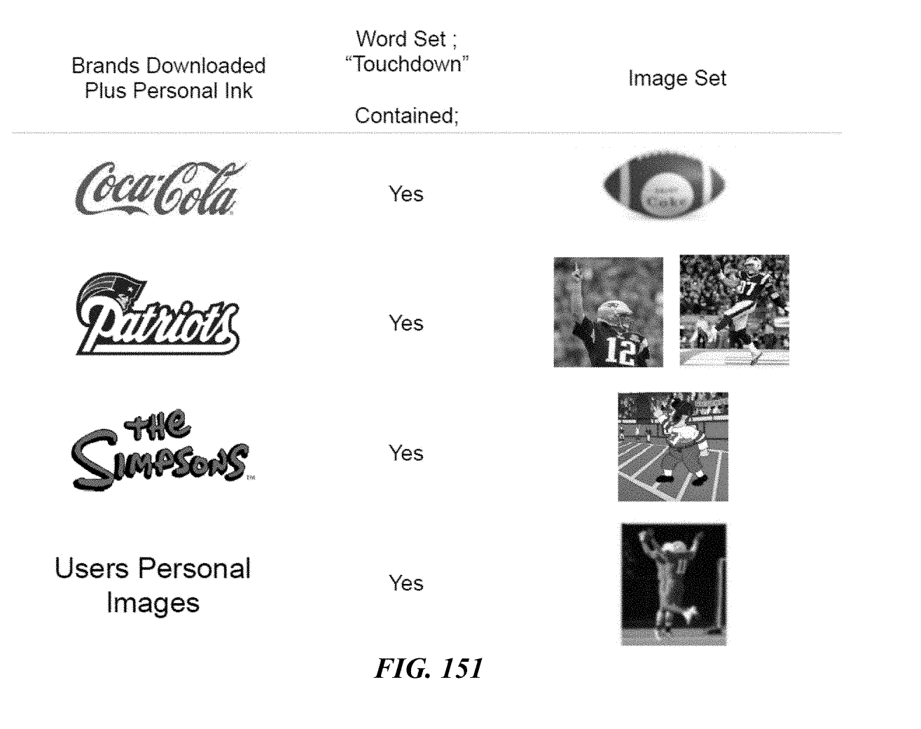

Users can download specific branded ink sets. Once downloaded, these ink sets are made available to users within their own personal inks, appearing as either variations or default images. FIG. 151 illustrates a sample paradigm of a personal ink for the text “touchdown.” In this example, images are sourced from a user's personal images, as well as images from multiple branded ink sets. Branded images from various brands have been downloaded to a user's personal ink set library along with the “user's personal images.” When a user inputs the word “touchdown,” one of these images appears as the default image and the others as variations within the image set.

Depending on the age of a user (e.g., based on login details provided when initially downloading the Ink app) the system can restrict certain brand inks being made available for viewing and downloading. Brand inks can be allocated a rating based on the current MPAA rating system. For example, a brand ink may have a rating of NC-17. In this case the brand ink would not appear as an option available for download by a user under the age of 17.

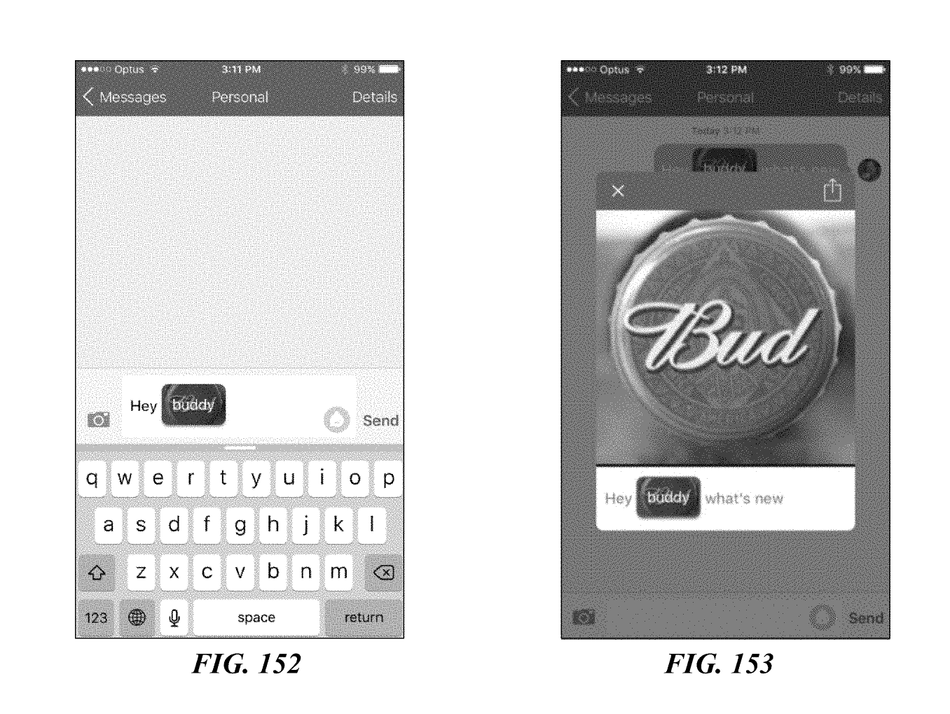

Within the brand library, brands can also promote generic words that have contextual relevance to the brand(s). For example, Budweiser can promote “bud” along with “buddy,” “friend,” or “pal,” and Coca Cola can promote “drink” or “thirsty.” When a user inputs text that a brand has linked to an image in this regard, the image can appear as either the default image or have preferred placement among the variations in the relevant image set. This type of brand promotion is illustrated in the example scenario shown in FIGS. 152-153, where a user has input the message, “hey buddy what's new.”

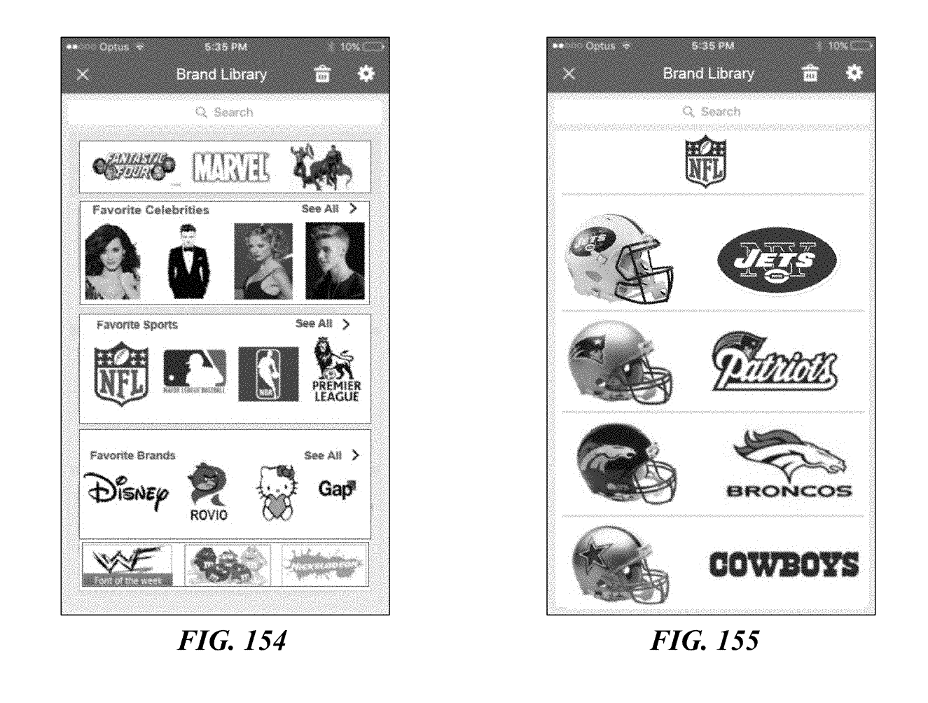

Users are also encouraged to upload images of their own to the brand library, to be considered for inclusion within the system's brand ink. This is a compilation of images sourced from users and uploaded to an online library can be made available to other users for download. FIG. 154 illustrates an example of a brand library for the selection of various brand inks. Users scroll through each row to display additional brands. In this example, the upper and lower rows display advertising space for various brands, with the three middle rows divided between “favorite celebrities,” “favorite sports,” and “favorite brands.” Users can download a brand ink, by tapping on their chosen brand.

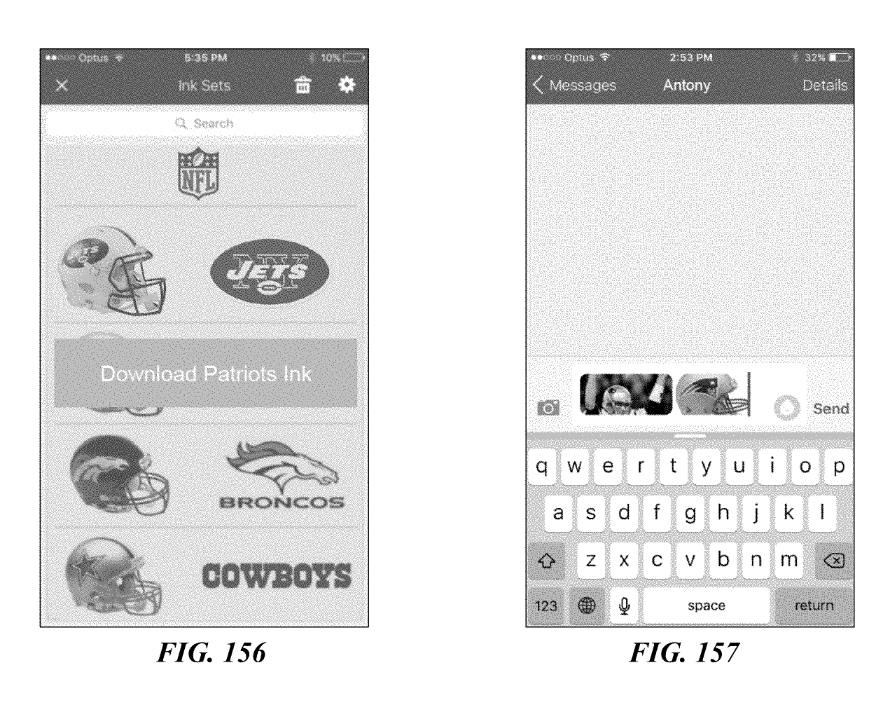

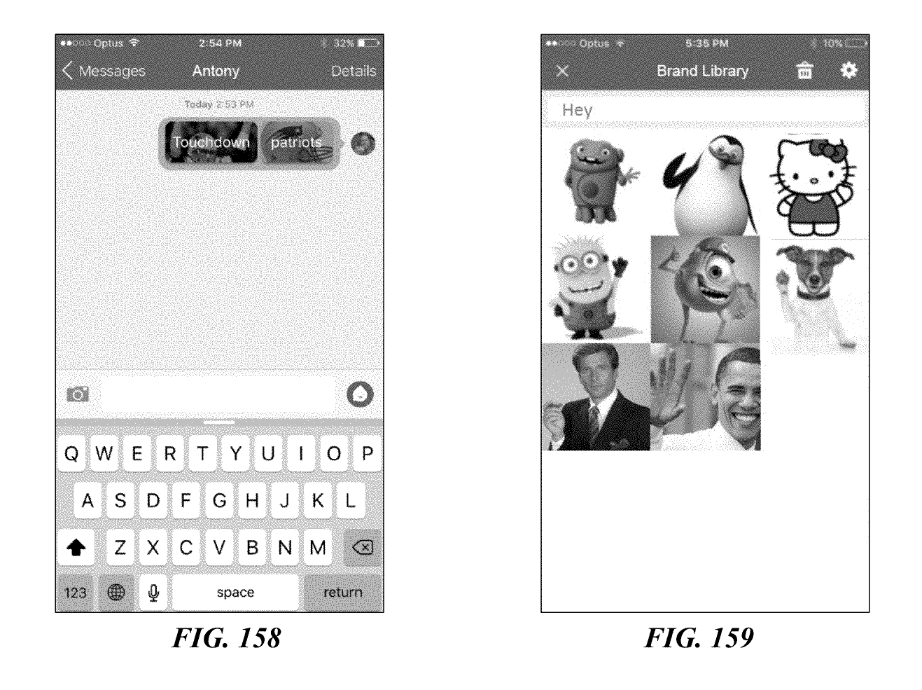

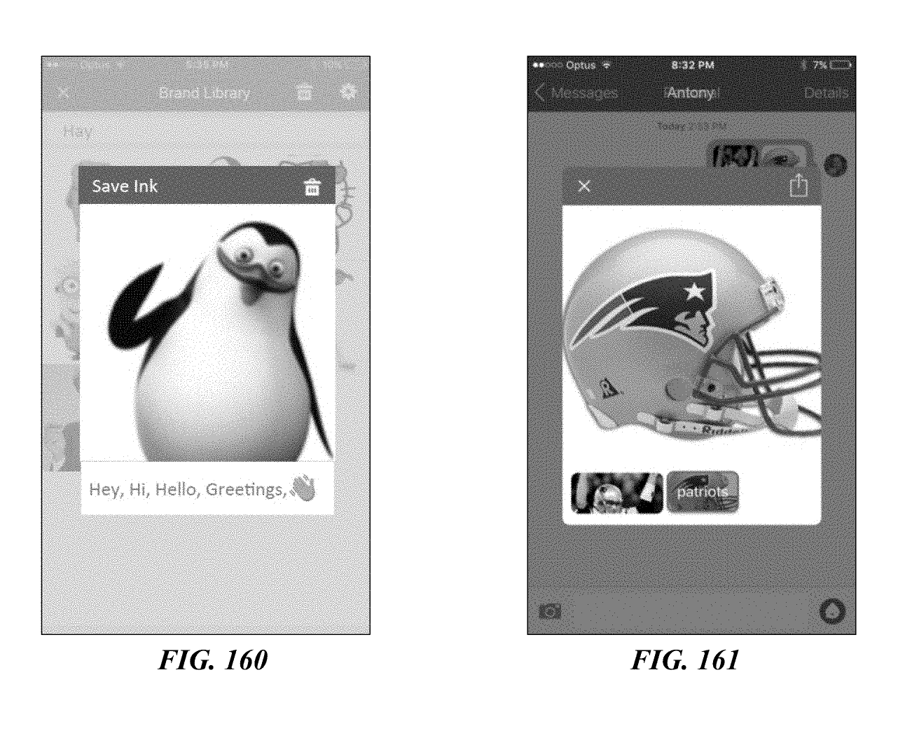

FIG. 155 illustrates an example scenario of various sports team ink sets. In the example, the user taps on the NFL® logo in FIG. 154. This opens brand inks associated with the NFL. Tapping on the New England Patriots® logo, the user is prompted to download the team brand ink, as illustrated in FIG. 156. Once downloaded, all ink sets included within the brand ink are added to a user's personal ink sets and made available in the composition of messages. FIGS. 157-158 illustrate an example in which the message: “touchdown patriots” is input and sent using images supplied by the brand. Images in the brand library can be searched for and viewed, as illustrated in FIG. 159. In this example, the user has searched for branded images linked to the text “Hey.” The image search results represent those images supplied by various brands and linked with “Hey.” Tapping on individual images displays a pop-up, as illustrated in FIG. 160, including all text linked to the image. In this example, an image of a penguin from the movie, Penguins of Madagascar®, is shown along with the text: “Hey, Hi, Hello, Greetings and an emoji of a hand waving.” Users can save the ink set as is, or they can add to or delete text to further personalize. Once the linked image is saved, the ink set forms a part of the user's personal ink set library and is available for the composition of messages.

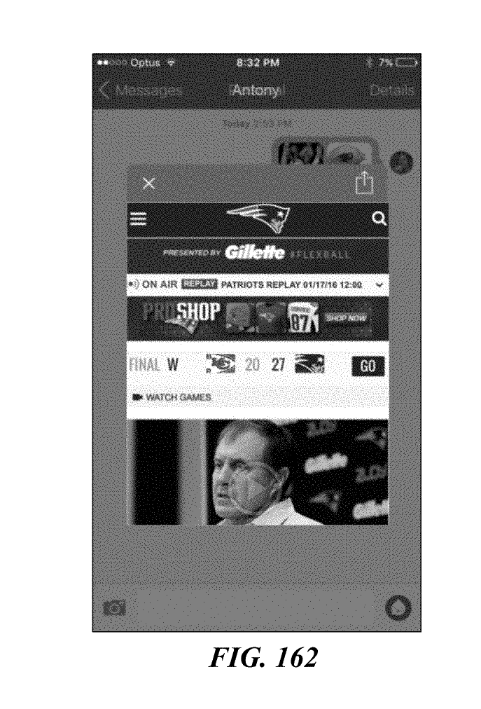

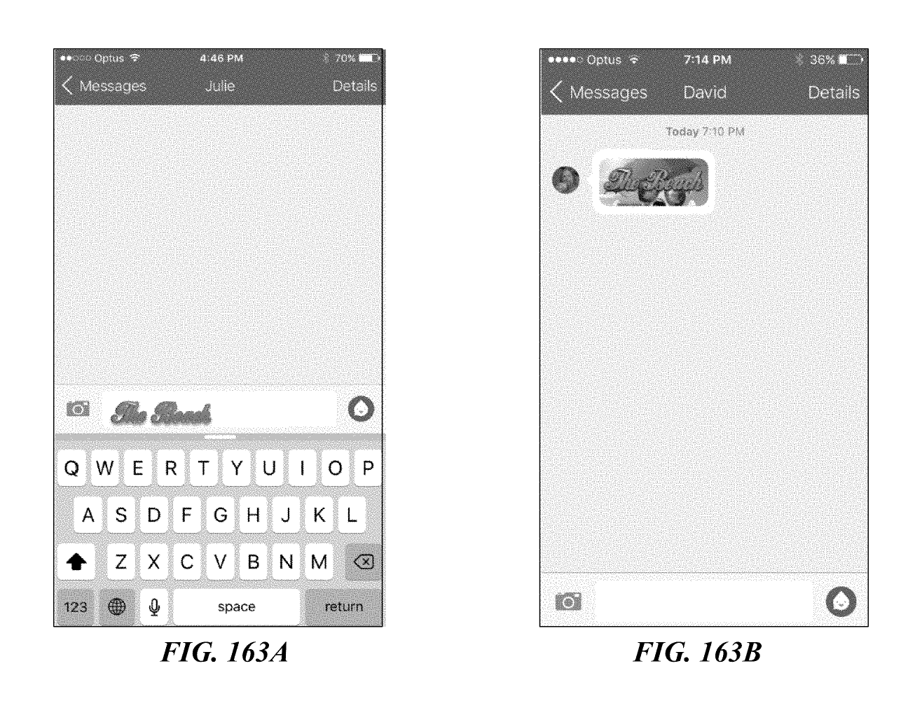

Brands can also attach hyperlinks to images, redirecting users to a brand's chosen web site. FIG. 162 illustrates an example brand-designated web page, accessed by holding down on the branded image shown in FIG. 161. Brands can upload their own branded font (a font particular to a specific brand), in which text is displayed when a brand ink is used. FIGS. 163A-163B illustrate an example of branded font using a Coca Cola® font. In the example, a user has chosen to incorporate a Coca-Cola® branded ink set linked to the text: “the Beach.”

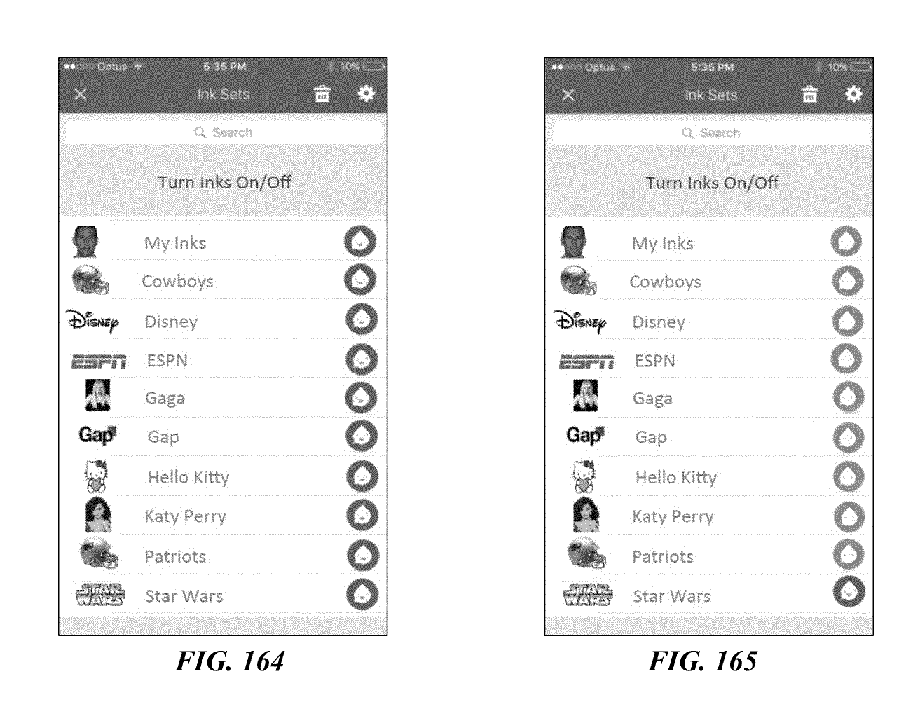

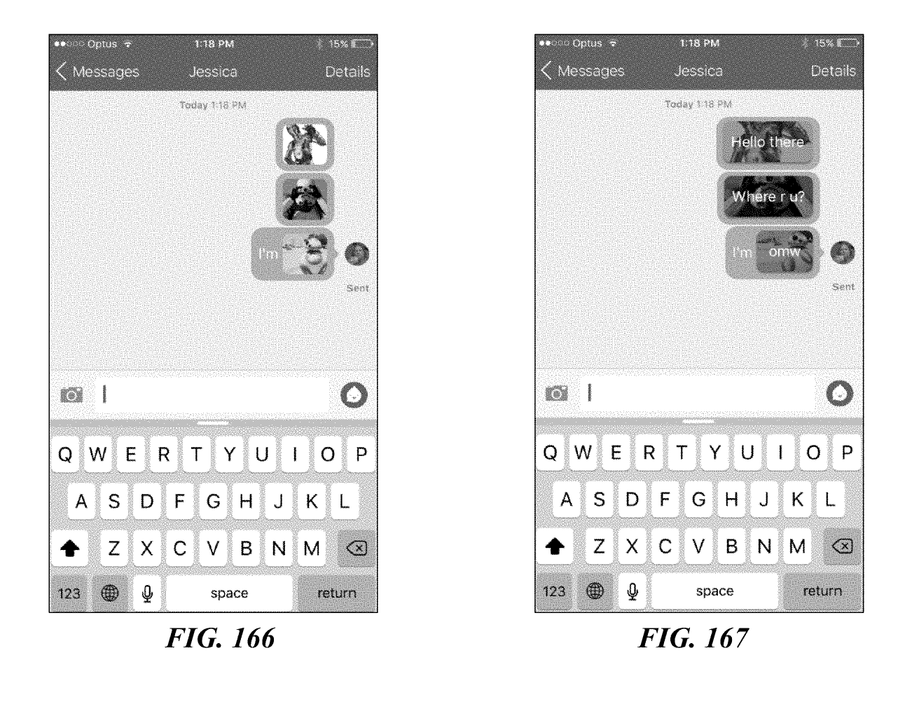

Users can manage which brand inks are displayed in the composition of messages (either as default images or variations) by turning specific brand inks on or off, as illustrated in FIGS. 164-165. Brand inks that are “on” are illustrated by the purple Ink logo. In this way, a user can limit the type of images used in the composition of a message by turning off various brand inks. In the example in FIG. 165, a user has chosen to turn off all downloaded ink sets except the Star Wars® ink. FIGS. 166-167 illustrate an example of a series of messages composed using the Star Wars® ink only.

Brands can enhance ink sets through direct customer engagement. Brands can request fans and followers to comment on branded images, submit additional images for possible inclusion within a brand ink, or indicate what other text they would like to have images for.

By virtue of these features, brands are now a part of a user's conversations, integrated into the native format rather than being in competition with it for space. As such, they neither disrupt the aesthetics nor interrupt a user's chain of thought, but enhance the experience through a chosen engagement. In addition, rather than a brand simply inserting native content that tells a story, a brand's ink set enables the brand's content to be inserted by a user to tell a story, one that the user wants to tell, at the very moment they want to tell it and pass it on.

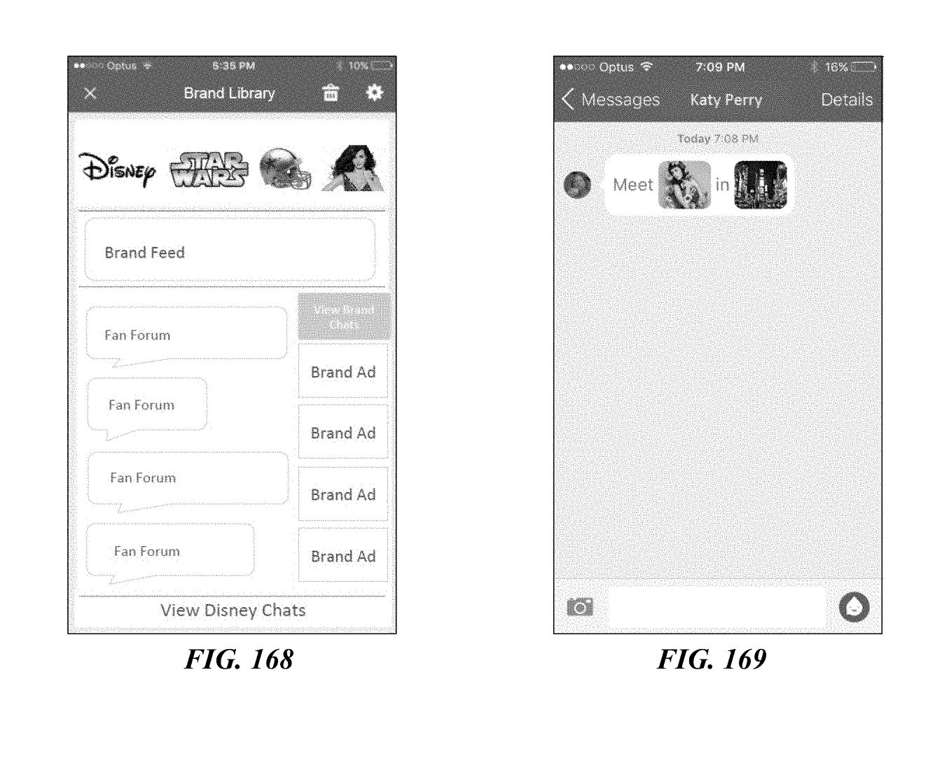

FIG. 168 illustrates an example of a brand homepage, with a Fan forum in which a brand's fans can chat using the brand's ink sets and a brand Feed can relate to a fan discussion, help spark a conversation between brand loyalists, display trending brand-related topics, make an announcement, etc. The forum can also include additional brand-related materials, such as advertisements.

Brands can communicate with followers/fans via the system using one-to-many messaging, or via brand chats within their brand forum. A brand chat can be started either by a user/group of users or by a brand itself. Brand chats can be marketed and sourced by various titles, such as topic, geographic area, etc. Where a brand creates a chat, parameters (as broad or specific as required) can be established by the brand for the chat, such as limiting the chat to users of a certain age group and/or location. A time frame for the chat can also be set. An example brand chat may have the following requirements:
Topic: new Star Wars® Movie, user Location; California, United States; user age group: 13-18 years (or use a MPAA rating such as PG-13); chat start date: 12/15/15; time: 17:00-20:00 P.S.T.

Sport teams and celebrities can create “event-related” chats. For example, a pre/post-match chat between a team's supporters and a player. As such, a brand can engage with specific users and enable a brand's fans/followers to interact with the brand as well as with one another.

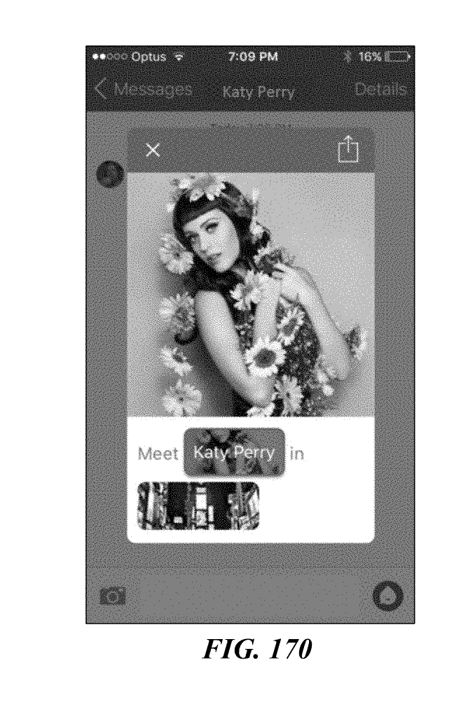

Brands can also send image-based push notifications as illustrated in the example in FIGS. 169-170, in which Katy Perry sends fans/followers a message to inform them that they can meet her in Times Square.

### Smart Devices

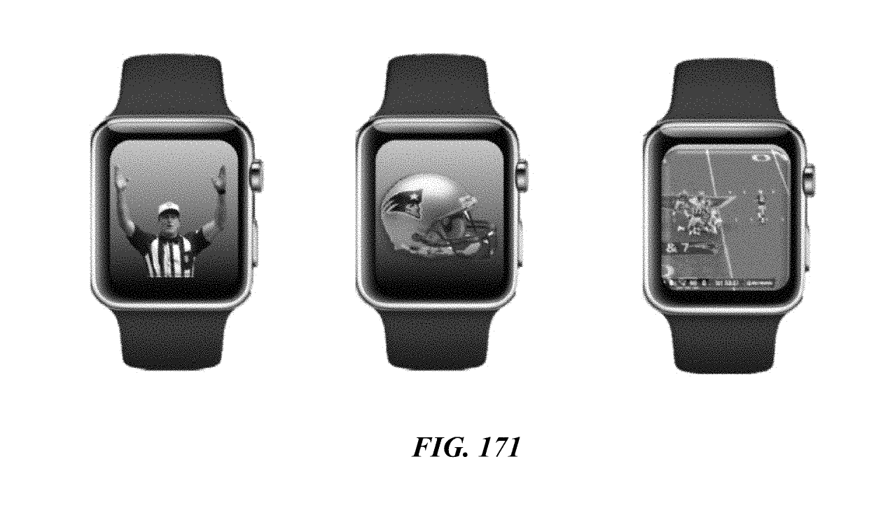

Embodiments of the present disclosure can be utilized across a variety of devices. This includes various mobile devices, such as wearable devices (smart watches, glasses, headsets, etc., as illustrated in FIG. 171), smart phones, laptop computers, tablets, etc. When viewed on a smartwatch, a recipient can view multiple linked images included within a text message by tapping or swiping movements on linked images to open a next linked image. In some embodiments, the linked images can be displayed one after the other automatically in a loop once a text message has been opened by a recipient.

### Acquisition and Trading of Ink Sets

Ink sets can be acquired (including, but not limited to, for free, purchased, won, or traded). Brands can offer free ink sets for a user to be able to start communicating in the brand ink. Brands can create and offer premium ink sets for sale. Premium ink sets can range from as few as one image to as many as the brand chooses.

The system also allows for brands to create activities, games and competitions for users to earn or win premium ink sets. The system include mechanisms to authenticate original branded images through the association of both visual and digital authentication measures, such as a holographic stamp. Authentic original branded images can be distributed as authenticated limited editions. Limited editions can range from as few as one image to as many as the brand chooses and can be individually numbered. Brands that are artists can create authentic original ink (including, but not limited to artwork) for use within messaging that can be sold and then become the user's property.

The system provides a platform for collecting images. Virtual albums can be created by the branded ink set. Using a virtual platform, a user can track and view which linked images he or she acquired as well as those linked images that he or she desires to complete the branded ink set. On completion of a branded ink set, the user may be rewarded by the brand with a “gift.” Users can acquire multiple versions of the same image. The system also facilitates include an ink trading floor where users can trade linked images they have acquired in a marketplace. Furthermore, the system provides a mechanism to verify the authenticity of the linked images being traded.

### Backend Architecture

The disclosed mobile application is a mobile messaging application that, in some embodiments, allows users to convert text into images and GIFs and send them to other users. Users associate images to text and save them in collections called ink sets for later use. When the user types the text, programming algorithms are used to detect and match the text to the associated image(s) and convert them into an image that can then be sent to another user in a message. In some embodiments, in addition to the disclosed (client) application, a back-end remote server component is present.

Back-end architecture and infrastructure can include a Ruby on Rails (RoR) web application that handles the web admin panel and logic for storing and retrieving client app user data, admin user authentication, ink uploads via admin panel, and other functionality. This RoR application and its accompanying database can be hosted on cloud servers and can automatically scale to support a heavy load. In some embodiments, linked images sent in text messages are sent as metadata including the URL of the image and not the image itself in order to optimize performance.

On the iOS™ client app, chat messaging is provided by the Layer SDK (https://layer.com/), which provides many basic messaging functionalities such as transmitting text and images between devices, group messaging, and other functionalities that would otherwise need to be built from scratch. For performance and data usage optimization, downloaded images are cached on the device until the cache is full or until the images are replaced by newly downloaded images and GIFs. Furthermore, images and GIFs uploaded by users can be first cropped into a 1:1 aspect ratio, and then resized to 512×512 pixels. User authentication is provided by, e.g., Digits (http://get.digits.com/) and ties a user's identity to their phone number. Both client side and server side applications use secure technologies for user authentication. All network messages are securely sent between iOS and the back-end through TLS 1.2 encryption.

### Suitable System

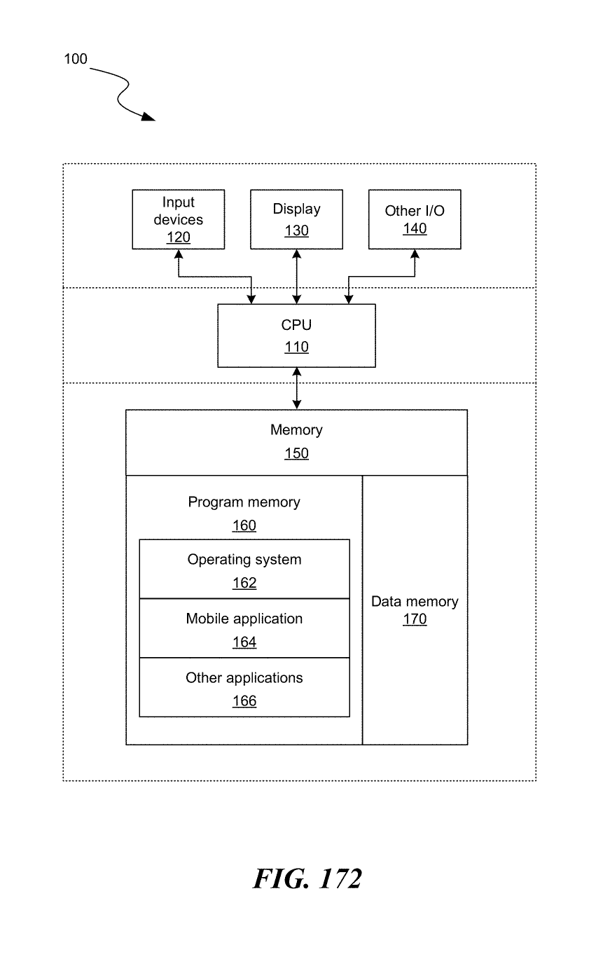

FIG. 172 is a block diagram illustrating an overview of devices on which some implementations of the disclosed technology can operate. The devices can comprise hardware components of a device 100 that can generate linked images. Device 100 can include one or more input devices 120 that provide input to the CPU (processor) 110, notifying it of actions. The actions are typically mediated by a hardware controller that interprets the signals received from the input device and communicates the information to the CPU 110 using a communication protocol. Input devices 120 include, for example, a mouse, a keyboard, a touchscreen, an infrared sensor, a touchpad, a wearable input device, a camera- or image-based input device, a microphone, or other user input devices.

CPU 110 can be a single processing unit or multiple processing units in a device or distributed across multiple devices. CPU 110 can be coupled to other hardware devices, for example, with the use of a bus, such as a PCI bus or SCSI bus. The CPU 110 can communicate with a hardware controller for devices, such as for a display 130. Display 130 can be used to display text and graphics. In some examples, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen; an LED display screen; a projected, holographic, or augmented reality display (such as a heads-up display device or a head-mounted device); and so on. Other I/O devices 140 can also be coupled to the processor, such as a network card, video card, audio card, USB, FireWre or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The CPU 110 can have access to a memory 150. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 150 can include program memory 160 that stores programs and software, such as an operating system 162, mobile application 164, and other application programs 166. Memory 150 can also include data memory 170 that can include, for example, contact information, preferences, linked images, content items, images, ink sets, and photographs, and which can be provided to the program memory 160 or any element of the device 100.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

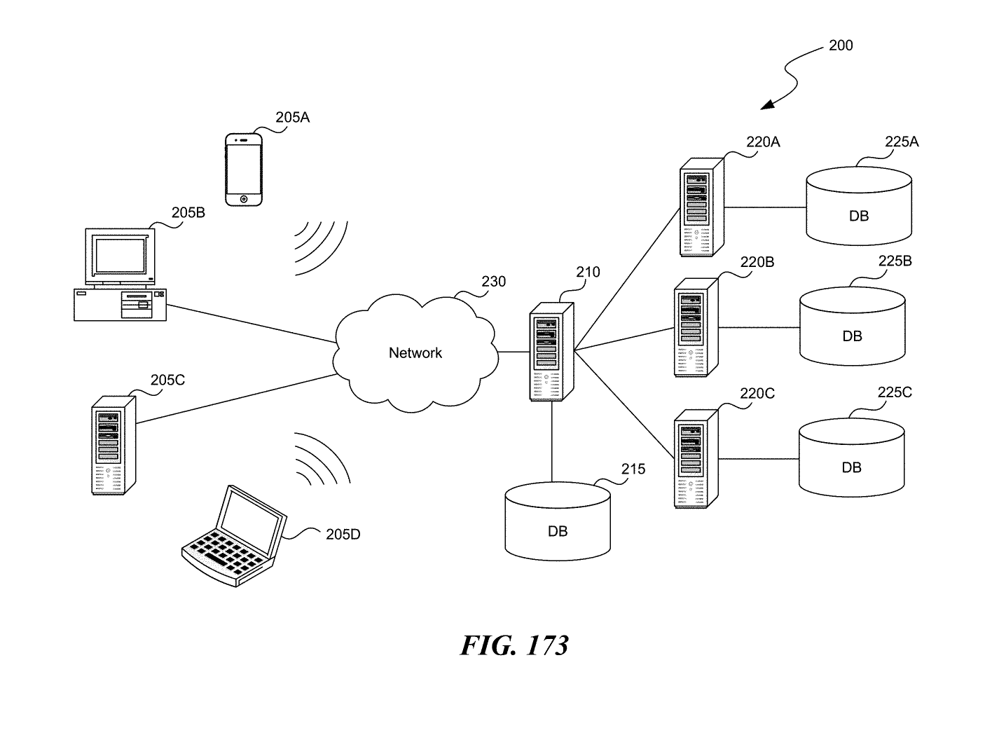

FIG. 173 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device 210.

In some implementations, server computing device 210 can be an edge server that receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server computing device 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g., store) information such as images, ink sets, content items, user preferences, deleted messages, messages, and linked content items. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

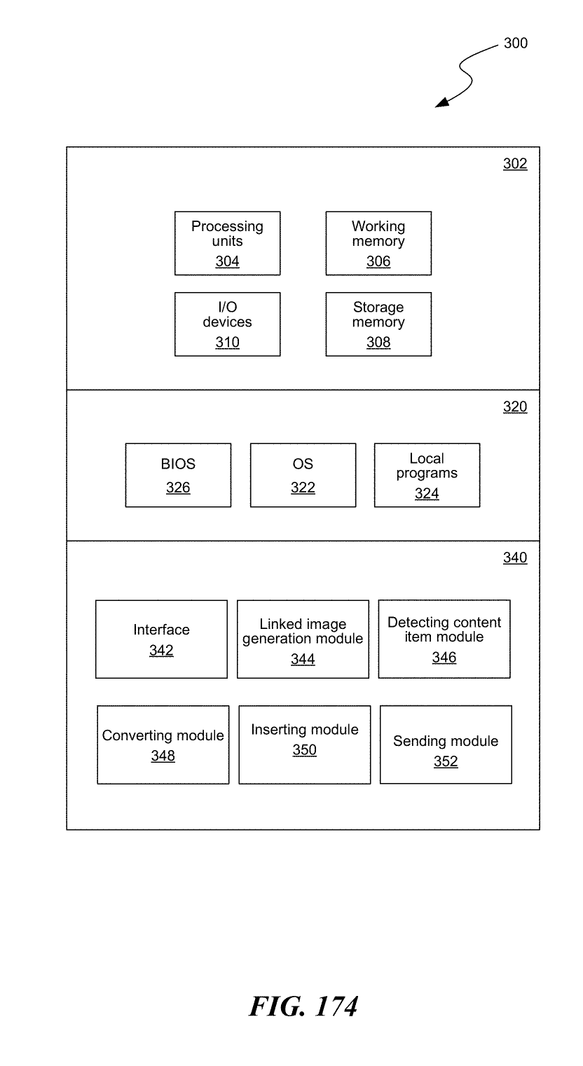

FIG. 174 is a block diagram illustrating components 300 which, in some implementations, can be used in a system employing the disclosed technology. The components 300 include hardware 302, general software 320, and specialized components 340. As discussed above, a system implementing the disclosed technology can use various hardware, including processing units 304 (e.g., CPUs, GPUs, APUs, etc.), working memory 306, storage memory 308, and input and output devices 310. Components 300 can be implemented in a client computing device such as client computing devices 205 or on a server computing device, such as server computing device 210 or 220.

General software 320 can include various applications, including an operating system 322, local programs 324, and a basic input output system (BIOS) 326. Specialized components 340 can be subcomponents of a general software application 320, such as local programs 324. Specialized components 340 can include linked image generation module 344, detecting content item module 346, converting module 348, inserting module 350, sending module 352, and components that can be used for transferring data and controlling the specialized components, such as interface 342. In some implementations, components 300 can be in a computing system that is distributed across multiple computing devices or can be an interface to a server-based application executing one or more of specialized components 340.

Linked image generation module 344 can receive an image and a content item representative of the image and generate a linked image by creating a link between the image and the content item. Detecting content item module 346 can detect that a content item entered by the user on the application (or a second application) is a content item that has been linked to an image. Detecting content item module 346 can retrieve the linked image from the memory of the device or from a remote storage device. Converting module 348 can convert the content item into the linked image. Inserting module 350 inserts a version of the linked image into the application (or second application). Sending module 352 can send the message, including the linked image, to a recipient device. Sending module 352 can further receive a request to delete the message from the device and from the recipient's device. Upon receiving a request to delete the message, sending module 352 can delete the message from the device and send a request to a remote server to delete the message from the recipient device.

From the foregoing, it will be appreciated that specific embodiments of the invention have been described herein for purposes of illustration, but that various modifications may be made without deviating from the scope of the invention.

Those skilled in the art will appreciate that the components illustrated in FIGS. 172-174 described above and in the flow diagram and sequence diagram may be altered in a variety of ways. For example, the order of the logic may be rearranged, substeps may be performed in parallel, illustrated logic may be omitted, other logic may be included, etc. In some implementations, one or more of the components described can execute one or more of the described processes. Moreover, while the application (i.e., “mobile application,” “first mobile application,” “second mobile application”) is referred to as a “mobile” application throughout the specification, the application can be installed or accessed on devices that are not mobile. Additionally, while the device is referred to throughout the specification as a “mobile” device, the device can be a device that is not mobile.

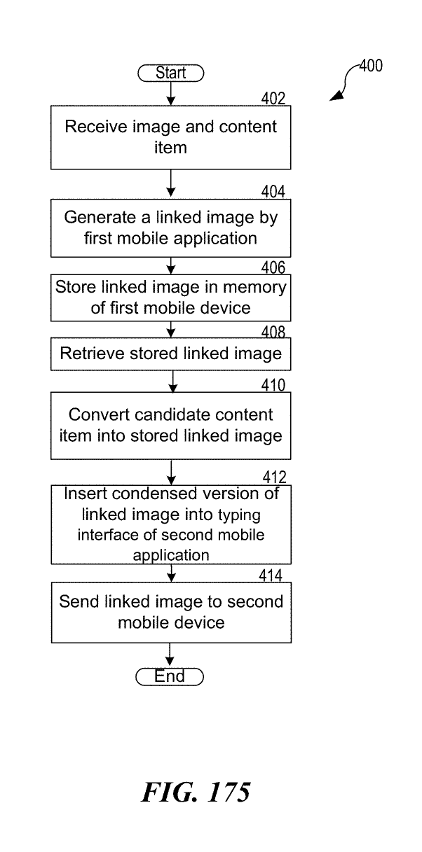

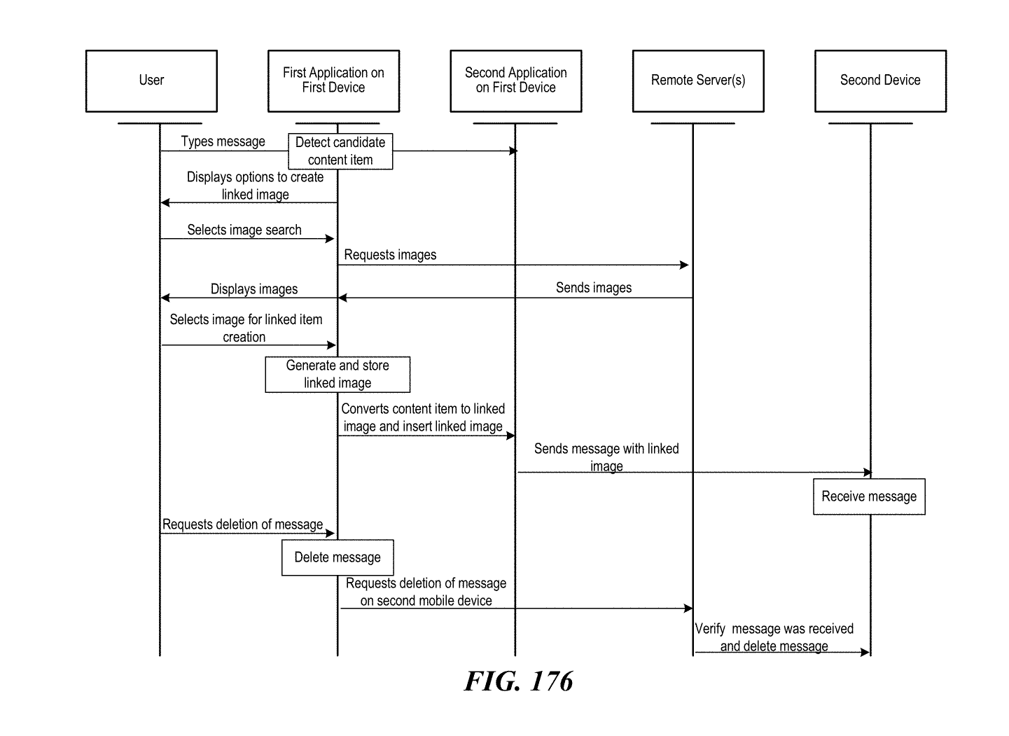

FIG. 175 is a flowchart 400 showing the steps implemented by a mobile application for generating linked images according to embodiments of the present disclosure. The mobile application is the disclosed mobile application (e.g., a first mobile application) and runs on the user's mobile device (e.g., a first mobile device). At step 402, the first mobile application receives an image and a content item representative of the image from a user. The content item can be a word, an expression, a collection of characters, or an emoji. In response to receiving the image and the content item representative of the image, the first mobile application generates (at step 404) a linked image by creating a link between the image and the content item. At step 406, the linked image is stored in a memory of the first mobile device. The user composes a text message via a typing interface of a second (e.g., messaging) application on the first mobile device. The messaging application can be a text messaging application associated with an operating system on the first mobile device. Alternately, the messaging application can be a third party application. In some embodiments, the messaging application is the disclosed mobile application, and no other messaging application is necessarily involved. Upon detecting that a candidate content item entered by the user on the typing interface matches with the content item representative of the image, the disclosed mobile application retrieves (step 408) the linked image from the memory of the first mobile device, converts (step 410) the content item into the linked image, inserts (step 412) a condensed version of the linked image into the typing interface of the second mobile application, and sends (step 414), via the second mobile application program, the linked image to a second mobile device, for example, to an intended recipient. In some embodiments, a candidate content item entered by the user item on the typing interface matches with the content item representative of the image according to one of the following matching conditions: (i) the candidate content item is identical to the content item, or (ii) at least a portion of the candidate content item is identical with at least a portion of the content item representative of the image.

FIG. 176 is a sequence diagram showing interactions between devices and components according to embodiments of the present disclosure. The sequence begins with the user typing a message into a second application on a first device. A first application on the first device can monitor the message and detect a content item that is a candidate for becoming a linked image. The first application can provide options to the user to create a linked image (e.g., take photo, photo library, image search). When the user selects an option for image search, the first application can send a request to a remote server to provide images relating to the content item. The remote server can locate and send images to the first application. The first application can display the images for selection by the user. The user can select an image(s) to be linked to the content item. After receiving a selection of at least one of the images, the first application can generate and store the linked image(s). The first application can then convert the content item in the message to the linked image and insert the linked image into the message in place of the content item. The second application can send the message with the linked image to second device. After the second application sends the message, the user can send a request to the first application to delete the message (e.g., if the user sent the message to an unintended recipient, if the message contained incorrect information). The first application can delete the message from the first device and send a request to a remote server to delete the message from the second device. The remote server can verify that the message was received by the second device and delete the message from the second device.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

Several implementations of the disclosed technology are described above in reference to the figures. The computing devices on which the described technology may be implemented can include one or more central processing units, memory, input devices (e.g., keyboards and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item, such as A and A; B, B, and C; A, A, B, C, and C; etc.

The above Detailed Description of examples of the technology is not intended to be exhaustive or to limit the technology to the precise form disclosed above. While specific examples for the technology are described above for illustrative purposes, various equivalent modifications are possible within the scope of the technology. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. §112(f) will begin with the words “means for”, but use of the term “for” in any other context is not intended to invoke treatment under 35 U.S.C. §112(f). Accordingly, the applicant reserves the right to pursue additional claims after filing this application to pursue such additional claim forms, in either this application or in a continuing application.

1. A method implemented by a first mobile application running on a first mobile device of the user, the method comprising:
receiving, at the first mobile device, an image and a content item representative of the image;
in response to receiving the image and the content item representative of the image, generating a linked image by creating a link between the image and the content item;
storing the linked image in a memory of the first mobile device; and
upon detecting that a candidate content item entered by the user on a typing interface of the first mobile device matches the content item representative of the image:
retrieving the linked image from the memory of the first mobile device;
converting the candidate content item into the linked image;
inserting a condensed version of the linked image into the typing interface of a second mobile application, and
sending, via the second mobile application, the linked image to a second mobile device;
wherein the typing interface is included in the second mobile application running on the first mobile device of the user.

2. The method of claim 1, further comprising:
integrating with the second mobile application,
wherein the second mobile application is a text messaging application,
wherein the second mobile application and the first mobile application are different applications;
modifying automatically, by the first mobile application, the typing interface of the second mobile application to include one or more user interface features corresponding to the first mobile application; and
providing a designated folder for storing the linked image in the memory of the first mobile device,
wherein the content item is a word or a phrase.

3. The method of claim 1, wherein the content item is an emoji of a plurality of pre-defined emojis provided by the second mobile application, and wherein the candidate content item entered by the user is entered into the second mobile application via dictation.

4. The method of claim 1, wherein the content item includes one or more ideograms, one or more alphabets, one or more numbers, or a combination of ideograms, alphabets and numbers.

5. The method of claim 1, further comprising:
receiving, at the first mobile device, a text message including a respective content item;
detecting, by the first mobile application, that the text message includes the respective content item;
automatically converting, by the first mobile application, the respective content item into a respective linked image corresponding to the respective content item;
replacing the respective content item in the text message with the respective linked image; and
displaying, via the second mobile application, the text message including the respective linked image.

6. The method of claim 1, wherein sending the linked image further comprises:
including the linked image in a text message composed using the second mobile application by replacing the content item in the text message with the linked image.

7. The method of claim 1, wherein the image is received from at least one of the following: a library storing personal images of the user on the first mobile device, an image captured by a camera application running on the first mobile device, or an online library of images accessible by the first mobile application.

8. The method of claim 1, wherein the image is a first image, the linked image is a first linked image, wherein the method further comprises:
receiving a second image and the content item representative of the second image;
in response to receiving the second image and the content item representative of the second image, generating a second linked image by creating a link between the second image and the content item;
storing the second linked image in the memory of the first mobile device;
upon detecting a candidate content item entered by the user item on a typing interface matches the content item representative of the image:
displaying the first linked image and the second linked image for selection by the user, and
receiving the selection of one of the first linked image or the second image for insertion in the typing interface, and
wherein the typing interface is included in the second mobile application running on the first mobile device of the user.

9. The method of claim 1, wherein the first mobile application is toggled between the linked image and the content item when the user selects on the linked image, and wherein the typing interface of the second mobile application includes the content item representative of the image and text entries that are not representative of images, wherein the content item representative of the image is differentiated from the text entries.

10. The method of claim 1, wherein the content item is a first content item, the link is a first link, and wherein the method further comprises:
receiving a second content item representative of the image; and
in response to receiving the second content item, generating a second link between the second content item and the linked image without adding an additional image, wherein the first content item, the second content item, and the linked image are defined as a single set.

11. The method of claim 1, wherein the image is a first image, the linked image is a first linked image, and the link is a first link, wherein the method further comprises:
receiving a second image corresponding to the content item; and
in response to receiving the second image, generating a second linked image by creating a second link between the second image and the content item associated with the first linked image without adding an additional content item, wherein the first linked image, the second linked image, and the content item are defined as a single set.

12. The method of claim 1, wherein detecting the that the candidate content item entered by the user on the typing interface matches with the content item representative of the image further comprises:
receiving, from the user, text entries in addition to the content item; and
inserting a condensed version of the linked image and the text entries on the typing interface of the second mobile application, wherein the first mobile application is different from the second mobile application, wherein the text entries are positioned in close proximity to the linked image.

13. The method of claim 1, wherein the candidate content item is highlighted by the user for emphasis on the typing interface, and wherein when the content item is associated with multiple linked images, the multiple linked images are positioned above the typing interface for selection by the user.

14. The method of claim 1, wherein the candidate content item entered by the user item on the typing interface matches with the content item representative of the image according to one of the following matching conditions: (i) the candidate content item is identical to the content item, or (ii) at least a portion of the candidate content item is identical with at least a portion of the content item representative of the image.

15. At least one non-transitory computer-readable medium comprising a set of instructions associated with a first mobile application of a first user that, when executed by one or more processors, cause a mobile device to perform operations of:
identifying in real time, via a text messaging application, that a message is composed for a second user by the first user; and
upon detecting a candidate content item entered by the first user on a typing interface of the text messaging application matches the content item representative of the image:
retrieving multiple linked images from the memory of the mobile device, wherein the multiple linked images are generated by creating links between the content item and each linked image of the multiple linked images,
inserting, in the message composed for the second user by the first user, a condensed version of a default linked image,
wherein the default linked image corresponds to a most recently used linked image by the first user for communicating with the second user, and
sending, via the text messaging application, the linked image in the message composed for the second user by the first user.

16. The at least one non-transitory computer-readable medium of claim 15, wherein the set of instructions associated with the first mobile application of the first user, when executed by the one or more processors, further cause the mobile device to perform the operations of:
in response to detecting a tap on the default linked image on the typing interface, displaying condensed versions of the multiple linked images on the typing interface.

17. The at least one non-transitory computer-readable medium of claim 15, wherein the set of instructions associated with the first mobile application of the first user, when executed by the one or more processors, further cause the mobile device to perform the operations of:
in response to detecting a tap on the default linked image on the typing interface, displaying condensed versions of the multiple linked images on the typing interface; and
in response to receiving a selection of the condensed version of one of the linked images in the multiple linked images displayed on the typing interface, inserting the condensed version of the linked image in the message composed for the second user by the first user.

18. The at least one non-transitory computer-readable medium of claim 17, wherein the set of instructions associated with the first mobile application of the first user, when executed by the one or more processors, further cause the mobile device to perform the operations of:
toggling the default linked image to the content item upon detecting a tap on the linked image on the typing interface; and
sending, to the second user, via the text messaging application, the content item without including any of the linked images in the multiple linked images.

19. A system comprising:
a first mobile application running on a first mobile device of the user, wherein the first mobile application is configured for:
receiving an image and text entered on the first mobile device representative of the image;
in response to receiving the image and the entered text representative of the image, generating a linked image by creating a link between the image and the entered text, and
storing the linked image in a memory of the first mobile device;
upon detecting that a candidate text item entered by the user in a text message matches with the entered text representative of the image,
wherein the text message is intended for a recipient at a second mobile device,
wherein the text message is included in a second mobile application running on the first mobile device of the user, and
wherein the second mobile application is a text messaging application or a social media application;
retrieving the linked image from the memory of the first mobile device;
converting the candidate text item into the linked image;
inserting the linked image into the text message, wherein the first mobile application is different from the second mobile application program;
sending, via the second mobile application, the text message including the linked image to the recipient at the second mobile device;
receiving a request for deleting the text message from the user; and
in response to the request for deleting the text message from the user:
deleting the text message at the first mobile device of the user; and
communicating the request to a remote server;
wherein the remote server, upon detecting the request for deleting the text message from the user is configured to:
verify that the text message is received by the recipient at the second mobile device; and
delete the text message at the second mobile device.

20. The system of claim 19, wherein the image is received from at least one of the following: a library storing personal images of the user on the first mobile device, an image captured by a camera application running on the first mobile device, or an online library of images accessible by the first mobile application, and wherein the candidate text item is included in a region with a border before being converted into the linked image is in response.
